(19) United States
(12) Patent Application Publication
(10) Pub. No.: US 2025/0234244 A1
(43) Pub. Date: Jul. 17, 2025

(54) Methods and Apparatus for Detecting and Indicating Congestion at a UE Which Uses a Non-3GPP Access Point

(71) Applicant: Charter Communications Operating, LLC, St. Louis, MO (US)

(72) Inventors: Paul L. Russell, JR., Lawrence, NJ (US); Yildirim Sahin, Englewood, CO (US); Imtiyaz Shaikh, Irving, TX (US); Maulik Vaidya, Escondido, CA (US)

(21) Appl. No.: 19/017,656

(22) Filed: Jan. 12, 2025

Related U.S. Application Data
(60) Provisional application No. 63/620,526, filed on Jan. 12, 2024.

(51) Int. Cl. H04W 28/02; H04W 24/08

(52) U.S. Cl. CPC H04W 28/0284; H04W 24/08

(57) ABSTRACT

Methods and apparatus for providing L4S support with regard to non-3GPP untrusted/trusted accesses in which a user equipment (UE) is enabled to monitor for uplink and/or downlink congestion with regard to L4S uplink data traffic flows at the UE, detect congestion, and perform explicit congestion notification (ECN) markings or communicate congestion information to perform ECN marking to another device are described. In some embodiments, the UE device indicates detected congestion, at the UE, in an uplink (UL) traffic flow via performing ECN marking of an innermost IP header ECN field. In some other embodiments, the UE device communicates detected congestion information, via a GRE message to a core network interface device, which communicates, via GTP-U, the detected congestion information to a UPF, which then uses the received UE detected congestion information to performs ECN marking in the innermost IP header of an uplink data packet.

### RELATED APPLICATIONS

The present application claims the benefit of U.S. Provisional Patent Application titled “Methods and Apparatus for Supporting Low Latency, Low Loss, Scalable Throughput (L4S) in Non-3GPP Untrusted and/or Trusted Access Networks” which was filed on Jan. 12, 2024 and assigned application Ser. No. 63/620,526 and which is hereby expressly incorporated by reference in its entirety.

### FIELD OF THE INVENTION

The present application relates to communications methods and, more particularly, to methods and apparatus for providing L4S support with regard to non-3GPP untrusted/trusted accesses.

### BACKGROUND

3rd Generation Partnership Project (3GPP) in Release 18 (R18) provides support of Low Latency, Low Loss, and Scalable Throughput (L4S) in Next Generation Radio Access Network (NG-RAN) and core network but has not addressed how non-3GPP access networks, e.g., WiFi access networks, might be able support L4S. The Rel-19 approved Study Item Description (SID) titled Study on Architecture enhancement for XRM Ph2 (SP-231198, updated in SP-231805) includes the below non-3GPP aspects to be studied as part of Rel-19:
WT #3 Further enhancement to support Extended Reality (XR) based on non-3GPP access.
WT #3.1 Study how to support L4S for non-3GPP access networks and intermediate 5GS nodes (Non-3GPP Interworking Function (N3IWF), Trusted Non-3GPP Gateway Function (TNGF) and Wireline-Access Gateway Function (W-AGF)) to perform Explicit Congestion Notification (ECN) marking for L4S.
Support L4S in untrusted/trusted access (e.g. N3IWF, TNGF).
Support L4S in wireline access (e.g. W-AGF).

While the Study Item Description (SID) suggests areas of study, in essence presents problems which remain to be solved.

As the use cases and applications for XR and Media services (XRM) are not limited to 3GPP access, XRM devices and applications may use non-3GPP access as a means of communication. Unfortunately, L4S support is not available for non-3GPP access.

Accordingly, it is desirable if L4S mechanisms could be extended to non-3GPP access networks and/or the potential impacts of such an extension on the non-3GPP access-specific intermediate nodes could be addressed.

In view of the above, it should be appreciated that there is a need for methods and apparatus that can be used to support L4S for non-3GPP access networks. It would be desirable if one more methods could be developed which would help support L4S at one or more nodes or network elements which are involved in non-3GPP access. Such nodes where it would be desirable if L4S could be supported with respect to non-3GPP, e.g., WiFi access, include intermediate 5GS nodes, e.g., N3IWF, TNGF and W-AGF. It would be desirable if such nodes and/or UEs could perform ECN marking for L4S when non-3GPP access is being used for or involved in communication. There is also a need for methods and/or apparatus which can be used to support L4S in untrusted/trusted access (e.g., N3IWF, TNGF) and/or support L4S in wireline access (e.g. W-AGF). In view of the above, methods and/or apparatus for supporting L4S with respect to non-3GPP access at any one of a variety of nodes which might be involved in non-3GPP access and/or communications would be desirable.

### BRIEF DESCRIPTION OF THE FIGURES

FIG. 1 is a drawing which illustrates L4S support in non-3GPP (i.e., w/WiFi AP+N3IWF or w/TNAP+TNGF) accesses.

FIG. 2 is a drawing which illustrates how 3GPP QoS flows are carried over non-3GPP accesses.

FIG. 3 is drawing which illustrates congestion in uplink detected at WLAN AP and/or at N3IWF of non-3GPP untrusted access and subsequent operations performed in response to the detected uplink congestion in accordance with various embodiments of the present invention.

FIG. 4 is a drawing which illustrates congestion in downlink detected at WLAN AP of non-3GPP untrusted access and subsequent operations performed in response to the detected downlink congestion in accordance with various embodiments of the present invention.

FIG. 5 is a drawing which illustrates congestion in downlink detected at N3IWF of non-3GPP untrusted access and subsequent operations performed in response to the detected downlink congestion in accordance with various embodiments of the present invention.

FIG. 6 is a drawing which illustrates congestion in uplink detected at Trusted Non-3GPP Access Point (TNAP) and/or at Trusted Non-3GPP Gateway Function (TNGF) of non-3GPP trusted access and subsequent operations performed in response to the detected uplink congestion in accordance with various embodiments of the present invention.

FIG. 7 is a drawing which illustrates congestion in downlink detected at TNAP of non-3GPP trusted access and subsequent operations performed in response to the detected downlink congestion in accordance with various embodiments of the present invention.

FIG. 8 is a drawing which illustrates congestion in downlink detected at TNGF of non-3GPP trusted access and subsequent operations performed in response to the detected downlink congestion in accordance with various embodiments of the present invention.

FIG. 9 is a drawing which illustrates congestion in uplink detected at UE via non-3GPP trusted access and subsequent operations performed in response to the detected uplink congestion in accordance with various embodiments of the present invention.

FIG. 10 is a drawing of an exemplary user equipment (UE) implemented in accordance with an exemplary embodiment.

FIG. 11 is a drawing of an exemplary wireless local area network access point (WLAN AP), e.g., a WiFi AP, implemented in accordance with an exemplary embodiment.

FIG. 12 is a drawing of an exemplary trusted non-3GPP access point (TNAP) implemented in accordance with an exemplary embodiment.

FIG. 13 is a drawing of an exemplary non-3GPP Interworking function (N3IWF) implemented in accordance with an exemplary embodiment.

FIG. 14 is a drawing of an exemplary trusted non-3GPP gateway function (TNGF) implemented in accordance with an exemplary embodiment.

FIG. 15 is a drawing of an exemplary core network node, e.g., a user plane function (UPF) device, an Access & Mobility Management Function (AMF) device, a Session Management Function (SMF) device, a Policy Control Function (PCF) device, etc., implemented in accordance with an exemplary embodiment.

FIG. 16A illustrates exemplary Protocol Data Unit (PDU) session establishment via untrusted or trusted non-3GPP access for an LAS traffic flow in accordance with an exemplary embodiment.

FIG. 16B, which is a continuation of FIG. 16A, illustrates exemplary UE application UL traffic congested at AP (WLAN AP or TNAP) and/or at core network interfacing device (N3IWF or TNGF) for an uplink L4S traffic flow corresponding to a Protocol Data Unit (PDU) session established in FIG. 16A, and exemplary operations performed including congestion detection, setting of bits in ECN fields in headers, and transfer of ECN information, in accordance with an exemplary embodiment.

FIG. 16C, which is a continuation of FIG. 16B, illustrates exemplary application data, headers, encapsulation, ECN markings, and transfer of congestion information, in accordance with an exemplary embodiment.

FIG. 16 is a drawing which illustrates that FIG. 16 comprises the combination of FIG. 16A, FIG. 16B and FIG. 16C.

FIG. 17A illustrates exemplary PDU session establishment via untrusted or trusted non-3GPP access for an LAS traffic flow in accordance with an exemplary embodiment.

FIG. 17B, which is a continuation of FIG. 17A, illustrates exemplary DN application downlink (DL) traffic congested at AP (WLAN AP or TNAP) and/or at core network interfacing device (N3IWF or TNGF) for an downlink L4S traffic flow corresponding to a PDU session established in FIG. 17A, and exemplary operations performed including congestion detection, setting of bits in ECN fields in headers, and transfer of ECN information, in accordance with an exemplary embodiment.

FIG. 17C, which is a continuation of FIG. 17B, illustrates exemplary application data, headers, encapsulation, ECN markings, and transfer of congestion information, in accordance with an exemplary embodiment.

FIG. 17 is a drawing which illustrates that FIG. 17 comprises the combination of FIG. 17A, FIG. 17B and FIG. 17C.

FIG. 18 illustrates how ECN traversal is handled throughout a network.

FIG. 19 is a drawing illustrating exemplary data format structures in which an IP packet for an L4S data flow is communicated in accordance with an exemplary embodiment.

### SUMMARY

Various embodiments are directed to methods and apparatus for providing L4S support with regard to non-3GPP untrusted/trusted accesses in which a user equipment (UE), is enabled to monitor for uplink congestion with regard to L4S uplink data traffic flows at the UE, detect congestion and perform explicit congestion notification (ECN) markings or communicate congestion information to perform ECN marking. In some embodiments, the UE device indicates detected congestion, at the UE, in an uplink (UL) traffic flow via performing ECN marking of the innermost IP header ECN field. In some other embodiments, the UE device communicates detected congestion information, via a GRE message to a core network interface device, which communicates, via GTP-U, the detected congestion information to a UPF, which uses the received UE detected congestion information to performs ECN marking in the innermost IP header of an uplink data packet. The innermost IP header ECN field including congestion information, which includes the impact of detected congestion at the UE, is communicated to the application in the destination node of the destination network.

An exemplary method of supporting L4S in non-GPP accesses, in accordance with some embodiments, includes: operating a user equipment (UE) to monitor for congestion on the uplink; and detecting, at the UE, congestion.

While various features are discussed in the above summary, all features discussed above need not be supported in all embodiments and numerous variations are possible. Additional features, details and embodiments are discussed in the detailed description which follows.

### DETAILED DESCRIPTION

This section discussed various features/aspects of the invention. Various embodiments, in accordance with the present invention, provide several scenarios of how non-3GPP access deployments may support L4S ECN marking.

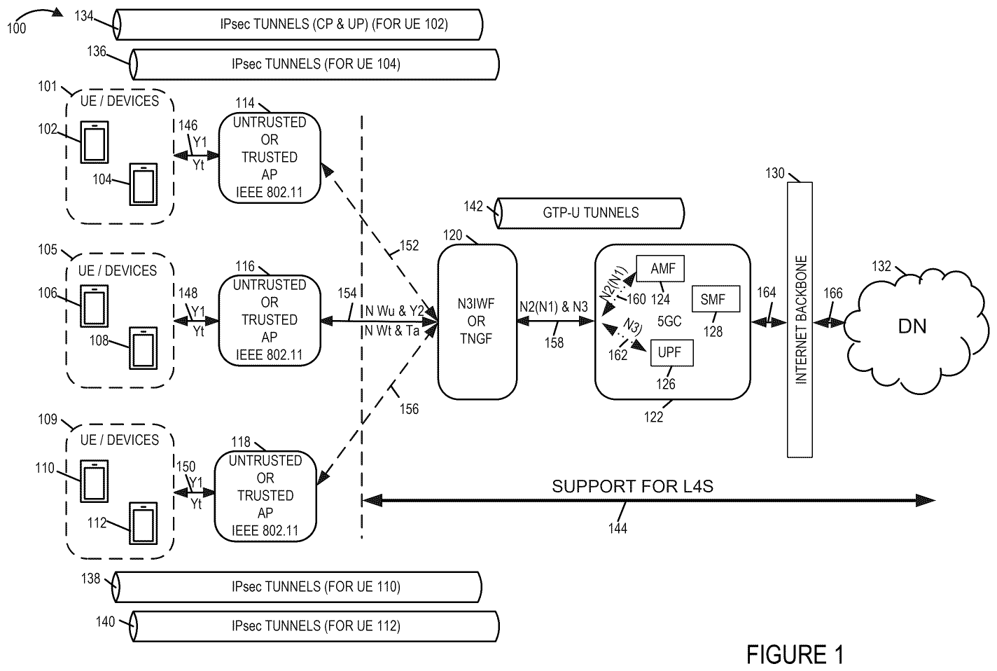

FIG. 1 is a drawing 100 which illustrates L4S support in non-3GPP (i.e., w/WiFi Access Point (AP)+N3IWF or w/TNAP+TNGF) accesses. A Wi-Fi access point is an access point which uses an IEEE 802.11 protocol, e.g., for local area networking of devices, Internet access and/or other communications purposes. FIG. 1 is a high-level illustration of 3GPP devices (i.e., UEs) connecting to a 3GPP 5GS via non-3GPP accesses and where support for L4S is implemented in accordance with the present invention. Various devices, e.g., UEs, untrusted APs (e.g., Wireless Local Area Network (WLAN) APs such as WiFi APs), trusted APs (e.g., TNAPs), N3IWF devices, TNGF devices, and/or core network devices, e.g. UPF devices, AMF devices, and SMF devices, are implemented to includes features and/or aspects in accordance with various embodiments of the present invention, and/or to implement steps of one or more methods in accordance with various embodiment of the present invention. 3GPP R18 specifies dedicated user plane resources for carrying L4S-enabled IP traffic, which is realized in 3GPP access via QoS flows.

The communications system of drawing 100 includes a first set of UEs/end user devices 101, a second set of UEs/end user devices 105, a third set of UEs/end user devices 109, a first access point (AP) 114, a second AP 116, a third AP 118, a core network interface device 120, a 5G core (5GC) 122, an Internet backbone 130 and a data network (DN) 132 coupled together as shown.

The first set of UEs/end user devices 101 includes UE/end user device 102 and UE/end user device 104, which are coupled, via Y1 or Yt interfaces 146, to first AP 114, which is an untrusted or trusted AP, e.g., in accordance with IEEE 802.11. The second set of UEs/end user devices 105 includes UE/end user device 106 and UE/end user device 108, which are coupled, via Y1 or Yt interfaces 148, to second AP 116, which is an untrusted or trusted AP, e.g., in accordance with IEEE 802.11. The third set of UEs/end user devices 109 including UE/end user device 110 and UE/end user device 112, which are coupled, via Y1 or Yt interfaces 150, to third AP 118, which is a untrusted or trusted AP, e.g., in accordance with IEEE 802.11.

First AP 114 is coupled to core network interface device 120, which is a N3IWF or TNGF, via interfaces 152, which are N Wu & Y2 interfaces or N Wt & Ta interfaces. Second AP 116 is coupled to core network interface device 120, which is a N3IWF or TNGF, via interfaces 154, which are N Wu & Y2 interfaces or N Wt & Ta interfaces 154. Third AP 118 is coupled to core network interface device 120, which is a N3IWF or TNGF, via interfaces 156, which are N Wu & Y2 interfaces or N Wt & Ta interfaces.

5GC 122 includes a plurality of core network functions including an access and mobility management function (AMF) 124, a user plane function (UPF) 126 and a session management function (SMF) 128). There may be, and sometimes are multiple instances of one or more particular function in the 5GC, e.g., one or more AMFs, one or more SMF, and one or more UPFs. In some embodiments, different instances of a particular function may have different capabilities, e.g., some may support aspects of the current invention, e.g., congestion monitoring and detection and ECN marking, with regard to uplink (UL) and/or downlink (DL) L4S traffic flows, while others may not. The core network interface device 120 is coupled to the 5GC 122 and/or elements within the 5GC 122 via N2 (N1) & N3 interface connections 158, N2 (N1) interface connections 160 and/or N3 interface connections 162.

5GC 122 is coupled to Internet backbone 130 via connections 164. Internet backbone 130 is coupled to data network (DN) 132 via connections 166. There may be, and sometimes are, IPsec tunnels extending between UE devices and the core network interface device (N3IWF or TNGF) 120. For example, IPsec tunnels 134 (for control plane (CP) and user plane (UP)) go between UE 102 and core network interface device 120; IPsec tunnels 136 (for control plane (CP) and (UP)) go between UE 104 and core network interface device 120; IPsec tunnels 110 (for control plane (CP) and (UP) go between UE 110 and core network interface device 120; and IPsec tunnels 140 (for control plane (CP) and (UP)) go between UE 112 and core network interface device 120. The IPsec tunnels corresponding to UE 106 and UE 108, are not shown in FIG. 1, for simplicity of illustration, but may be, and sometimes are implemented, as needed.

There are also General Packet Radio Service (GPRS) Tunnelling Protocol User Plane (GTP-U) tunnels 142 between the core network interface device 120 and UPFs of 5GC 122 including exemplary UPF 126. Arrow 144 indicates support for L4S extending from the interfaces between the APs (114, 116, 118)/core network interfacing device 120 (N3IWF or TNGF) to the DN. In accordance with features of the present invention, support for L4S is extended to include the non-3GPP untrusted or trusted APs (114, 116, 118) and the UEs (102, 104, 106, 108, 110, 112).

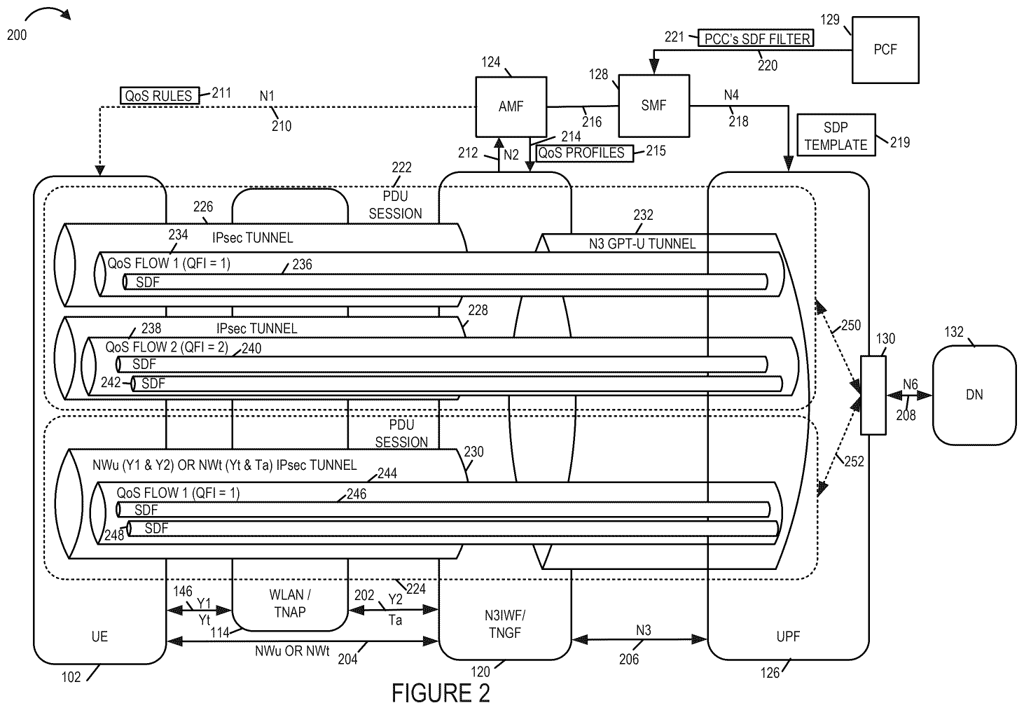

FIG. 2 is a drawing 200 which illustrates how 3GPP QoS flows are carried over non-3GPP accesses. Drawing 200 of FIG. 2 illustrates non-3GPP (i.e., w/WLAN+N3IWF or TNAP+TNGF) QOS Architecture (i.e., Rules, Profiles, SDF Template, & Flows, etc.).

Drawing 200 includes UE 102, access point AP 114, which is a WLAN AP or a TNAP, core network interfacing device 120, which is a N3IWF (non-3GPP interworking function) or a TNGF, AMF 124, UPF 126, SMF 128, PCF 129, Internet backbone 130 and data network (DN) 132 coupled together as shown.

There is a Y1 or Yt interface connection 146 between UE 102 and AP 114, which is a WLAN AP or TNAP. There is a Y2 or Ta interface connection 202 between AP 114 and core network interfacing device 120. There is a NWu or NWt interface connection 204 between UE 102 and core network interfacing device 120. There is a N3 interface connection 206 between core network interfacing device (N3IWF or TNGF) 120 and UPF 126.

Dashed box 222 identifies a first Protocol Data Unit (PDU) session of which UE 102 is an endpoint. Dashed box 224 identifies a second PDU session of which UE 102 is an endpoint. The first PDU session 222 includes QoS flow 1 234, with QoS flow identifier (QFI)=1 and QoS flow 2 238, with QFI=2. Each of the QoS flows (234, 238), are shown between UE 102 and UPF 126. QoS flow 1 234 include service data flow (SDF) 236. QOS flow 2 238 includes SDF 240 and SDF 242. The second PDU session 230 includes QoS flow 1 244, with QFI=1. QoS flow 1 244 is shown between UE 102 and UPF 126. QOS flow 1 244 includes SDF 246 and SDF 248.

IPsec tunnel 226, carries QoS flow 1 234 information between UE 102 and core network interfacing device 120, which is a Non-3GPP Interworking Function (N3IWF) or TNGF. IPsec tunnel 228, carries QoS flow 2 240 information between UE 102 and core network interfacing device 120, which is a N3IWF or TNGF. IPsec tunnel 230, carries QoS flow 1 244 information between UE 102 and core network interfacing device 120, which is a N3IWF or TNGF. N3 GPT-U tunnel 232, which extends between the core network interfacing device 120, which is a N3IWF or TNGF, and UPF 126, carries QoS flow 1 244 information, QoS flow 2 238 information, and QoS flow 1 244 information.

Bi-directional arrows 250, 252 represents first PDU session 222 information and second PDU session 224 information being communicated via UPF 126 to Internet backbone 130. Bi-directional arrow 208 represents an N6 interface connection to DN 132, via which data is communicated between user plane function (UPF) 126 and DN 132.

PCF 129, which is part of 5GC 122, sends PCC's SDF filter 221, via connection 220, to SMF 128. SMF 128 sends SDP template 219 to UPF 126 via N4 interface 218. The core network interfacing device 120, which is an N3IWF or TNGF, sends an N2 message 212 to AMF 124. AMF 124 sends QoS profiles 215, via signals 214, to the core network interfacing device (N3IWF or TNGF) 120. AMF 124 sends QoS rules 211 via N1 interface 210 to UE 102.

If congestion in a non-3GPP access (i.e., un-trusted and trusted) is experienced, it will most probably occur at the wireless access point (i.e., AP), although the N3IWF and TNGF could also experience congestion independently within its internal managed traffic queues as well as the UE.

Various features and aspects of the present invention, are directed to how to provide congestion information (i.e., ECN marking and level of congestion) on behalf of the AP, as well as:
If it is possible, for the AP to provide percentage of congestion information similar to how NG-RAN provides percentage of congestion information.
If the wireless access point does not support L4S, it should not impact the IP header's ECN field as specified in RFC 9330, is there any impact in N3IWF and TNGF for support of L4S.
If the N3IWF and TNGF can determine that the AP was congested based on internal means.

The solutions provided, in accordance with the present invention, implement that 3GPP-defined non-3GPP access nodes (i.e., N3IWF and TNGF) provide mechanisms to extend support for L4S in non-3GPP untrusted and trusted accesses.

The solutions, in accordance with the present invention, have the following principles:
Dedicated UP resources are used for carrying L4S-enabled IP traffic.
N3IWF and/or TNGF maps the L4S-enabled QoS Flows to UP resources.
N3IWF and/or TNGF relays ECN marking up the stack to the Inner most IP header, so the end-to-end applications are aware of the ECN marking.
Option for the UE to perform ECN marking when UL congestion is experienced at the UE.

Various features and aspects relating to supporting L4S in N3IWF will now be described. It is most probable that if congestion is experienced in the uplink, it is related to the wireless link (i.e., WiFi AP). 3GPP does not have responsibility for the AP specification but can relay any congestion notification that the WiFi AP provides to the inner most IP layer at the N3IWF. This is accomplished by leveraging IETF draft RFC, draft-ietf-tsvwg-ecn-encap-guidelines-22, which provides Guidelines for Adding Congestion Notification to Protocols that Encapsulate IP.

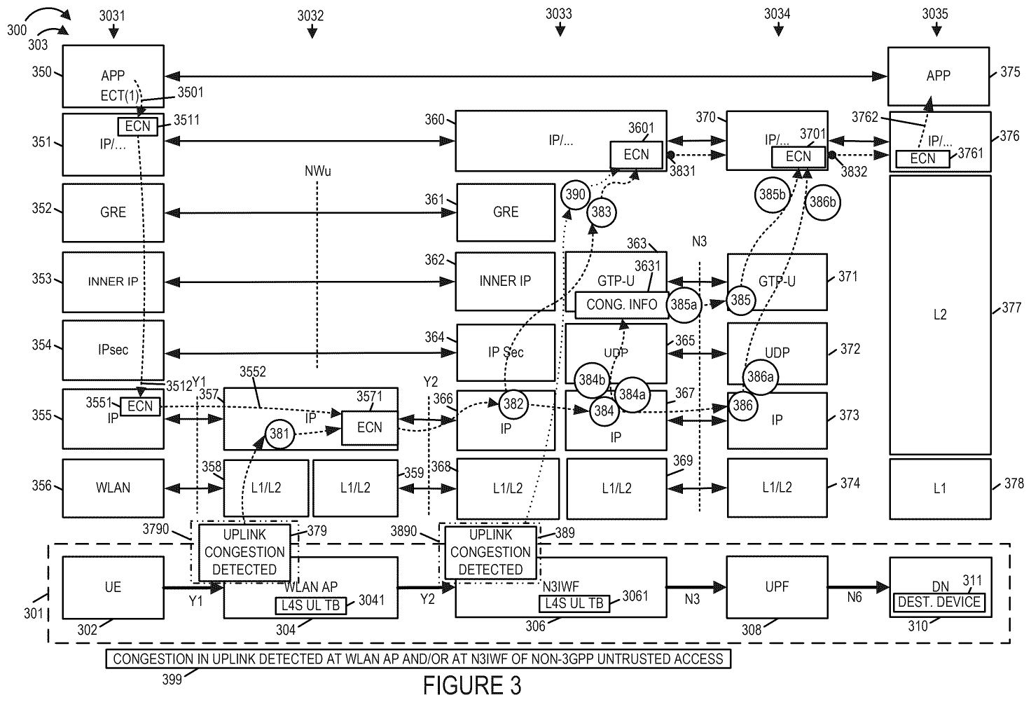

FIG. 3 includes drawing 300 which illustrates congestion in uplink detected at WLAN AP 304 and/or at N3IWF 306 of non-3GPP untrusted access (as indicated by title box 399) and subsequent operations performed in response to the detected uplink congestion in accordance with various embodiments of the present invention. Drawing 300 of FIG. 3 illustrates how support for L4S is accomplished, in accordance with various embodiments of the present invention, when congestion is detected (see step 379) at the WLAN AP (e.g., a WiFi AP) 304 in the uplink. Drawing 300 illustrates UE 302, WLAN AP 304, e.g., a WiFi AP, N3IWF 306, UPF 308, and DN 310, which are part of exemplary system 301. DN 310 includes destination device 311, e.g., a destination server or a destination UE. In some embodiments, UE 302 of FIG. 3 is UE 102 of FIG. 1 and FIG. 2; WLAN AP 304 of FIG. 3 is non-3GPP AP 114 of FIG. 1 and FIG. 2, N3IWF 306 of FIG. 3 is core network interface device 120 of FIG. 1 and FIG. 2; UPF 308 of FIG. 3 is UPF 126 of FIG. 1 and FIG. 2; and DN 310 of FIG. 3 is DN 132 of FIG. 1 and FIG. 2.

Drawing 300 of FIG. 3 further includes a protocol stack diagram 303 illustrating protocol stack for each of the elements (UE 302, WLAN AP 304, N3IWF 306, UPF 308, DN 310), and the communication of congestion information (ECN marking and level of congestion information) in response to uplink congestion detected at the WLAN AP 304. The protocol stack 3031 for UE 302 includes an application (APP) layer 350, an IP/ . . . layer 351, a Generic Routing Encapsulation (GRE) layer 352, an Inner IP layer 353, an IPsec layer 354, an IP layer 355 and a WLAN layer 356, as shown. The protocol stack 3032 for WLAN AP 304 includes an IP layer 357, L1/L2 layer component 358 and L1/L2 layer component 359, as shown. The protocol stack 3033 for N3IWF 306 includes an IP/ . . . layer 360, a Generic Routing Encapsulation (GRE) layer 361, an Inner IP layer component 362, a GPRS Tunnelling Protocol for the user plane (GTP-U) layer component 363, an Internet Protocol Security (IPsec) layer component 364, a UDP layer component 365, IP layer component 366, IP layer component 367, L1/L2 layer component 368, and L1/L2 layer component 369, as shown. The protocol stack 3034 for UPF 308 includes an IP/ . . . layer 370, a GTP-U layer 371, an User Datagram Protocol (UDP) layer 372, an Internet Protocol (IP) layer 373, and a L1/L2 layer 374, as shown. The protocol stack 3035 for DN 310 includes an application (APP) layer 375, an IP/ . . . layer 376, a L2 layer 377, and a L1 layer 378, as shown.

Solid line arrows (uni-directional arrows and bi-directional arrows) are used in FIG. 3 to represent interfaces (e.g., Y1, Y2, N3, N6, NWu) and/or communications (e.g., communications over those interfaces).

An application 350, e.g., an L4S application, in UE 302 sets (in step 3501) the ECN field 3511 in the innermost IP header 351 to ECT(1), e.g., a bit pattern of 01. UE 302, relays, e.g., copies, (in step 3512) the ECT(1) indication from the ECN field 3511 of the innermost IP header 351 to the ECN field 3551 of the outer IP header 355 of UE 302. UE 302 communicates (in step 3552) the outer IP header 355 ECN field setting, indicating ECT(1), of the UE 302 to the ECN field 3571 of the outer IP header 357 of WLAN AP 304.

In step 379, WLAN AP 304, which is monitoring (in step 3790) the status of its uplink traffic buffers, e.g., L4S uplink traffic buffer(s) 3041, detects uplink congestion. Operation proceeds from step 379 to step 381.

FIG. 3 illustrates 3 alternative operational paths, which may be implemented in response to uplink congestion detected in step 379 at WLAN AP 304, to communicate congestion information and perform ECN marking in the innermost IP header. A first alternative path includes steps 381, 382, and 383. A second alternative path includes steps 381, 382, 384b, 385a, and 385b. A third alternative path includes steps 381, 382, 384a, 386a and 386b.

In step 381, WLAN AP 304 indicates via IP Header ECN field 3571 that congestion was experienced, assuming that the ECN field was set to ECT(1). Thus, in step 381 WLAN AP 304 changes, e.g., sets, the value in ECN field 3571 to indicate congestion experienced (CE), e.g., the bit pattern in ECN field 3571 is changed from 01 to 11. Operation proceeds from step 381 to step 382.

In step 382 N3IWF 306 detects outer IP header ECN field is set indicating congestion. Operation proceeds from step 382 to one of: step 383, step 384a or step 384b, depending upon the particular implemented embodiment.

In step 383 N3IWF 306 relays information to inner-most IP header 360 as specified in draft RFC draft-ietf-tsvwg-ecn-encap-guidelines-22 and marks ECN field 3601 indicating congestion was experienced.

In step 384a of step 384 N3IWF 306 relays information to outer IP header to UPF 308 as specified in draft RFC draft-ietf-tsvwg-ecn-encap-guidelines-22 and if the PDU Session Anchor (PSA) User Plane Function (UPF) is responsible for performing the ECN marking in the UL, the N3IWF 306 can provide congestion information related to congestion experienced by the N3IWF but may not be able to provide congestion information experienced by the WiFi AP.

Based on implementation it may be possible, in step 384b of step 384 for the N3IWF 306 to estimate congestion information 3631 relative to the access point (i.e., level of congestion of WLAN AP 304) and provide congestion information via GTP-U header 363.

In some embodiments, operation proceeds from step 384b to step 385a. Alternatively, in some other embodiments, operation proceeds from step 384a to step 386a.

In step 385a of step 385 N3IWF 306 provides GTP-U header with congestion information to UPF 308 and in step 385b of step 385 UPF 308 marks ECN field 3701 of innermost IP header 370 indicating congestion was experienced.

In step 386a of step 386 UPF 308 relays information, e.g., ECN information, from outer IP header to UPF 308 inner IP header 370 as specified in draft RFC draft-ietf-tsvwg-ecn-encap-guidelines-22 and in step 386b of step 386 UPF 308 marks ECN field 3701 of innermost IP header 370 as specified in draft RFC draft-ietf-tsvwg-ecn-encap-guidelines-22 indicating congestion was experienced. If congestion is experienced in the uplink by the N3IWF 306, not illustrated, it is capable of setting the IP header ECN field of the inner IP as well as providing congestion information via GTP-U to PSA UPF in the case the PSA UPF is instructed to perform the ECN marking.

If congestion is experienced in the uplink by the N3IWF 306 and the WiFi AP 304, the ECN marking provided by the WiFi AP (if supported) would take precedent and relayed to the innermost IP layer for use by the receiving application. If the congestion in the uplink at the N3IWF 306 persists, it will eventually perform the ECN marking once the congestion from the WiFi AP 304 is removed.

Like uplink, it is most probably likely that if congestion is experienced in the downlink, the congestion is related to the wireless link (i.e., WiFi AP 304) and 3GPP does not have responsibility for the AP specification but can relay any congestion notification that the WiFi AP 304 provides to the inner most IP layer at the UE 302. This is accomplished by leveraging IETF draft RFC, draft-ietf-tsvwg-ecn-encap-guidelines-22, which provides Guidelines for Adding Congestion Notification to Protocols that Encapsulate IP.

Drawing 300 of FIG. 3 further illustrates an example of exemplary embodiment in which the N3IWF 306 is enabled to monitor for congestion in the uplink and perform ECN marking in response to detected congestion. Drawing 300 of FIG. 3 illustrates how support for L4S is accomplished, in accordance with various embodiments of the present invention, when congestion is detected (see step 389) at the N3IWF 306 in the uplink. In step 389, N3IWF 306, which is monitoring (in step 3890) the status of its uplink traffic buffers, e.g., L4S uplink traffic buffer(s) 3061, detects uplink congestion. Operation proceeds from step 389 to step 390. In step 390 N3IWF 306 indicates via IP Header ECN field 3601 that congestion was experienced, assuming that the ECN field was set to ECT(1). Thus, in step 390 N3IWF 306 communicates congestion information and performs ECN marking directly in innermost IP header 3601.

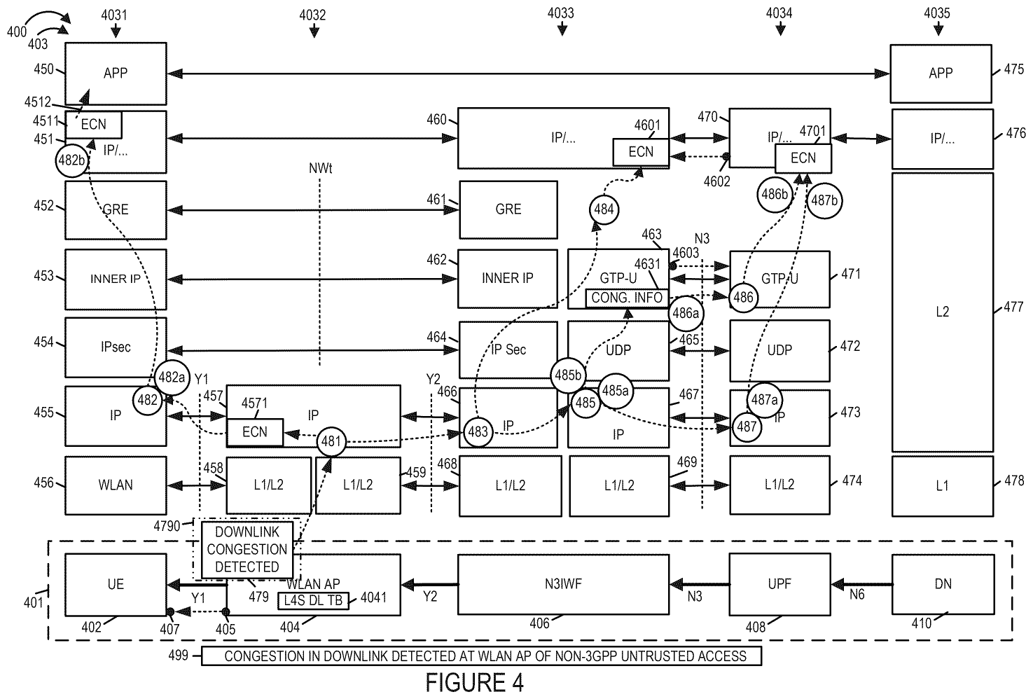

FIG. 4 includes drawing 400 which illustrates congestion in downlink detected at WLAN AP 404 of non-3GPP untrusted access (as indicated by title box 499) and subsequent operations performed in response to the detected downlink congestion in accordance with various embodiments of the present invention. Drawing 400 of FIG. 4 illustrates how support for L4S is accomplished, in accordance with various embodiments of the present invention, when congestion is detected (see step 479)_at the WLAN AP 404 in the downlink. Drawing 400 illustrates UE 402, WLAN AP 404, e.g., a WiFi AP, N3IWF 406, UPF 408, and DN 410, which are part of exemplary system 401. In some embodiments, UE 402 of FIG. 4 is UE 102 of FIG. 1 and FIG. 2; WLAN AP 404 of FIG. 4 is non-3GPP AP 114 of FIG. 1 and FIG. 2, N3IWF 406 of FIG. 4 is core network interface device 120 of FIG. 1 and FIG. 2; UPF 408 of FIG. 4 is UPF 126 of FIG. 1 and FIG. 2; and DN 410 of FIG. 3 is DN 132 of FIG. 1 and FIG. 2.

Drawing 400 of FIG. 4 further includes a protocol stack diagram 403 illustrating protocol stack for each of the elements (UE 402, WLAN AP 404, N3IWF 406, UPF 408, DN 410), and the communication of congestion information (ECN marking and level of congestion information) in response to uplink congestion detected at the WLAN AP 404. The protocol stack 4031 for UE 402 includes an application (APP) layer 450, an IP/ . . . layer 451, a Generic Routing Encapsulation (GRE) layer 452, an Inner IP layer 453, an IPsec layer 454, an IP layer 455 and a WLAN layer 456, as shown. The protocol stack 4032 for WLAN AP 404 includes an IP layer 457, L1/L2 layer component 458 and L1/L2 layer component 459, as shown. The protocol stack 4033 for N3IWF 406 includes an IP/ . . . layer 460, a Generic Routing Encapsulation (GRE) layer 461, an Inner IP layer component 462, a GTP-U layer component 463, an IPsec layer component 464, a UDP layer component 465, IP layer component 466, IP layer component 467, L1/L2 layer component 468, and L1/L2 layer component 469, as shown. The protocol stack 4034 for UPF 408 includes an IP/ . . . layer 470, a GTP-U layer 471, an UDP layer 472, an IP layer 473, and a L1/L2 layer 474, as shown. The protocol stack 4035 for DN 410 includes an application (APP) layer 475, an IP/ . . . layer 476, a L2 layer 477, and a L1 layer 478, as shown.

Solid line arrows (uni-directional arrows and bi-directional arrows) are used in FIG. 4 to represent interfaces (e.g., Y1, Y2, N3, N6, NWu) and/or communications (e.g., communications over those interfaces).

An application, e.g., an LAS application, in DN 410 sets an ECN field in the innermost IP header 476 to ECT(1), e.g., a bit pattern of 01. DN 402, relays, e.g., copies, the ECT(1) indication from the ECN field of the innermost IP header 476 to the ECN field of the outer IP header of DN 410. DN 410 communicates, e.g., via UPF 408 and N3IWF 406, the outer IP header ECN field setting, indicating ECT(1), to the ECN field 4571 of the outer IP header 457 of WLAN AP 404.

In step 479, WLAN AP 404, which is monitoring (in step 4790) the status of its downlink traffic buffers, e.g., L4S downlink traffic buffer(s) 4041, detects downlink congestion. Operation proceeds from step 479 to step 481.

FIG. 4 illustrates 4 alternative operational paths, which may be implemented in response to downlink congestion detected in step 479 at WLAN AP 404, to communicate congestion information and perform ECN marking in the innermost IP header. A first alternative path includes steps 481, 482a, and 482b. A second alternative path includes steps 481, 483 and 484. A third alternative path includes steps 481, 483, 485b, 486a and 486b. A fourth alternative path includes steps 481, 483, 485a, 487a and 487b.

In step 481 WLAN AP 404 indicates via IP Header ECN field 4571 that congestion was experienced, assuming that the ECN field was set to ECT(1). Thus, in step 481 WLAN AP 404 changes, e.g., sets, the value in ECN field 4571 to indicate congestion experienced (CE), e.g., the bit pattern in ECN field 4571 is changed from 01 to 11. Operation proceeds from step 481 to step 482a or step 483 depending upon the particular implemented embodiment.

In step 482a of step 482 UE 402 detects outer IP header ECN field is set indicating congestion. In step 482b of step 482 UE 402 relays information to inner IP header (e.g., ECN field 4511 of 451) as specified in draft RFC draft-ietf-tsvwg-ecn-encap-guidelines-22. In step 483 N3IWF 406 detects outer IP header ECN field is set indicating congestion. Operation proceeds from step 483 to one of: step 484, step 485a or step 485b, depending upon the particular implemented embodiment.

In step 484 N3IWF 406 relays information to inner-most IP header (e.g., ECN field 4601 of 460) as specified in draft RFC draft-ietf-tsvwg-ecn-encap-guidelines-22.

In step 485a of step 485 N3IWF 406 relays information, e.g. ECN congestion information, to outer IP header to UPF 408 as specified in draft RFC draft-ietf-tsvwg-ecn-encap-guidelines-22 and if the PSA UPF is responsible for performing the ECN marking in the UL, the N3IWF 406 can provide congestion information related to congestion experienced by the N3IWF 406 but it may not be able to provide congestion information experienced at the WiFi AP 404. Operation proceeds from step 485a to step 487a.

Based on implementation it may be possible for the N3IWF 406 in step 485b of step 485 to estimate congestion information relative to the access point (i.e., level of congestion of WLAN AP 404) and provide via GTP-U header 463.

In step 486a of step 486 N3IWF 406 provides GTP-U header 463 with congestion information 4631 to UPF 408 and in step 486b of step 486 UPF 408 marks ECN field 4701 in the inner-most header 470 indicating congestion was experienced.

In step 487a of step 487 UPF 408 relays information from UPF outer IP header 473 to UPF 408 inner IP header 470 as specified in draft RFC draft-ietf-tsvwg-ecn-encap-guidelines-22 and in step 487b of step 487 UPF 408 marks ECN field 4701 of the inner-most IP header 470 as specified in draft RFC draft-ietf-tsvwg-ecn-encap-guidelines-22 indicating congestion was experienced.

In the downlink the N3IWF 406 supports the same reference point N3, as the NG-RAN and should be able to support similar L4S functionality as the NG-RAN. Such as:
Method 1: Performing ECN marking according to IETF RFC 9330 and RFC 9331 for downlink in IP layer of the received packets. Also, dedicated QoS flow(s) can be used for carrying L4S enabled IP traffic.
Method 2: If the PSA UPF performs the ECN marking in the downlink, the N3IWF 406 can provide the congestion information via the GTP-U header. The N3IWF 406 shall also be able to receive an indication from the SMF to report congestion information (i.e., a percentage of packets that UPF uses for ECN marking for L4S) of the QoS flow on DL direction via GTP-U header extension to PSA UPF. If there is no UL packet when report for DL needs to be provided the N3IWF 406 may generate an UL Dummy GTP-U packet for such reporting. That is, if congestion is experienced in the downlink by the N3IWF 406, the N3IWF 406 can set the IP header ECN field of the inner IP as well as providing congestion information via GTP-U to PSA UPF in the case the PSA UPF is instructed to perform the ECN marking.

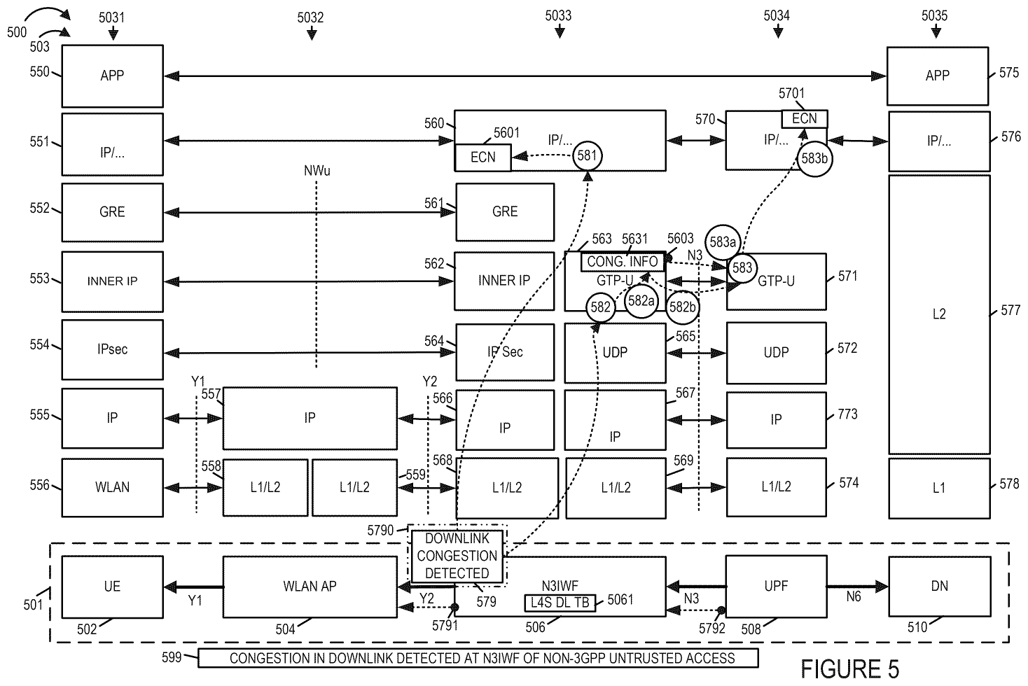

FIG. 5 includes drawing 500 which illustrates congestion in downlink detected at N3IWF 506 of non-3GPP untrusted access (as indicated by title box 599) and subsequent operations performed in response to the detected downlink congestion in accordance with various embodiments of the present invention. Drawing 500 of FIG. 5 illustrates how support for L4S is accomplished, in accordance with various embodiments of the present invention, when congestion is detected (see step 579) at the N3IWF 506 in the downlink.

Drawing 500 illustrates UE 502, WLAN AP 504, e.g., a WiFi AP, N3IWF 506, UPF 508, and DN 510, which are part of exemplary system 501. In some embodiments, UE 502 of FIG. 5 is UE 102 of FIG. 1 and FIG. 2; WLAN AP 504 of FIG. 5 is non-3GPP AP 114 of FIG. 1 and FIG. 2, N3IWF 506 of FIG. 4 is core network interface device 120 of FIG. 1 and FIG. 2; UPF 508 of FIG. 4 is UPF 126 of FIG. 1 and FIG. 2; and DN 510 of FIG. 3 is DN 132 of FIG. 1 and FIG. 2.

Drawing 500 of FIG. 5 further includes a protocol stack diagram 503 illustrating protocol stack for each of the elements (UE 502, WLAN AP 504, N3IWF 506, UPF 508, DN 510), and the communication of congestion information (ECN marking and level of congestion information) in response to uplink congestion detected at the N3IWF 506. The protocol stack 5031 for UE 502 includes an application (APP) layer 550, an IP/ . . . layer 551, a Generic Routing Encapsulation (GRE) layer 552, an Inner IP layer 553, an IPsec layer 554, an IP layer 555 and a WLAN layer 556, as shown. The protocol stack 5032 for WLAN AP 504 includes an IP layer 557, L1/L2 layer component 558 and L1/L2 layer component 559, as shown. The protocol stack 5033 for N3IWF 506 includes an IP/ . . . layer 560, a Generic Routing Encapsulation (GRE) layer 561, an Inner IP layer component 562, a GTP-U layer component 563, an IPsec layer component 564, a UDP layer component 565, IP layer component 566, IP layer component 567, L1/L2 layer component 568, and L1/L2 layer component 569, as shown. The protocol stack 5034 for UPF 508 includes an IP/ . . . layer 570, a GTP-U layer 571, an UDP layer 572, an IP layer 573, and a L1/L2 layer 574, as shown. The protocol stack 5035 for DN 510 includes an application (APP) layer 575, an IP/ . . . layer 576, a L2 layer 577, and a L1 layer 578, as shown.

Solid line arrows (uni-directional arrows and bi-directional arrows) are used in FIG. 5 to represent interfaces (e.g., Y1, Y2, N3, N6, NWu) and/or communications (e.g., communications over those interfaces).

In step 579, N3IWF 506, which is monitoring (in step 5790) the status of its downlink traffic buffers, e.g., L4S downlink traffic buffer(s) 5061, detects downlink congestion. Operation proceeds from step 579 to one of: step 581 or 582, depending upon the particular implementation.

FIG. 5 illustrates 2 alternative operational paths, which may be implemented in response to downlink congestion detected in step 579 at N3IWF 506, to communicate congestion information and perform ECN marking in the innermost IP header. A first alternative path includes step 581. A second alternative path includes steps 582 including sub-steps 582a and 582b, and step 583 including sub-steps 583a and 583b.

In step 581 N3IWF 506 indicates via IP Header ECN field 5601 that congestion was experienced, assuming that the ECN field was set to ECT(1).

In step 582 if the PSA UPF (e.g., UPF 508, which is a PSA UPF) is responsible for performing the ECN marking in the DL, the N3IWF 506 can provide congestion information 5631 related to congestion experienced by the N3IWF 506 via GTP-U header to UPF 508. In step 582a of step 582 the N3IWF 506 is operated to generate a GTP-U header including information indicating that downlink congestion was encountered; and in step 582b of step 582 the NEIWF 506 is operated to communicate, e.g., send, the GTP-U header with the congestion information to UPF 508, said congestion information indicating that downlink congestion was encountered.

In some embodiments, operating the N3IWF 506 to communicate the GTP-U header with the congestion information to UPF 508 includes sending (step 5603) a GTP-U uplink (UL) packet to the UPF 508. In some embodiments, when there is no uplink traffic data to be communicated, the GTP-U UL packet is a dummy packet.

In step 583a of step 583 UPF 508 receives congestion information from the GTP-U header and in step 583b of step 583 UPF 508 sets the ECN field 5701 of 570 accordingly.

Various features and aspects relating to supporting L4S in TNAN in accordance with the present invention will now be described. Trusted (i.e. TNAN) access support for L4S is similar to un-trusted, although 3GPP has responsibility for specifying NWt which can take advantage of features discussed in, or which are similar to, those discussed in draft RFC draft-ietf-tsvwg-ecn-encap-guidelines-22 as described in with regard to Supporting L4S in N3IWF.

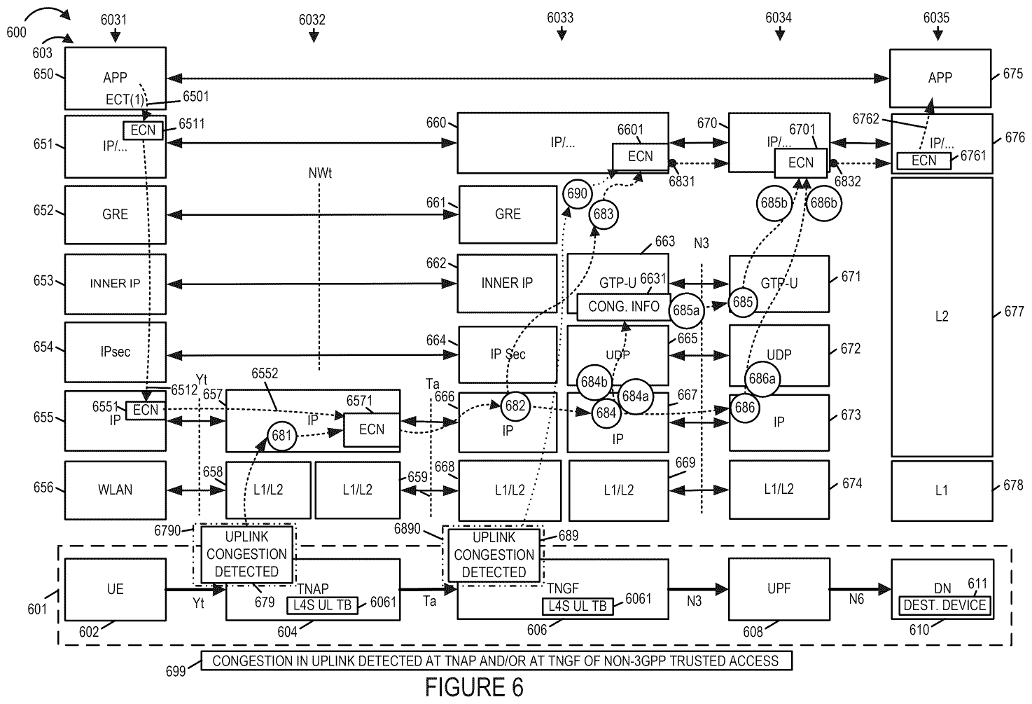

FIG. 6 includes drawing 600 which illustrates congestion in uplink detected at TNAP 604 of non-3GPP trusted access (as indicated by title box 699) and subsequent operations performed in response to the detected uplink congestion in accordance with various embodiments of the present invention. Drawing 600 of FIG. 6 illustrates how support for L4S is accomplished, in accordance with various embodiments of the present invention, when congestion is detected (see step 679) in the uplink at the TNAP 604.

Drawing 600 illustrates UE 602, TNAP 604, TNGF 606, UPF 608, and DN 610, which are part of exemplary system 601. DN 610 includes destination device 611, e.g., a destination server or a destination UE. In some embodiments, UE 602 of FIG. 6 is UE 102 of FIG. 1 and FIG. 2; TNAP 604 of FIG. 6 is non-3GPP AP 114 of FIG. 1 and FIG. 2, TNGF 606 of FIG. 6 is core network interface device 120 of FIG. 1 and FIG. 2; UPF 608 of FIG. 6 is UPF 126 of FIG. 1 and FIG. 2; and DN 610 of FIG. 6 is DN 132 of FIG. 1 and FIG. 2.

Drawing 600 of FIG. 6 further includes a protocol stack diagram 603 illustrating protocol stack for each of the elements (UE 602, TNAP 604, TNGF 606, UPF 608, DN 610), and the communication of congestion information (ECN marking and level of congestion information) in response to uplink congestion detected at the TNAP 604. The protocol stack 6031 for UE 602 includes an application (APP) layer 650, an IP/ . . . layer 651, a Generic Routing Encapsulation (GRE) layer 652, an Inner IP layer 653, an IPsec layer 654, an IP layer 655 and a WLAN layer 656, as shown. The protocol stack 6032 for TNAP 604 includes an IP layer 657, L1/L2 layer component 658 and L1/L2 layer component 659, as shown. The protocol stack 6033 for TNGF 606 includes an IP/ . . . layer 660, a Generic Routing Encapsulation (GRE) layer 661, an Inner IP layer component 662, a GTP-U layer component 663, an IPsec layer component 664, a UDP layer component 665, IP layer component 666, IP layer component 667, L1/L2 layer component 668, and L1/L2 layer component 669, as shown. The protocol stack 6034 for UPF 608 includes an IP/ . . . layer 670, a GTP-U layer 671, an UDP layer 672, an IP layer 673, and a L1/L2 layer 674, as shown. The protocol stack 6035 for DN 610 includes an application (APP) layer 675, an IP/ . . . layer 676, a L2 layer 677, and a L1 layer 678, as shown.

Solid line arrows (uni-directional arrows and bi-directional arrows) are used in FIG. 6 to represent interfaces (e.g., Yt, Ta, N3, N6, NWt) and/or communications (e.g., communications over those interfaces).

An application 650, e.g., an L4S application, in UE 602 sets (in step 6501) the ECN field 6511 in the innermost IP header 651 to ECT(1), e.g., a bit pattern of 01. UE 602, relays, e.g., copies, (in step 6512) the ECT(1) indication from the ECN field 6511 of the innermost IP header 651 to the ECN field 6551 of the outer IP header 655 of UE 602. UE 602 communicates (in step 6552) the outer IP header 655 ECN field 6551 setting, indicating ECT(1), of the UE 602 to the ECN field 6571 of the outer IP header 657 of TNAP 604.

In step 679, TNAP 604, which is monitoring (in step 6790) the status of its uplink traffic buffers, e.g., L4S uplink traffic buffer(s) 6061, detects uplink congestion. Operation proceeds from step 679 to step 681.

FIG. 6 illustrates 3 alternative operational paths, which may be implemented in response to uplink congestion detected in step 679 at TNAP 604, to communicate congestion information and perform ECN marking in the innermost IP header. A first alternative path includes steps 681, 682, and 683. A second alternative path includes steps 681, 682, 684b, 685a, and 685b. A third alternative path includes steps 681, 682, 684a, 686a and 686b.

In step 681 TNAP 604 indicates via IP Header ECN field 6571 that congestion was experienced, assuming that the ECN field was set to ECT(1). Thus, in step 681 TNAP 604 changes, e.g., sets, the value in ECN field 6571 to indicate congestion experienced (CE), e.g., the bit pattern in ECN field 6571 is changed from 01 to 11. Operation proceeds from step 681 to step 682. In step 682 TNGF 606 detects outer IP header ECN field is set indicating congestion. Operation proceeds from step 682 to one of: step 683, 684a or step 684b, depending upon the implemented embodiment.

In step 683 TNGF 606 relays information to inner IP header (e.g., to ECN field 6601 in 660) (which is the innermost IP header) as specified in draft RFC draft-ietf-tsvwg-ecn-encap-guidelines-22.

In step 684a of step 684 TNGF 606 relays information to outer IP header to UPF 608 as specified in draft RFC draft-ietf-tsvwg-ecn-encap-guidelines-22 and if the PSA UPF (e.g., where UPF 608 is a PSA UPF) is responsible for performing the ECN marking in the UL, the TNGF 606 can provide congestion information related to congestion experienced by the TNGF 606 but may not be able to provide congestion information experienced by the TNAP 604.

Based on implementation it may be possible, in step 684b, for the TNGF 606 to estimate congestion information relative to the access point (i.e., level of congestion of TNAP) and provide congestion information 6631, e.g., ECN information, and, in some embodiments, estimated level of congestion information, via GTP-U header. In step 685a of step 685 TNGF 606 provides GTP-U header with congestion information 6631 to UPF 608 and in step 685b of step 685 UPF 608 marks ECN field 6701 indicating congestion was experienced.

In step 686a of step UPF 608 relays information, e.g., congestion information, from outer IP header to UPF 608 inner IP header 6701 as specified in draft RFC draft-ietf-tsvwg-ecn-encap-guidelines-22 and in step 686b of step 686 UPF 608 marks ECN field 6701 as specified in draft RFC draft-ietf-tsvwg-ecn-encap-guidelines-22 indicating congestion was experienced.

If congestion is experienced in the uplink by the TNGF 606, not illustrated, it is capable of setting the IP header ECN field of the inner IP as well as providing congestion information via GTP-U to PSA UPF 608 in the case the PSA UPF 608 is instructed to perform the ECN marking.

If congestion is experienced in the uplink by the TNGF 606 and the TNAP 604, the ECN marking provided by the TNAP 604 (if supported) would take precedent and relayed to the inner most IP layer for use by the receiving application. If the congestion in the uplink at the TNGF 606 persists, it will eventually perform the ECN marking once the congestion from the TNAP 604 is removed.

Like uplink, it is most probably likely that if congestion is experienced in the downlink it is related to the wireless link (i.e., TNAP 604) and 3GPP does not have responsibility for the AP specification but can relay any congestion notification that the TNAP 604 provides to the inner most IP layer at the UE 602. This is accomplished by leveraging IETF draft RFC, draft-ietf-tsvwg-ecn-encap-guidelines-22, which provides Guidelines for Adding Congestion Notification to Protocols that Encapsulate IP.

Drawing 600 of FIG. 6 further illustrates an example of exemplary embodiment in which the TNGF 606 is enabled to monitor for congestion in the uplink and perform ECN marking in response to detected congestion. Drawing 600 of FIG. 6 illustrates how support for L4S is accomplished, in accordance with various embodiments of the present invention, when congestion is detected (see step 689) at the TNGF 606 in the uplink. In step 689, TNGF 606, which is monitoring (in step 6890) the status of its uplink traffic buffers, e.g., L4S uplink traffic buffer(s) 6061, detects uplink congestion. Operation proceeds from step 689 to step 690. In step 690 TNGF 606 indicates via IP Header ECN field 6601 that congestion was experienced, assuming that the ECN field was set to ECT(1). Thus in step 690 TNGF 606 communicates congestion information and performs ECN marking directly in innermost IP header 6601.

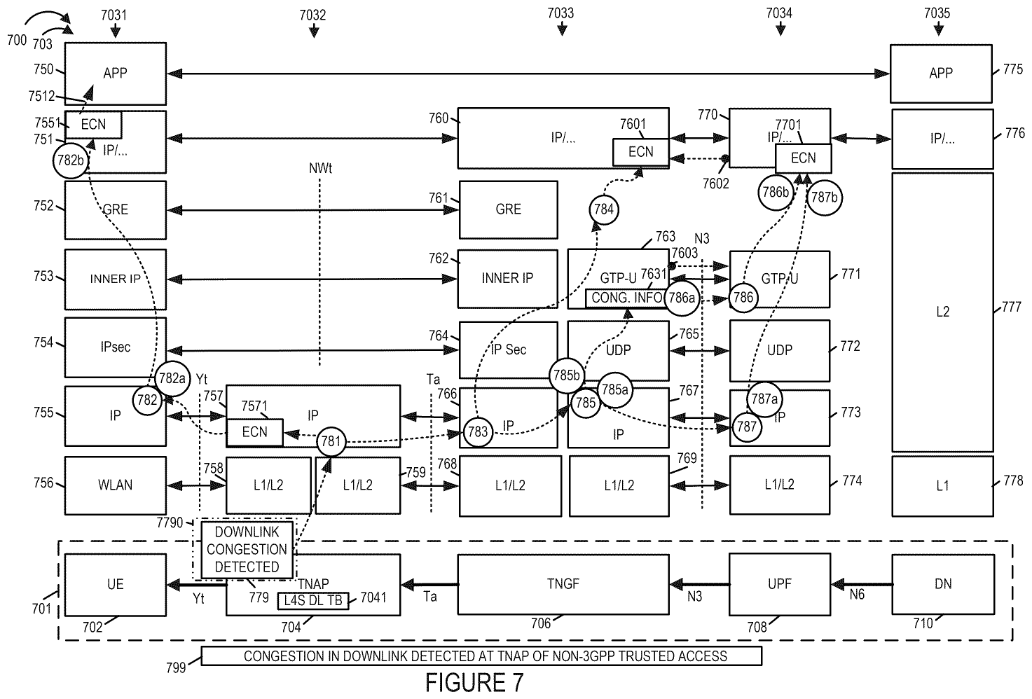

FIG. 7 includes drawing 700 which illustrates Congestion in downlink detected at TNAP 704 of non-3GPP trusted access (as indicated by title box 799) and subsequent operations performed in response to the detected downlink congestion in accordance with various embodiments of the present invention. Drawing 700 of FIG. 7 illustrates how support for L4S is accomplished, in accordance with various embodiments of the present invention, when congestion is detected (see step 779) at the TNAP 704 in the downlink.

Drawing 700 illustrates UE 702, TNAP 704, TNGF 706, UPF 708, and DN 710, which are part of exemplary system 701. In some embodiments, UE 702 of FIG. 7 is UE 102 of FIG. 1 and FIG. 2; TNAP 704 of FIG. 7 is non-3GPP AP 114 of FIG. 1 and FIG. 2, TNGF 706 of FIG. 7 is core network interface device 120 of FIG. 1 and FIG. 2; UPF 708 of FIG. 7 is UPF 126 of FIG. 1 and FIG. 2; and DN 710 of FIG. 7 is DN 132 of FIG. 1 and FIG. 2.

Drawing 700 of FIG. 7 further includes a protocol stack diagram 703 illustrating protocol stack for each of the elements (UE 702, TNAP 704, TNGF 706, UPF 708, DN 710), and the communication of congestion information (ECN marking and level of congestion information) in response to downlink congestion detected at the TNAP 704. The protocol stack 7031 for UE 702 includes an application (APP) layer 750, an IP/ . . . layer 751, a Generic Routing Encapsulation (GRE) layer 752, an Inner IP layer 753, an IPsec layer 754, an IP layer 755 and a WLAN layer 756, as shown. The protocol stack 7032 for TNAP 704 includes an IP layer 757, L1/L2 layer component 758 and L1/L2 layer component 759, as shown. The protocol stack 7033 for TNGF 706 includes an IP/ . . . layer 760, a Generic Routing Encapsulation (GRE) layer 761, an Inner IP layer component 762, a GTP-U layer component 763, an IPsec layer component 764, a UDP layer component 765, IP layer component 766, IP layer component 767, L1/L2 layer component 768, and L1/L2 layer component 769, as shown. The protocol stack 7034 for UPF 708 includes an IP/ . . . layer 770, a GTP-U layer 771, an UDP layer 772, an IP layer 773, and a L1/L2 layer 774, as shown. The protocol stack 7035 for DN 710 includes an application (APP) layer 775, an IP/ . . . layer 776, a L2 layer 777, and a L1 layer 778, as shown.

Solid line arrows (uni-directional arrows and bi-directional arrows) are used in FIG. 7 to represent interfaces (e.g., Yt, Ta, N3, N6, NWt) and/or communications (e.g., communications over those interfaces).

An application, e.g., an L4S application, in DN 710 sets an ECN field in the innermost IP header 776 to ECT(1), e.g., a bit pattern of 01. DN 702, relays, e.g., copies, the ECT(1) indication from the ECN field of the innermost IP header 776 to the ECN field of the outer IP header of DN 710. DN 710 communicates, e.g., via UPF 708, and TNGF 706, the outer IP header ECN field setting, indicating ECT(1), to the ECN field 4771 of the outer IP header 757 of TNAP 704.

In step 779, TNAP 704, which is monitoring (in step 7790) the status of its downlink traffic buffers, e.g., L4S DL traffic buffer(s) 7041, detects downlink congestion. Operation proceeds from step 779 to step 781.

FIG. 7 illustrates 4 alternative operational paths, which may be implemented in response to uplink congestion detected in step 679 at TNAP 704, to communicate congestion information and perform ECN marking in the innermost IP header. A first alternative path includes step 781 and step 782 including sub-steps 782a and 782b. A second alternative path includes steps 781, 783, and 784. A third alternative path includes steps 781, 783, 785a, and 787 including sub-steps 787a and 787b. A fourth alternative path includes steps 781, 783, 785b, and 786 including sub-steps 786a and 786b.

In step 781 TNAP 704 indicates via IP Header ECN field 7571 that congestion was experienced, assuming that the ECN field was set to ECT(1). Thus, in step 781 TNAP 704 changes, e.g., sets, the value in ECN field 7571 to indicate congestion experienced (CE), e.g., the bit pattern in ECN field 7571 is changed from 01 to 11. Operation proceeds from step 781 to step 782 or step 783, depending upon the particular implemented embodiment.

In step 782a of step 782 UE 702 detects outer IP header ECN field is set indicating congestion. In step 782b of step 782 UE 702 relays information to inner IP header (ECN field 7551 of 751) as specified in draft RFC draft-ietf-tsvwg-ecn-encap-guidelines-22. In step 783 TNGF 706 detects outer IP header ECN field is set indicating congestion. Operation proceeds from step 783 to one of steps 784, 785a or 785b, depending upon the particular implemented embodiment.

In step 784 TNGF 706 relays information to inner IP header (ECN field 7601 of 760) as specified in draft RFC draft-ietf-tsvwg-ecn-encap-guidelines-22.

In step 785a of step 785 TNGF 706 relays information to outer IP header to UPF 708 as specified in draft RFC draft-ietf-tsvwg-ecn-encap-guidelines-22 and if the PSA UPF (e.g., where UPF 708 is a PSA UPF) is responsible for performing the ECN marking in the DL, the TNGF 706 can provide congestion information related to congestion experienced by the TNGF 706 but may not be able to provide congestion information experienced by the TNAP 704.

Based on implementation it may be possible, in step 785b of step 785, for the TNGF 706 to estimate congestion information relative to the access point (i.e., level of congestion of TNAP 704) and provide. In step 786a congestion information 7631, e.g., ECN information, and in some embodiments estimated level of congestion at the TNAP 704, via GTP-U header 763. In step 785b the TNGF 706 is operated to generate a GTP-U header including information indicating that downlink congestion was encountered; and in step 786a the TNGF 706 is operated to communicate, e.g., send, the GTP-U header with the congestion information to UPF 708, said congestion information indicating that downlink congestion was encountered.

In some embodiments, operating the TNGF 706 to communicate the GTP-U header with the congestion information to UPF 708 includes sending (step 7603) a GTP-U uplink (UL) packet to the UPF 708. In some embodiments, when there is no uplink traffic data to be communicated, the GTP-U UL packet is a dummy packet.

Thus, in step 786a of step 786 TNGF 706 provides GTP-U header 763 with congestion information 7631 to UPF 708, and in step 786b of step 786 UPF 708 marks ECN field 7701 indicating congestion was experienced.

In step 785a of step 785 UPF 708 relays information (e.g., received congestion ECN information indicative of downlink congestion at TNAP 704) from outer IP header 773 to innermost IP header 770 as specified in draft RFC draft-ietf-tsvwg-ecn-encap-guidelines-22 and in step 787b of step 787 UPF 708 marks ECN field 7701 of inner-most IP header 770 as specified in draft RFC draft-ietf-tsvwg-ecn-encap-guidelines-22 indicating congestion was experienced.

In the downlink the TNGF 706 supports the same reference point N3, as the NG-RAN and should be able to support similar L4S functionality as the NG-RAN. Such as:
Method 1: Performing ECN marking according to IETF RFC 9330 and RFC 9331 for downlink in IP layer of the received packets. Also, dedicated QoS flow(s) can be used for carrying L4S enabled IP traffic.
Method 2: If the PSA UPF 708 performs the ECN marking in the downlink, the TNGF 706 can provide the congestion information via the GTP-U header. The TNGF 706 shall also be able to receive an indication from the SMF to report congestion information (i.e., a percentage of packets that UPF 708 uses for ECN marking for L4S) of the QoS flow on DL direction via GTP-U header extension to PSA UPF 708. If there is no UL packet when report for DL needs to be provided the TNGF 706 may generate an UL Dummy GTP-U packet for such reporting. That is, if congestion is experienced in the downlink by the TNGF 706, the TNGF 706 can set the IP header ECN field of the inner IP as well as providing congestion information via GTP-U to PSA UPF 708 in the case the PSA UPF 708 is instructed to perform the ECN marking.

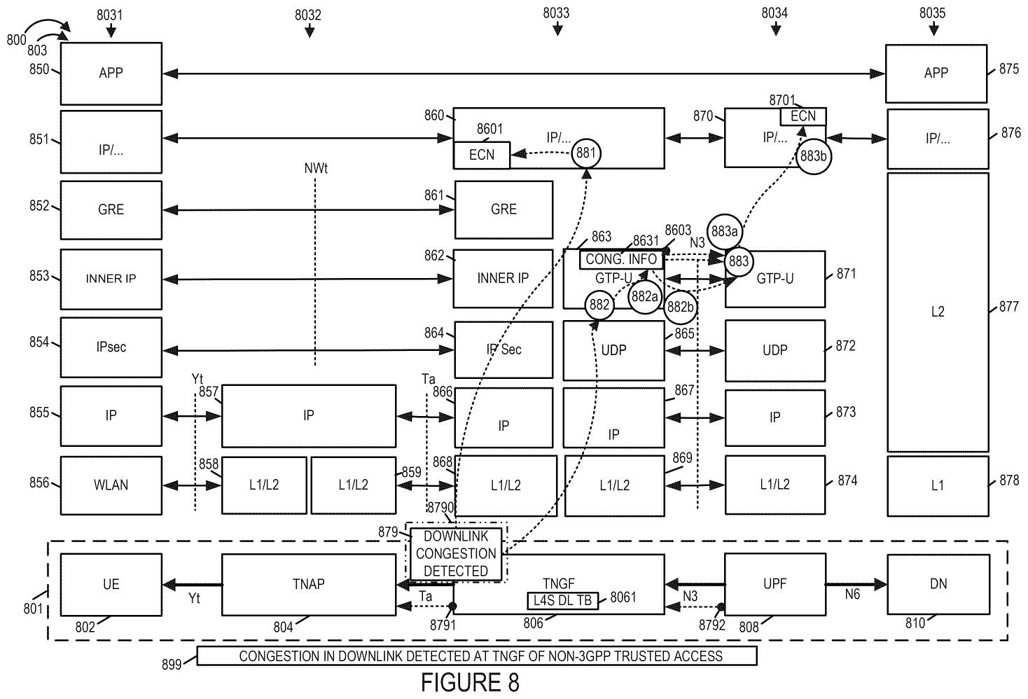

FIG. 8 includes drawing 800 which illustrates congestion in downlink detected at TNGF 806 of non-3GPP trusted access (as indicated by title box 899) and subsequent operations performed in response to the detected uplink congestion in accordance with various embodiments of the present invention. Drawing 800 of FIG. 8 illustrates how support for L4S is accomplished, in accordance with various embodiments of the present invention, when congestion is detected (see step 879) at the TNGF 806 in the downlink.

Drawing 800 illustrates UE 802, TNAP 804, TNGF 806, UPF 808, and DN 810, which are part of exemplary system 801. In some embodiments, UE 802 of FIG. 8 is UE 102 of FIG. 1 and FIG. 2; TNAP 804 of FIG. 8 is non-3GPP AP 114 of FIG. 1 and FIG. 2, TNGF 806 of FIG. 8 is core network interface device 120 of FIG. 1 and FIG. 2; UPF 808 of FIG. 8 is UPF 126 of FIG. 1 and FIG. 2; and DN 810 of FIG. 8 is DN 132 of FIG. 1 and FIG. 2.

Drawing 800 of FIG. 8 further includes a protocol stack diagram 803 illustrating protocol stack for each of the elements (UE 802, TNAP 804, TNGF 806, UPF 808, DN 810), and the communication of congestion information (ECN marking and level of congestion information) in response to downlink congestion detected at the TNGF 806. The protocol stack 8031 for UE 802 includes an application (APP) layer 850, an IP/ . . . layer 851, a Generic Routing Encapsulation (GRE) layer 852, an Inner IP layer 853, an IPsec layer 854, an IP layer 855 and a WLAN layer 856, as shown. The protocol stack 8032 for TNAP 804 includes an IP layer 857, L1/L2 layer component 858 and L1/L2 layer component 859, as shown. The protocol stack 8033 for TNGF 806 includes an IP/ . . . layer 860, a Generic Routing Encapsulation (GRE) layer 861, an Inner IP layer component 862, a GTP-U layer component 863, an IPsec layer component 864, a UDP layer component 865, IP layer component 866, IP layer component 867, L1/L2 layer component 868, and L1/L2 layer component 869, as shown. The protocol stack 8034 for UPF 808 includes an IP/ . . . layer 870, a GTP-U layer 871, an UDP layer 872, an IP layer 873, and a L1/L2 layer 874, as shown. The protocol stack 8035 for DN 810 includes an application (APP) layer 875, an IP/ . . . layer 876, a L2 layer 877, and a L1 layer 878, as shown.

Solid line arrows (uni-directional arrows and bi-directional arrows) are used in FIG. 8 to represent interfaces (e.g., Yt, Ta, N3, N6, NWt) and/or communications (e.g., communications over those interfaces).

In step 879, TNGF 806, which is monitoring (in step 8790) the status of its downlink traffic buffers, e.g., L4S DL traffic buffer(s) 8061, detects downlink congestion. Operation proceeds from step 879 to one of: step 881 or 882, depending upon the particular implementation.

FIG. 8 illustrates 2 alternative operational paths, which may be implemented in response to downlink congestion detected in step 879 at TNGF 806, to communicate congestion information and perform ECN marking in the innermost IP header. A first alternative path includes step 881. A second alternative path includes steps 882 including sub-steps 882a and 882b, and step 883 including sub-steps 883a and 883b.

In step 881 TNGF 806 indicates via IP Header ECN field 8601 that congestion was experienced, assuming that the ECN field was set to ECT(1).

In step 882 if the PSA UPF (e.g., where UPF 808 is a PSA UPF) is responsible for performing the ECN marking in the DL, the TNGF 806 can provide congestion information (8631) related to congestion experienced by the TNGF 806 via GTP-U header (863) to UPF 808. In step 882a of step 882 the TNGF 806 is operated to generate a GTP-U header including information indicating that downlink congestion was encountered; and in step 882b of step 882 the TNGF 806 is operated to communicate, e.g., send, the GTP-U header with the congestion information to UPF 808, said congestion information indicating that downlink congestion was encountered.

In some embodiments, operating the TNGF 806 to communicate the GTP-U header with the congestion information to UPF 808 includes sending (step 8603) a GTP-U uplink (UL) packet to the UPF 808. In some embodiments, when there is no uplink traffic data to be communicated, the GTP-U UL packet is a dummy packet.

In step 883a of step 883 UPF 808 receives congestion information 8631 from the GTP-U header and in step 883b of step 883 UPF 808 sets the ECN field 8701 of 870 accordingly.

Various features and/or aspects relating to supporting L4S in UE will now described.

A 3GPP UE, implemented in accordance with some embodiments of the present invention, may, and sometimes does, also provide uplink support for L4S when connecting to a 5GS via a non-3GPP access.

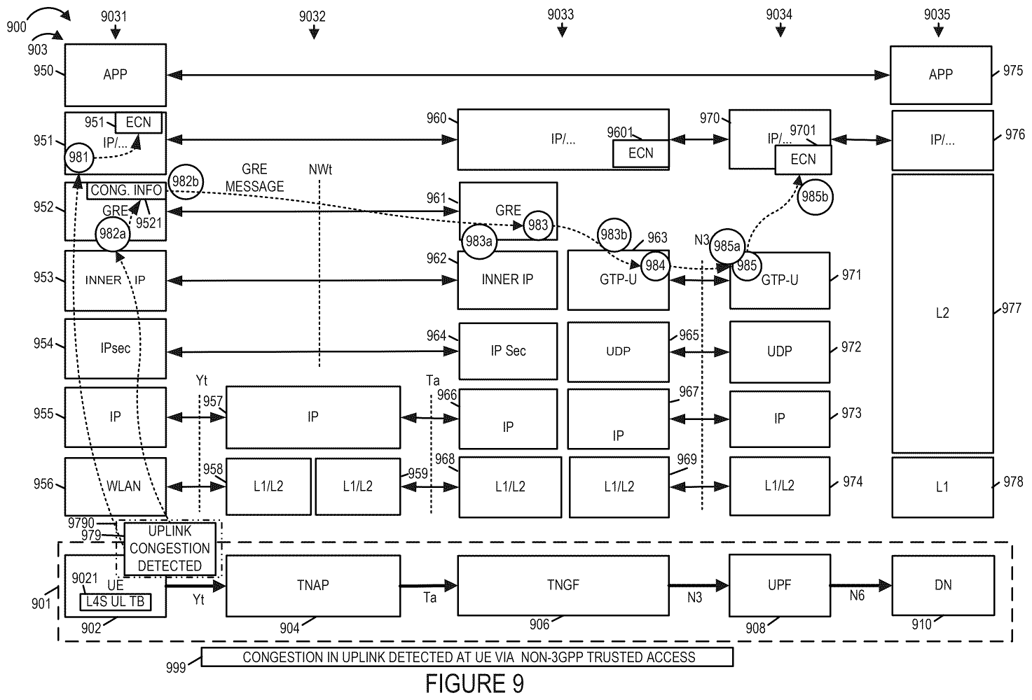

FIG. 9 includes drawing 900 which illustrates congestion in uplink detected at UE 902 via non-3GPP trusted access (as indicated by title box 999) and subsequent operations performed in response to the detected uplink congestion in accordance with various embodiments of the present invention. Drawing 900 of FIG. 9 illustrates how support for L4S is accomplished, in accordance with various embodiments of the present invention, when congestion is detected (see step 979) in the uplink at the UE 902 when accessing a 5GS via a non-3GPP trusted access (i.e., TNAP+TNGF).

Drawing 900 illustrates UE 902, TNAP 904, TNGF 906, UPF 908, and DN 910, which are part of exemplary system 901. In some embodiments, UE 902 of FIG. 9 is UE 102 of FIG. 1 and FIG. 2; TNAP 904 of FIG. 9 is non-3GPP AP 114 of FIG. 1 and FIG. 2, TNGF 906 of FIG. 9 is core network interface device 120 of FIG. 1 and FIG. 2; UPF 908 of FIG. 9 is UPF 126 of FIG. 1 and FIG. 2; and DN 910 of FIG. 9 is DN 132 of FIG. 1 and FIG. 2.

Drawing 900 of FIG. 9 further includes a protocol stack diagram 903 illustrating protocol stack for each of the elements (UE 902, TNAP 904, TNGF 906, UPF 908, DN 910), and the communication of congestion information (ECN marking and level of congestion information) in response to uplink congestion detected at the UE 902. The protocol stack 9031 for UE 902 includes an application (APP) layer 950, an IP/ . . . layer 951, a Generic Routing Encapsulation (GRE) layer 952, an Inner IP layer 953, an IPsec layer 954, an IP layer 955 and a WLAN layer 956, as shown. The protocol stack 9032 for TNAP 904 includes an IP layer 957, L1/L2 layer component 958 and L1/L2 layer component 959, as shown. The protocol stack 9033 for TNGF 906 includes an IP/ . . . layer 960, a Generic Routing Encapsulation (GRE) layer 961, an Inner IP layer component 962, a GTP-U layer component 963, an IPsec layer component 964, a UDP layer component 965, IP layer component 966, IP layer component 967, L1/L2 layer component 968, and L1/L2 layer component 969, as shown. The protocol stack 9034 for UPF 908 includes an IP/ . . . layer 970, a GTP-U layer 971, an UDP layer 972, an IP layer 973, and a L1/L2 layer 974, as shown. The protocol stack 9035 for DN 910 includes an application (APP) layer 975, an IP/ . . . layer 976, a L2 layer 977, and a L1 layer 978, as shown.

Solid line arrows (uni-directional arrows and bi-directional arrows) are used in FIG. 9 to represent interfaces (e.g., Yt, Ta, N3, N6, NWt) and/or communications (e.g., communications over those interfaces).

In step 979, UE 902, which is monitoring (in step 9790) the status of its uplink traffic buffers, e.g., L4S ulink traffic buffer(s) 9021, detects uplink congestion. Operation proceeds from step 979 to one of: step 981 or 982, depending upon the particular implementation.

FIG. 9 illustrates 2 alternative operational paths, which may be implemented in response to uplink congestion detected in step 979 at UE 902, to communicate congestion information and perform ECN marking in the innermost IP header. A first alternative path includes step 981. A second alternative path includes steps 982 including sub-steps 982a and 982b, step 983 including sub-steps 983a and 983b, step 984, and step 985 including sub-steps 985a and 985b.

In step 981 UE 902 indicates via inner-most IP Header 951 ECN field 9511 that congestion was experienced, assuming that the ECN field was set to ECT(1).

In step 982 if the PSA UPF (e.g., wherein UPF 908 is a PSA UPF) is responsible for performing the ECN marking in the UL, the UE 902 can provide congestion information 9521 related to congestion experienced by the UE 902 via GRE 952 to the TNGF 906. In step 982a of step 982, the UE 902 is operated to generate a GRE message indicating that uplink congestion was experienced at UE 902. In step 982b of step 982 UE 902 is operated to provide, e.g., send, congestion information, related to the congestion experienced by UE 902, via the GRE message to TNGF 906.

In step 983a of step 983 TNGF 906 detects GRE message and in step 983b of step 983 TNGF 906 provides the UE's congestion information on the GTP-U header 963 to UPF 908. In step 983b TNGF 906 generates a GTP-U header including the UE provided congestion information to be sent to UPF 908.

In step 984 TNGF 906 sends GTP-U message header containing congestion information to UPF 908.

In step 985a of step 985 UPF 908 receives congestion information from the GTP-U header and in step 985b of step 985 UE 908 sets the ECN field 9701 in the inner-most IP header 970 accordingly.

Impacts on services, entities and interfaces will now be described.
PCF, implemented in accordance with features and/or aspects of the present invention, enables the non-3GPP access (i.e. N3IWF and TNGF) to relay ECN marking from the WLAN AP IP or TNAP header.
UE, N3IWF, TNGF, & UPF, implemented in accordance with features and/or aspects of the present invention provide support for draft RFC draft-ietf-tsvwg-ecn-encap-guidelines-22.

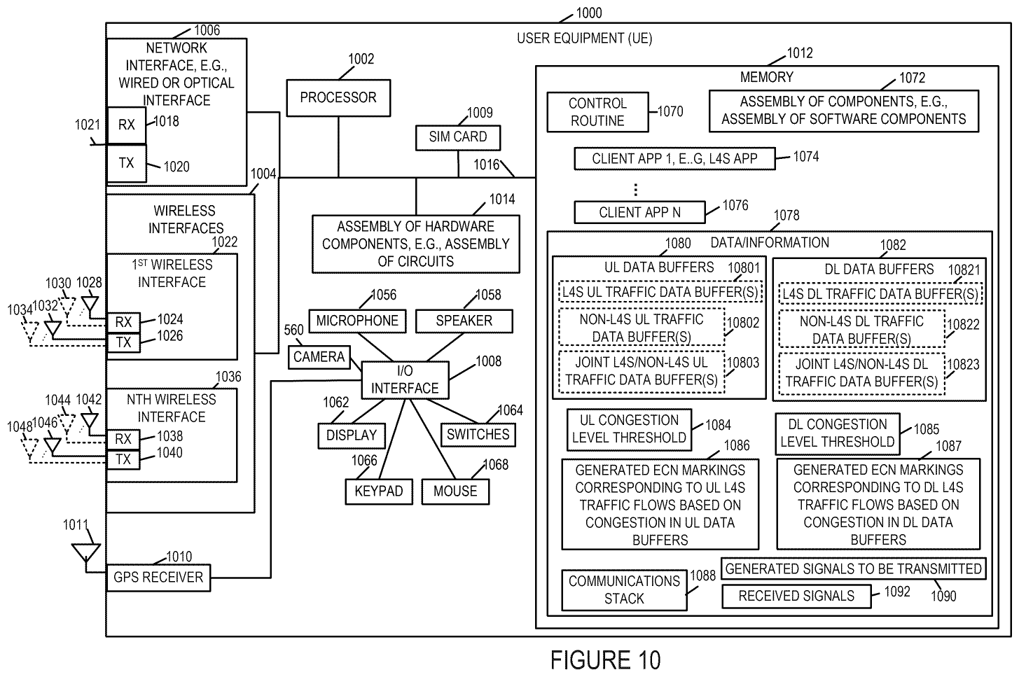

FIG. 10 is a drawing of an exemplary user equipment (UE) 1000 implemented in accordance with an exemplary embodiment. UE 1000 is, e.g., any of the UEs shown in FIGS. 1-9. UE 1000 includes processor 1002, e.g., a CPU, wireless interfaces 1004, network interface 1006, I/O interface 1008, Subscriber Identity module (SIM) card 1009, GPS receiver 1010, memory 1012 and assembly of hardware components 1014, e.g., an assembly of circuits, coupled together via bus 1016 over which the various elements may exchange data and information.

Wireless interfaces 1004 includes a plurality of wireless interfaces (1st wireless interface 1022, . . . , Nth wireless interface 1036). 1st wireless interface 1022 includes wireless receiver (RX) 1024 and wireless transmitter (TX) 1026. Wireless receiver 1024 is coupled to one or more receive antennas or antenna elements (1028, . . . , 1030) via which the UE 1000 receives wireless signals, e.g., from a WLAN AP. Wireless transmitter 1026 is coupled to one or more transmit antennas or antenna elements (1032, . . . , 1034) via which the UE 1000 transmits wireless signals, e.g., to a WLAN AP. In some embodiments, the same antennas are used for transmit and receive with regard to the 1st wireless interface 1022. Nth wireless interface 1036 includes wireless receiver (RX) 1038 and wireless transmitter (TX) 1040. Wireless receiver 1038 is coupled to one or more receive antennas or antenna elements (1042, . . . , 1044) via which the UE 1000 receives wireless signals, e.g., from a TNAP. Wireless transmitter 1040 is coupled to one or more transmit antennas or antenna elements (1046, . . . , 1048) via which the UE 1000 transmits wireless signals, e.g., to a TNAP. In some embodiments, the same antennas are used for transmit and receive with regard to the 2nd wireless interface 1036. In some embodiments the 1st wireless interface 1022 and the nth wireless interface 1036 are used for different communications bands and/or correspond to different technologies.

Network interface 1006, e.g., a wired or optical interface, includes receiver 1018, transmitter 1020 and connector 1021. Network interface 1006 allows the UE 1000 to connect to a wired or optical interface, when the UE 1000 is stationary and the wired or optical interface is available.

GPS receiver 1010 is coupled to GPS antenna 1011 via which the UE 1000 receives GPS signals used to determine time, UE position, and velocity. UE 1000 further includes a plurality of I/O devices (microphone 1056, speaker 1058, camera 1060, display 1062, e.g., a touch screen display, switches 1064, keypad 1066, and mouse 1068) coupled to I/O interface 1008 via which the via I/O devices may interact with other elements within UE 1000.

Memory 1012 includes a control routine 1070, an assembly of components 1072, e.g., an assembly of software components, a plurality of client applications (client app 1 1074, e.g., an L4S application, . . . , client app N 1076), and data/information 1078. Different applications may, and sometimes do, have different requirements with regard to latency, etc. For example some applications require classic SF ECT(0) and some applications require LL SF ECT(1).

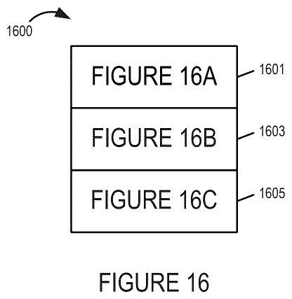

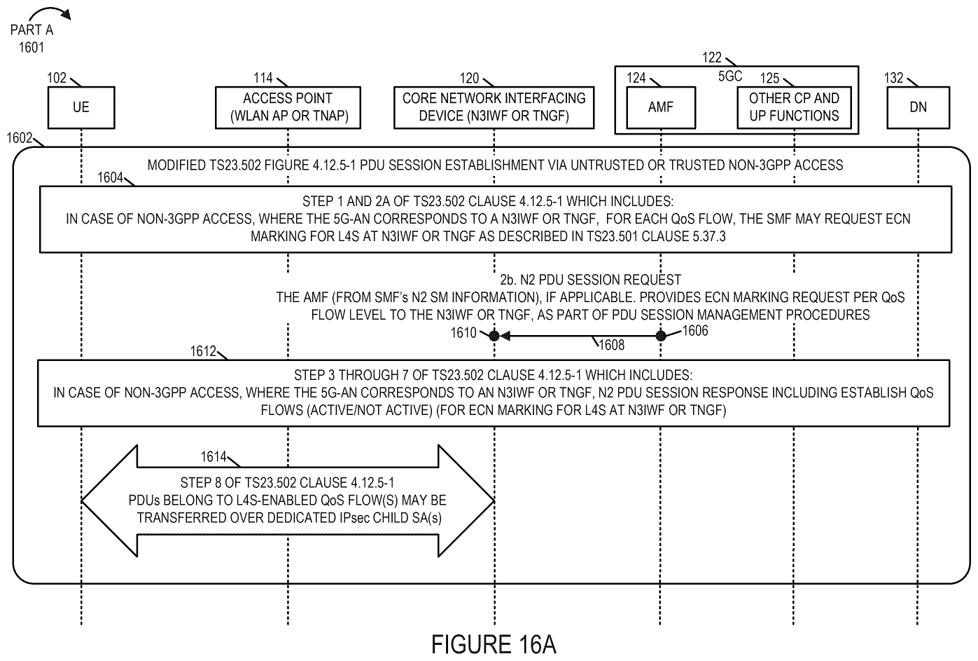

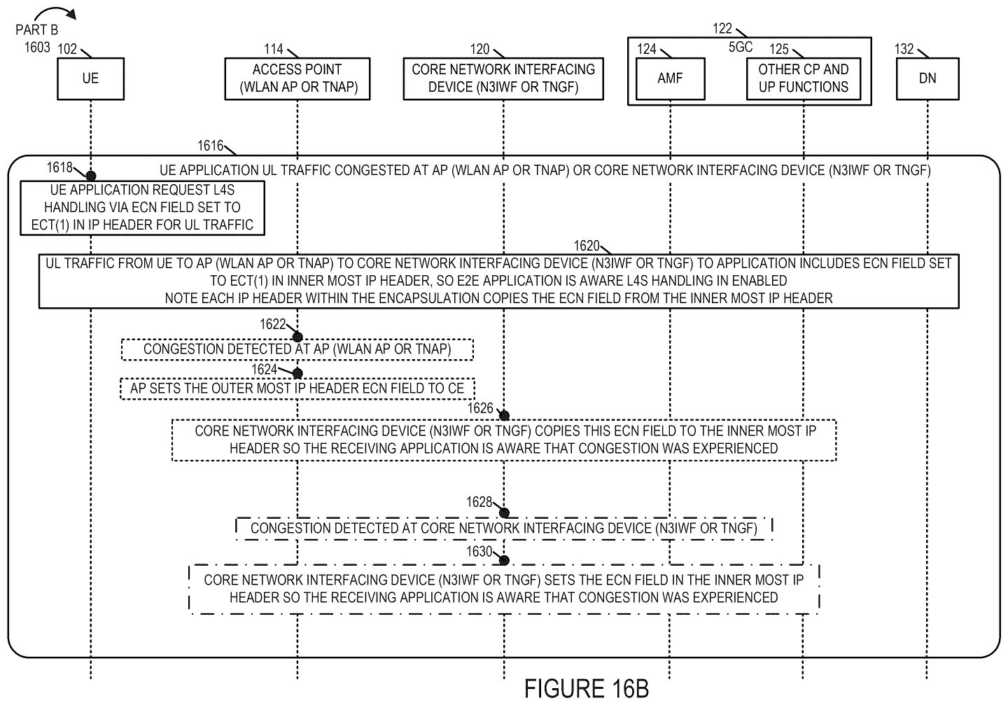

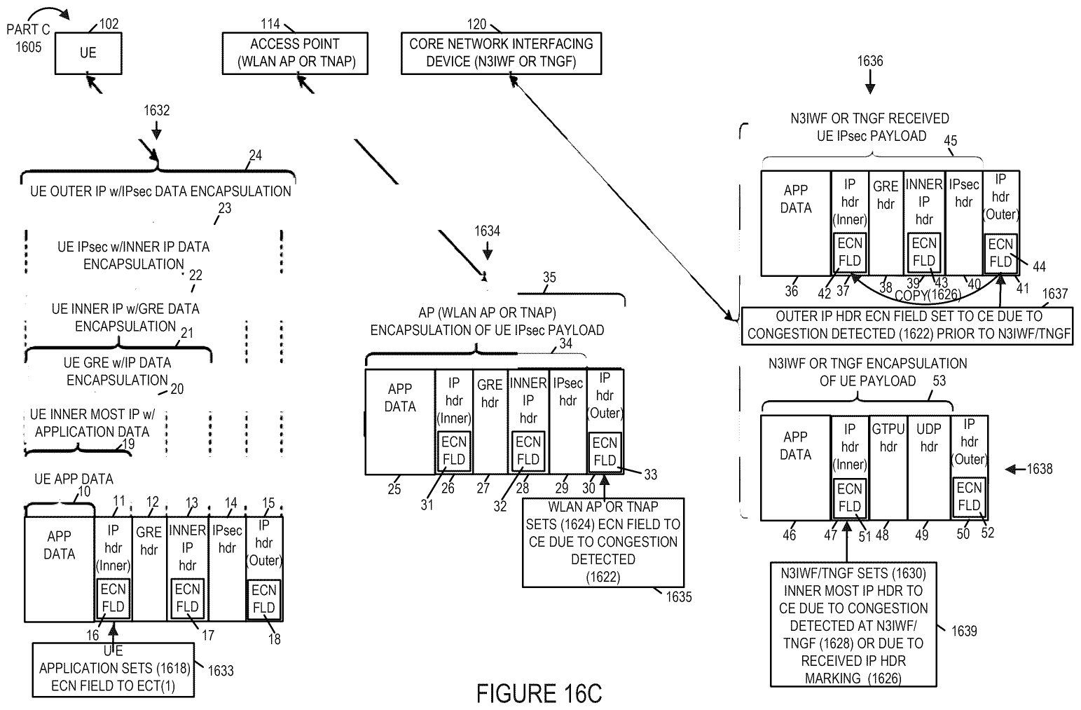

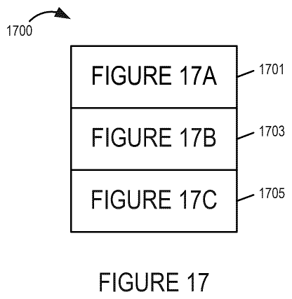

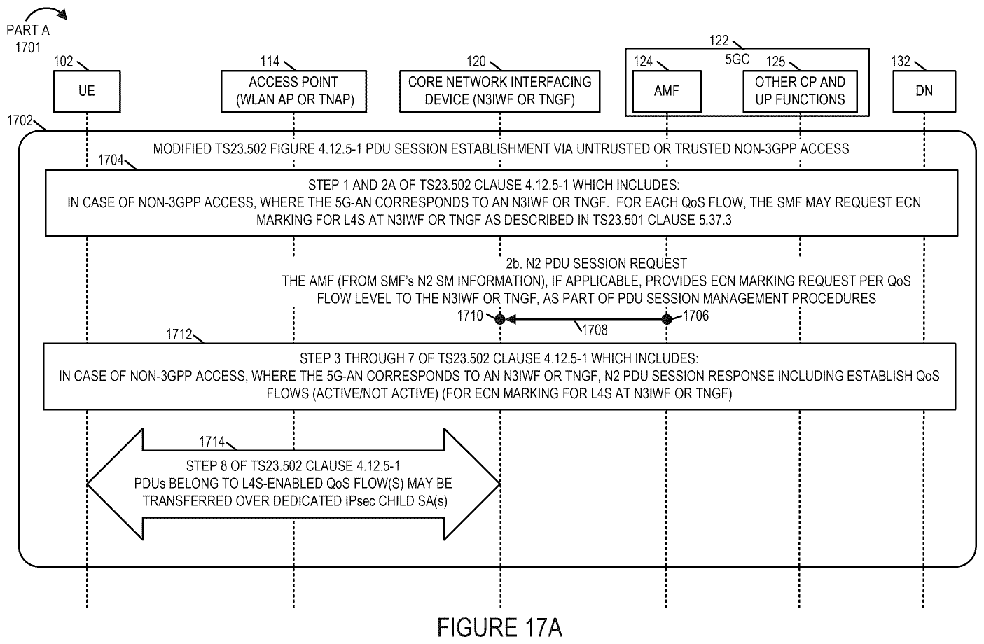

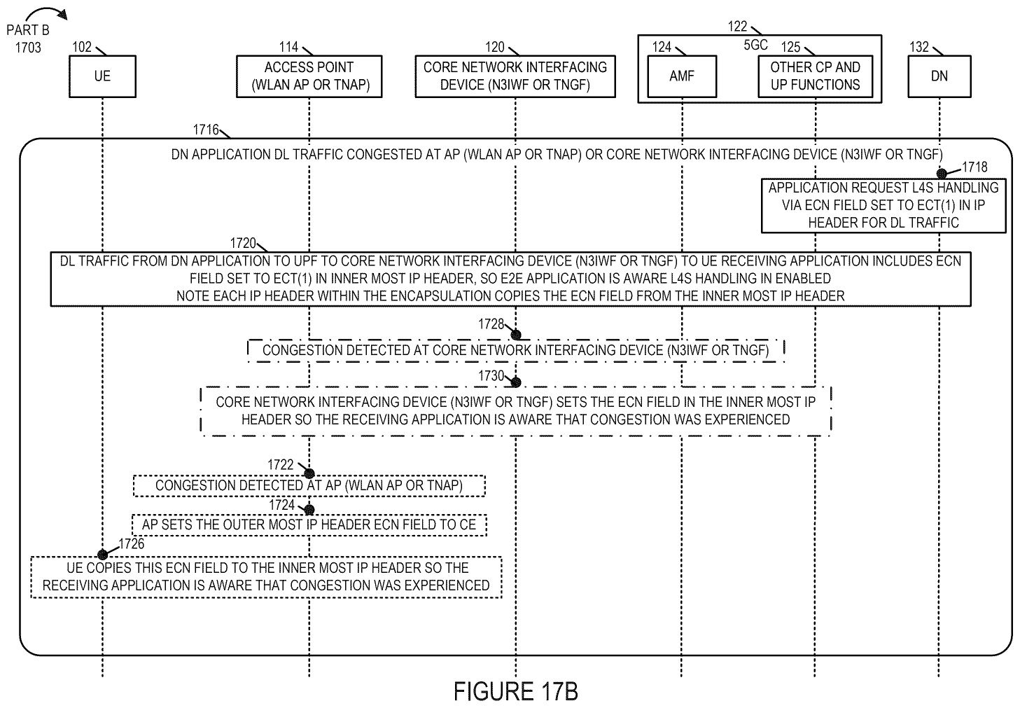

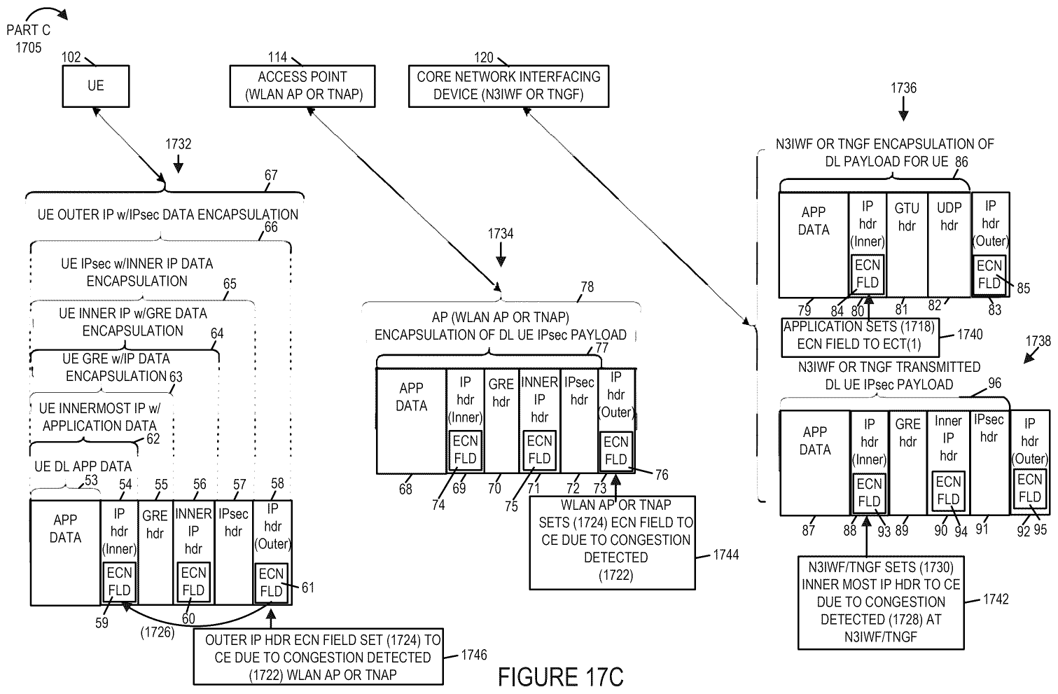

Control routine 1070 includes instructions which when executed by processor 1002 control the UE 1000 to implement basic operational functions, e.g., read memory, write to memory, control an interface, load a program, subroutine, or app, etc. Assembly of components 1072, e.g., an assembly of software components, e.g., routines, subroutines, applications, etc., includes, e.g., code, e.g., machine executable instructions, which when executed by processor 1002, controls the UE 1000 to implement steps of a method, e.g., steps of a method which are performed by UE 302 implementing steps of the method of diagram 300 of FIG. 3, steps of a method which are performed by UE 402 implementing steps of the method of diagram 400 of FIG. 4, steps of a method which are performed by UE 502 implementing steps of the method of diagram 500 of FIG. 5, steps of a method which are performed by UE 602 implementing steps of the method of diagram 600 of FIG. 6, steps of a method which are performed by UE 702 implementing steps of the method of diagram 700 of FIG. 7, steps of a method which are performed by UE 802 implementing steps of the method of diagram 800 of FIG. 8, steps of a method which are performed by UE 902 implementing steps of the method of diagram 900 of FIG. 9, steps of a method which are performed by UE 102 implementing steps of the method of diagram 1600 of FIG. 16 and/or steps of a method which are performed by UE 102 implementing steps of the method of diagram 1700 of FIG. 17.

Data/information 1078 includes UL data buffers 1080, DL data buffers 1082, an UL congestion level threshold 1084, a DL congestion level threshold 1085, generated ECN markings corresponding to UL traffic flows based on congestion in UL data buffers 1086, generated ECN markings corresponding to DL traffic flows based on congestion in DL data buffers 1087, a communications stack 1088, generated signals to be transmitted 1092 and received signals 1092. UL data buffers 1080 includes one or more or all of: L4S UL traffic data buffer(s) 10801, non-L4S UL traffic data buffer(s) 10802, and joint L4S/non-L4S UL traffic data buffers 10803. DL data buffers 1082 includes one or more or all of: L4S DL traffic data buffer(s) 10821, non-L4S DL traffic data buffer(s) 10822, and joint L4S/non-L4S DL traffic data buffers 10823.

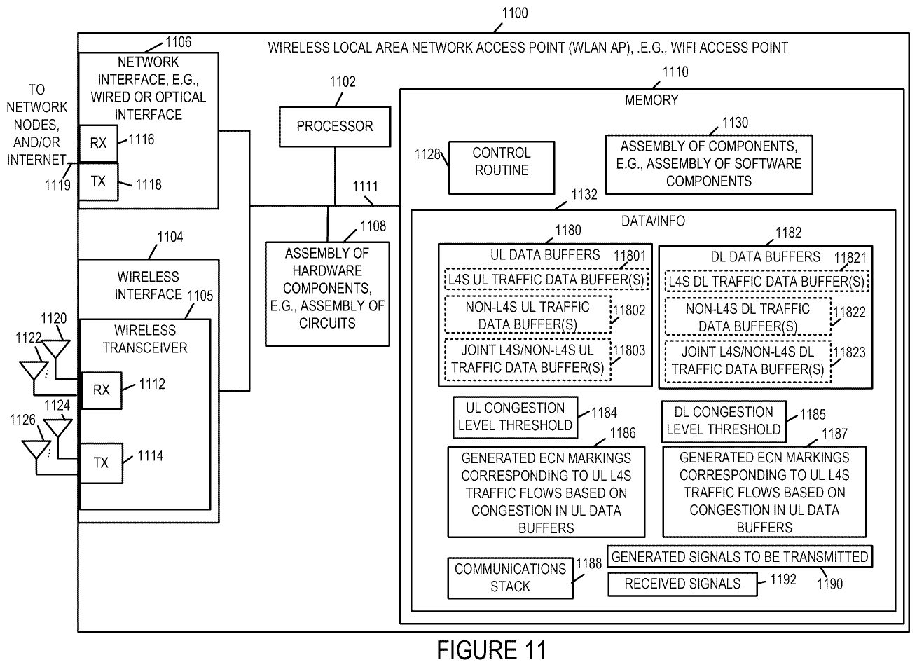

FIG. 11 is a drawing of an exemplary wireless local area network access point (WLAN AP) 1100, e.g., a WiFi AP, implemented in accordance with an exemplary embodiment. WLAN AP 1100 is, e.g., any of the WLANs shown in FIGS. 1-5. WLAN AP 1100 includes a processor 1102, e.g., a CPU, a wireless interface 1104, a network interface 1106, e.g., a wired or optical interface, an assembly of hardware components 1108, e.g., an assembly of circuits, and memory 1110 coupled together via a bus 1111 over which the various elements may interchange data and information. Network interface 1106, e.g., a wired or optical interface includes a receiver 1116, a transmitter 1118 and a connector 1119. Network interface 1106 couples the WLAN AP 1100 to network nodes, e.g., a non-3GPP Interworking Function (N3IWF), which couples the WLAN AP to a core network, e.g., a 5G core (5GC). Wireless interface 1104 includes a wireless receiver 1112 coupled to one or more receive antennas or antenna elements (1120, . . . , 1122) via which the WLAN AP 1100 receives uplink wireless signals from UEs. Wireless interface 1104 further includes a wireless transmitter 1114 coupled to one or more transmit antennas or antenna elements (1124, . . . , 1126) via which the WLAN AP 1100 transmits downlink signals to UEs. In some embodiments, the same antennas are used for transmit and receive. In some embodiments, the wireless receiver 1112 and the wireless transmitter 1114 are included as part of a wireless transceiver 1105.

Memory 1110 includes a control routine 1128, an assembly of components 1130, e.g., an assembly software components, and data/information 1132. Control routine 1128 includes instructions which when executed by processor 1102 control the WLAN AP 1100 to implement basic operational functions, e.g., read memory, write to memory, control an interface, load a program, subroutine, or app, etc. Assembly of components 1130, e.g., an assembly of software components, e.g., routines, subroutines, applications, etc., includes, e.g., code, e.g., machine executable instructions, which when executed by processor 1102, controls the WLAN AP 1100 to implement steps of a method, e.g., steps of a method which are performed by WLAN AP 304 implementing steps of the method of diagram 300 of FIG. 3, steps of a method which are performed by WLAN AP 404 implementing steps of the method of diagram 400 of FIG. 4, steps of a method which are performed by WLAN AP 504 implementing steps of the method of diagram 500 of FIG. 5, steps of a method which are performed by WLAN AP 114 implementing steps of the method of diagram 1600 of FIG. 16 and/or steps of a method which are performed by WLAN AP 114 implementing steps of the method of diagram 1700 of FIG. 17.

Data/information 1132 includes UL data buffers 1180, DL data buffers 1182, an UL congestion level threshold 1184, a DL congestion level threshold 1185, generated ECN markings corresponding to UL traffic flows based on congestion in UL data buffers 1186, generated ECN markings corresponding to DL traffic flows based on congestion in DL data buffers 1187, a communications stack 1188, generated signals to be transmitted 1190 and received signals 1192. UL data buffers 1180 includes one or more or all of: L4S UL traffic data buffer(s) 11801, non-L4S UL traffic data buffer(s) 11802, and joint L4S/non-L4S UL traffic data buffers 11803. DL data buffers 1182 includes one or more or all of: L4S DL traffic data buffer(s) 11821, non-L4S DL traffic data buffer(s) 11822, and joint L4S/non-L4S DL traffic data buffers 11823.

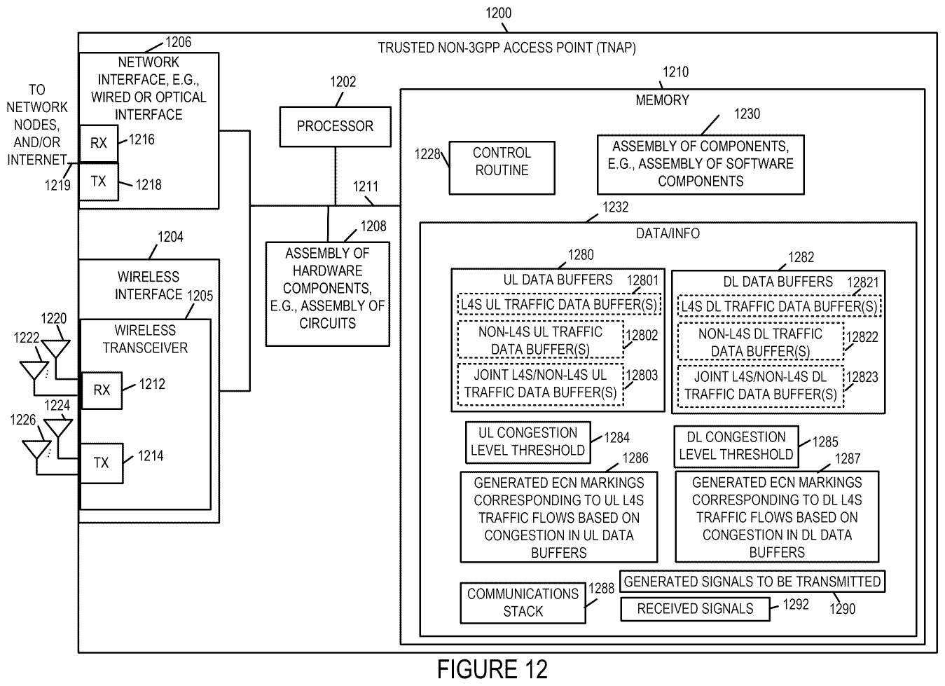

FIG. 12 is a drawing of an exemplary trusted non-3GPP access point (TNAP) 1200 implemented in accordance with an exemplary embodiment. TNAP 1200 is, e.g., any of the TNAPs shown in FIGS. 1-2, and 6-9. TNAP 1200 includes a processor 1202, e.g., a CPU, a wireless interface 1204, a network interface 1206, e.g., a wired or optical interface, an assembly of hardware components 1208, e.g., an assembly of circuits, and memory 1210 coupled together via a bus 1211 over which the various elements may interchange data and information. Network interface 1206, e.g., a wired or optical interface includes a receiver 1216, a transmitter 1218 and a connector 1219. Network interface 1206 couples the TNAP 1200 to network nodes, e.g., a Trusted Non-3GPP Gateway Function (TNGF), which couples the TNAP to a core network, e.g., a 5G core (5GC). Wireless interface 1204 includes a wireless receiver 1212 coupled to one or more receive antennas or antenna elements (1220, . . . , 1222) via which the TNAP 1200 receives uplink wireless signals from UEs. Wireless interface 1204 further includes a wireless transmitter 1214 coupled to one or more transmit antennas or antenna elements (1224, . . . , 1226) via which the TNAP 1200 transmits downlink signals to UEs. In some embodiments, the same antennas are used for transmit and receive. In some embodiments, the wireless receiver 1212 and the wireless transmitter 1214 are included as part of a wireless transceiver 1205.

Memory 1210 includes a control routine 1228, an assembly of components 1230, e.g., an assembly software components, and data/information 1232. Control routine 1128 includes instructions which when executed by processor 1202 control the TNAP 1200 to implement basic operational functions, e.g., read memory, write to memory, control an interface, load a program, subroutine, or app, etc. Assembly of components 1230, e.g., an assembly of software components, e.g., routines, subroutines, applications, etc., includes, e.g., code, e.g., machine executable instructions, which when executed by processor 1202, controls the TNAP 1200 to implement steps of a method, e.g., steps of a method which are performed by TNAP 604 implementing steps of the method of diagram 600 of FIG. 6, steps of a method which are performed by TNAP 704 implementing steps of the method of diagram 700 of FIG. 7, steps of a method which are performed by TNAP 804 implementing steps of the method of diagram 800 of FIG. 8, steps of a method which are performed by TNAP 804 implementing steps of the method of diagram 900 of FIG. 9, steps of a method which are performed by TNAP 114 implementing steps of the method of diagram 1600 of FIG. 16 and/or steps of a method which are performed by TNAP 114 implementing steps of the method of diagram 1700 of FIG. 17.

Data/information 1232 includes UL data buffers 1280, DL data buffers 1282, an UL congestion level threshold 1284, a DL congestion level threshold 1285, generated ECN markings corresponding to UL traffic flows based on congestion in UL data buffers 1286, generated ECN markings corresponding to DL traffic flows based on congestion in DL data buffers 1287, a communications stack 1288, generated signals to be transmitted 1290 and received signals 1292. UL data buffers 1280 includes one or more or all of: L4S UL traffic data buffer(s) 12801, non-L4S UL traffic data buffer(s) 12802, and joint L4S/non-L4S UL traffic data buffers 12803. DL data buffers 1282 includes one or more or all of: L4S DL traffic data buffer(s) 12821, non-L4S DL traffic data buffer(s) 12822, and joint L4S/non-L4S DL traffic data buffers 12823.

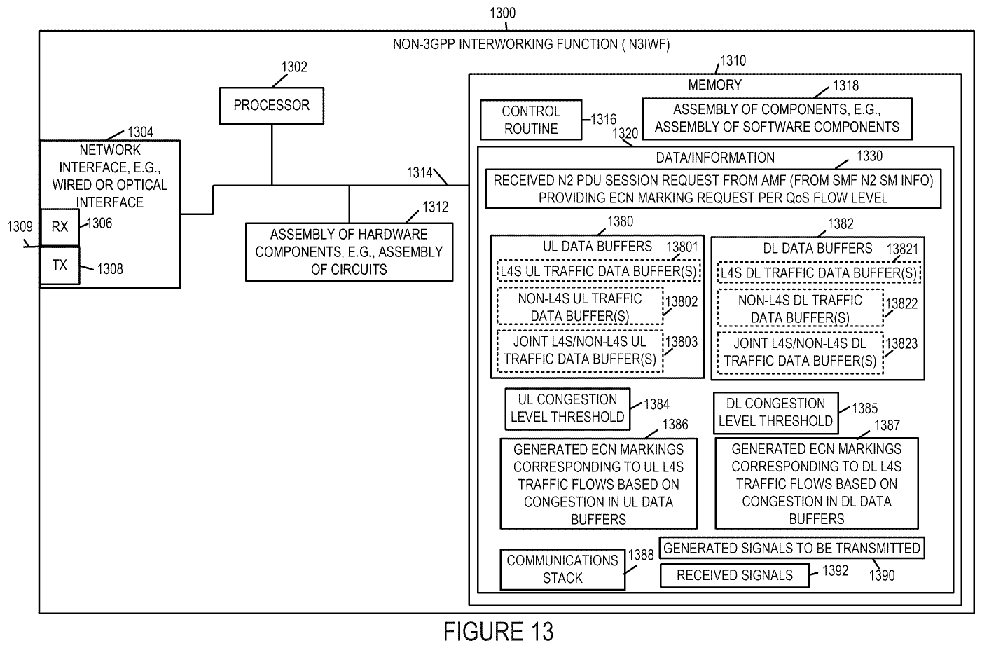

FIG. 13 is a drawing of an exemplary non-3GPP Interworking function (N3IWF) 1300 implemented in accordance with an exemplary embodiment. N3IWF 1300 is, e.g., any of the N3IWFs shown in FIGS. 1-5. N3IWF 1300 includes a processor 1302, e.g., a CPU, a network interface 1304, e.g., a wired or optical interface, an assembly of hardware components 1312, e.g., an assembly of circuits, and memory 1310 coupled together via a bus 1314 over which the various elements may interchange data and information. Network interface 1304 includes a receiver 1306, a transmitter 1308 and a connector 1309. Network interface 1304 couples the N3IWF 1300 to network nodes, e.g., a WLAN AP, and core network nodes, e.g. 5G core (5GC) nodes which implement core network functions, e.g. AMF, SMF, UPF, PCF, etc.

Memory 1310 includes a control routine 1316, an assembly of components 1318, e.g., an assembly software components, and data/information 1320. Control routine 1316 includes instructions which when executed by processor 1302 control the N3IWF 1300 to implement basic operational functions, e.g., read memory, write to memory, control an interface, load a program, subroutine, or app, etc. Assembly of components 1318, e.g., an assembly of software components, e.g., routines, subroutines, applications, etc., includes, e.g., code, e.g., machine executable instructions, which when executed by processor 1302, controls the N3IWF 1300 to implement steps of a method, e.g., steps of a method which are performed by N3IWF 306 implementing steps of the method of diagram 300 of FIG. 3, steps of a method which are performed by N3IWF 406 implementing steps of the method of diagram 400 of FIG. 4, steps of a method which are performed by N3IWF 506 implementing steps of the method of diagram 500 of FIG. 5, steps of a method which are performed by N3IWF 120 implementing steps of the method of diagram 1600 of FIG. 16 and/or steps of a method which are performed by N3IWF 120 implementing steps of the method of diagram 1700 of FIG. 17.

Data/information 1320 includes a received N2 session request 1330 from AMF (from session management function (SMF) N2 session management (SM) information) providing ECN marking request per QoS flow level, UL data buffers 1380, DL data buffers 1382, an UL congestion level threshold 1384, a DL congestion level threshold 1385, generated ECN markings corresponding to UL traffic flows based on congestion in UL data buffers 1386, generated ECN markings corresponding to DL traffic flows based on congestion in DL data buffers 1387, a communications stack 1388, generated signals to be transmitted 1390 and received signals 1392. UL data buffers 1380 includes one or more or all of: L4S UL traffic data buffer(s) 13801, non-L4S UL traffic data buffer(s) 13802, and joint L4S/non-L4S UL traffic data buffers 13803. DL data buffers 1382 includes one or more or all of: L4S DL traffic data buffer(s) 13821, non-L4S DL traffic data buffer(s) 13822, and joint L4S/non-L4S DL traffic data buffers 13823.

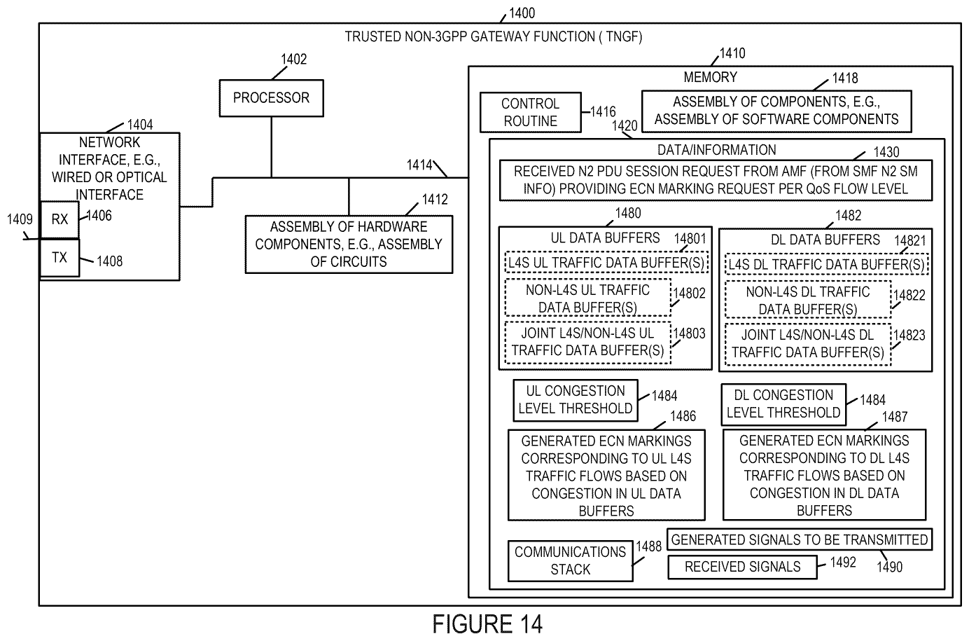

FIG. 14 is a drawing of an exemplary trusted non-3GPP gateway function (TNGF) 1400 implemented in accordance with an exemplary embodiment. TNGF 1400 is, e.g., any of the TNGFs shown in FIGS. 1-2 and 6-9. TNGF 1400 includes a processor 1402, e.g., a CPU, a network interface 1404, e.g., a wired or optical interface, an assembly of hardware components 1412, e.g., an assembly of circuits, and memory 1410 coupled together via a bus 1414 over which the various elements may interchange data and information. Network interface 1404 includes a receiver 1406, a transmitter 1408 and a connector 1409. Network interface 1404 couples the TNGF 1400 to network nodes, e.g., a TNAP, and core network nodes, e.g. 5G core (5GC) nodes which implement core network functions, e.g. AMF, SMF, UPF, PCF, etc.

Memory 1410 includes a control routine 1416, an assembly of components 1418, e.g., an assembly software components, and data/information 1420. Control routine 1416 includes instructions which when executed by processor 1402 control the TNGF 1400 to implement basic operational functions, e.g., read memory, write to memory, control an interface, load a program, subroutine, or app, etc. Assembly of components 1418, e.g., an assembly of software components, e.g., routines, subroutines, applications, etc., includes, e.g., code, e.g., machine executable instructions, which when executed by processor 1402, controls the TNGF 1400 to implement steps of a method, e.g., steps of a method which are performed by TNGF 606 implementing steps of the method of diagram 600 of FIG. 6, steps of a method which are performed by TNGF 706 implementing steps of the method of diagram 700 of FIG. 7, steps of a method which are performed by TNGF 806 implementing steps of the method of diagram 800 of FIG. 8, steps of a method which are performed by TNGF 906 implementing steps of the method of diagram 900 of FIG. 9, steps of a method which are performed by TNGF 120 implementing steps of the method of diagram 1600 of FIG. 16 and/or steps of a method which are performed by TNGF 120 implementing steps of the method of diagram 1700 of FIG. 17.

Data/information 1420 includes a received N2 session request 1430 from AMF (from session management function (SMF) N2 session management (SM) information) providing ECN marking request per QoS flow level, UL data buffers 1480, DL data buffers 1482, an UL congestion level threshold 1484, a DL congestion level threshold 1485, generated ECN markings corresponding to UL traffic flows based on congestion in UL data buffers 1486, generated ECN markings corresponding to DL traffic flows based on congestion in DL data buffers 1487, a communications stack 1488, generated signals to be transmitted 1490 and received signals 1492. UL data buffers 1480 includes one or more or all of: L4S UL traffic data buffer(s) 14801, non-L4S UL traffic data buffer(s) 14802, and joint L4S/non-L4S UL traffic data buffers 14803. DL data buffers 1482 includes one or more or all of: L4S DL traffic data buffer(s) 14821, non-L4S DL traffic data buffer(s) 14822, and joint L4S/non-L4S DL traffic data buffers 14823.

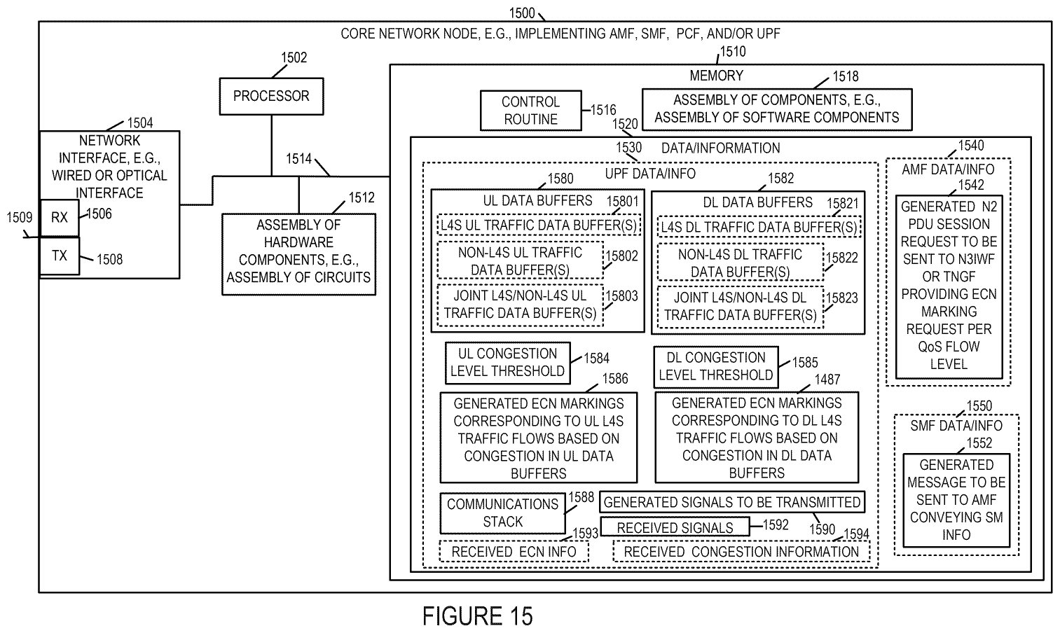

FIG. 15 is a drawing of an exemplary core network node 1500, e.g., a core network device implementing one or more or all of: a UPF, an AMF, a SMF, a PCF, other core network function(s), implemented in accordance with an exemplary embodiment. Exemplary core network node 1500 is, e.g., any of the core network nodes implementing one or more core network functions, e.g. UPF, AMF, SMF, shown in FIGS. 1-9 and/or FIGS. 16-17. Core network node 1500 is, e.g., AMF 124, SMF 128, or UPF 126 of system 100 of FIG. 1, FIG. 2, FIG. 16 and FIG. 17 or PCF 129 of FIG. 2.

Core network node 1500 includes a processor 1502, e.g., a CPU, a network interface 1504, e.g., a wired or optical interface, an assembly of hardware components 1512, e.g., an assembly of circuits, and memory 1510, coupled together via a bus 1514 over which the various elements may interchange data and information.

Network interface 1504, e.g., a wired or optical interface, includes a receiver 1506, a transmitter 1508 and a connector 1509. Memory 1510 includes a control routine 1516, an assembly of components 1518, e.g., an assembly of software components, and data/information 1520. Control routine 1516 includes instructions which when executed by processor 1502 control the core network node 1500 to implement basic operational functions, e.g., read memory, write to memory, control an interface, load a program, subroutine, or app, etc. Assembly of components 1518, e.g., an assembly of software components, e.g., routines, subroutines, applications, etc., includes, e.g., code, e.g., machine executable instructions, which when executed by processor 1402, controls the core network node 1500 to implement steps of a method, e.g., steps of a method which are performed by a core network node implementing steps of the method of any FIGS. 3, 4, 5, 6, 7, 8, 9, 16, and/or 17.

Data information 1520 includes UPF data/information, for an embodiment, in which core network node 1500 implements a UPF, UPF data/information 1530. UPF data/information 1530 includes DL data buffers 1582, an UL congestion level threshold 1584, a DL congestion level threshold 1585, generated ECN markings corresponding to UL traffic flows based on congestion in UL data buffers 1586, generated ECN markings corresponding to DL traffic flows based on congestion in DL data buffers 1587, a communications stack 1588, generated signals to be transmitted 1590 and received signals 1592. UL data buffers 1580 includes one or more or all of: L4S UL traffic data buffer(s) 15801, non-L4S UL traffic data buffer(s) 15802, and joint L4S/non-L4S UL traffic data buffers 15803. DL data buffers 1582 includes one or more or all of: L4S DL traffic data buffer(s) 15821, non-L4S DL traffic data buffer(s) 15822, and joint L4S/non-L4S DL traffic data buffers 15823. In some embodiments, UPF data/information 1530 includes received ECN marking information 1593 indicative of congestion detected at another device, e.g., a UE, a non-3GPP AP (WLAN AP or TNAP) or core network interface device (N3iWF or TNGF). In some embodiments, in which the core network node 1500 implements a PSA UPF, UPF data/information 1530 further includes received congestion information 1594, e.g., received L4S percentage (%) utilization information indicating a percentage of buffers at a device, which is experiencing congestion, being utilized for L4S traffic.

Data information 1520 includes AMF data/information 1540, for an embodiment, in which core network node 1500 implements an AMF. AMF data/information 1540 includes a generated N2 PDU session request 1542 to be sent to a N3IWF or TNGF providing ECN marking request per QoS flow level. Data information 1520 includes SMF data/information 1550, for an embodiment, in which core network node 1500 implements a SMF. SMF data/information 1550 includes a generated message 1552 to be sent to an AMF, said generated message include session management (SM) information to be used by the AMF in generating a N2 PDU session request.

Various Features and Aspects of the invention may be grouped as follows with respect to the devices and/or operations to which they relate:

N3IWF deployment—congestion detected at WLAN AP
1. UL
   a. option 1 (FIG. 3) N3IWF performs marking: steps 381, 382, 383
   b. option 2 (FIG. 3) UPF performs marking: steps 381, 382, 384b, 385 (including 385a, and 385b) and & 381, 382, 384a, 386 (including 386a and 386b)
      i. Note that if UPF is doing marking, it must also provide config info.
2. DL
   a. option 1 (FIG. 4) UE performs marking: steps 481, 482 (including 482a and 482b)
   b. option 2 (FIG. 4) N3IWF performs marking: steps 481, 483, 484
   c. option 3 (FIG. 4) UPF performs marking: steps 481, 483, 485b, 486 (including 486a and 486b) & 481, 483, 485a, 487 (including 487a and 487b)
      i. Note that if UPF is doing marking, it must also provide config info.

N3IWF deployment—congestion detected at N3IWF.
1. UL
   a. option 1 (FIG. 3) N3IWF performs marking: step 390
2. DL
   a. option 1 (FIG. 5) N3IWF performs marking: step 581
   b. option 2 (FIG. 5) UPF performs marking: steps 581, 582 (including 582a and 582b), 583 (including 583a and 583b)
      i. Note that if UPF is doing marking, it must also provide config info.

TNGF deployment—congestion detected at TNAP.
1. UL
   a. option 1 (FIG. 6) TNGF performs marking: steps 681, 682, 683
   b. option 2 (FIG. 6) UPF performs marking: steps 681, 682, 684b, 685 (including 685a and 685b) & 681, 682, 684a, 686 (including 686a and 686b)
      i. Note that if UPF is doing marking, it must also provide config info.
2. DL
   c. option 1 (FIG. 7) UE performs marking: steps 781, 782 (including 782a and 782b)
   d. option 2 (FIG. 7) TNGF performs marking: steps 781, 783, 784
   e. option 3 (FIG. 7) UPF performs marking: steps 781, 783, 785b, 786 e. (including 786a and 786b) & 781, 783, 785a, 787 (including 787a and 787b)
      i. Note that if UPF is doing marking, it must also provide config info.

TNGF deployment—congestion detected at TNGF.
1. UL
   a. Option 1 (FIG. 6) TNGF performs marking: step 690
2. DL
   b. option 1 (FIG. 8) TNGF performs marking: steps 881
   c. option 2 (FIG. 8) UPF performs marking: steps 882 (including 882a and 882b), 883 (including 883a and 883b)
      i. Note that if UPF is doing marking, it must also provide config info.

TNGF deployment—congestion detected at UE.
1. UL
   a. option 1 (FIG. 9) UE performs marking: 981
   b. option 2 (FIG. 9) UPF performs marking: 982 (including 982a and 982b), 983 (including 983a and 983b), 984, 985 (including 985a and 985b)
   c. Note that if UPF is doing marking, it must also provide config info.

Please note that this also applies to a N3IWF deployment.

FIG. 16, comprising the combination of FIG. 16A, FIG. 16B, and FIG. 16C, is a drawing 1600, comprising Part A 1601, Part B 1603 and Part C 1606, which illustrates PDU session establishment via untrusted or trusted non-3GPP access for an L4S traffic flow and UE application UL traffic congestion detection at AP (WLAN AP or TNAP) and/or network interfacing device (N3IWF or TNGF) and ECN marking for an exemplary communications system, e.g., system 100 of FIG. 1, in accordance with an exemplary embodiment. Exemplary system 100 includes UE 102, non-3GPP access point (WLAN AP or TNAP) 114, core network interface device (N3IWF or TNGF) 120, a 5GC 122 including AMF 124 and other control plane (CP) and user plane (UP) functions 125, which includes UPF 126, SMF 129, and PCF 129), and DN 132. Block 1602 of FIG. 16A illustrates a modified TS23.502 FIG. 4.12.5-1 PDU session establishment via untrusted or trusted non-3GPP access, in accordance with an exemplary embodiment. In block 1604, step 1 and 2a of TS23.502 clause 4.12.5-1 are performed, which includes, in the case of non-3GPP access, where the 5G-AN corresponds to a N3IWF or TNFG, for each QoS flow, the SMF, e.g., SMF 128, may request ECN marking for L4S at N3IWF or TNGF as described in TS.23.501 clause 5.37.3. In step 1606, AMF 124 generates and sends a (step 2b) N2 PDU session request 1608 to the core network interfacing device (N3IWF or TNGF) 120. The AMF 124, from SMF's N2 Session Management (SM) information, if applicable, provides an ECN marking request per QoS flow level to the core network interfacing device (N3IWF or TNGF) 120, as part of PDU session management procedures. In block 1612, steps 3 through 7 of TS23.502 clause 4.12.5-1 are performed, which includes, in the case of non-3GPP access, where the 5G-AN corresponds to a N3IWF or TNGF, N2 PDU session response including establish QoS flows (active/not active) (for ECN marking for L4S at N3IWF or TGNF). Bidirectional arrow 1614 illustrates step 8 of TS23.502 clause 4.12.5-1 in which PDUs belonging to L4S-enabled QoS flow(s) may be transferred over dedicated IPsec Child Security Association(s) (SA(s)).

Block 1616 of FIG. 16B illustrates exemplary UE application UL traffic and congestion detected at an AP (WLAN AP or TNAP) 114 and/or at a core network interfacing device (N3IWF or TNGF) 120, and exemplary operations performed in response to the detected congestion. In step 1618 UE 102 sets a UE application request for L4S handling via setting ECN field to ECT(1) in IP header for UL traffic. Block 1620 indicates that UL traffic from UE to AP (WLAN AP or TNAP) to core network interfacing device (N3IWF or TNGF) to application includes ECN field set to ECT(1) in inner most IP header, so end-to-end (E2E) application is aware L4S handling is enabled. Note, each IP header within the encapsulation copies the ECN field from the inner most IP header.

Set of steps 1622, 1624, and 1626, indicated in dotted boxes, corresponds to a scenario in which AP 114 monitors to detect congestion and performs ECN marking. Set of steps 1628 and 1630, indicated in dot/dash boxes, corresponds to a scenario in which core network interfacing device (N3IWF or TNGF) 114 monitors to detect congestion and performs ECN marking. It should be appreciated that if both the AP 114 and core networking interfacing device (N3IWF or TNGF) 120 are enabled to monitor for congestion and perform ECN marking, then both sets of steps may be, and sometimes are performed, e.g., when congestion is detected at both the core network interfacing device 120 and the AP 114.

In step 1622 the access point (WLAN or TNAP) 114 detects congestion at the AP, e.g., the AP 114 detects congestion, with regard to the status of its uplink traffic buffers used for L4S uplink traffic. In response to the uplink congestion detection of step 1622, in step 1624, the core network interfacing device (N3IWF or TNGF) 120 sets the outer most IP header ECN field to CE (e.g., a bit pattern of 11). In step 1626, the core network interfacing device (N3IWF or TNGF) 120 copies the ECN field to the inner most IP header so the receiving application is aware that congestion was experienced.

In step 1628 the core network interfacing device (N3IWF or TNGF) 120 detects congestion at the core network interfacing device, e.g., the core network interfacing device 120 detects congestion, with regard to the status of its uplink traffic buffers used for L4S uplink traffic. In response to the uplink congestion detection of step 1628, in step 1630, the core network interfacing device (N3IWF or TNGF) 120 sets the ECN field in the inner most IP header to CE (e.g., a bit pattern of 11) so the receiving application is aware that congestion was experienced.

FIG. 16C illustrates uplink application data, headers, encapsulation, and ECN field setting(s) for an example of an uplink L4S traffic flow in which uplink congestion is detected at a non-3GPP AP 114 and/or at a core network interfacing device 120, as a L4S uplink data packet, corresponding to an application is communicated from UE 102 toward a DN 132 including a destination end node. Drawing 1632 illustrates data, header fields and data encapsulation corresponding to UE 102 for an example in which UE application data 10 is communicated from UE 102 toward DN 130. Drawing 1632 illustrates UE application (app) data 10, IP header (Inner) 11 including an ECN field 16, GRE header 12, Inner IP header 13 including an ECN field 17, IPsec header 14 and IP header (Outer) 15 including and ECN field 18. UE innermost IP w/application data 19 includes UE application data 10 and IP header (Inner) 11. UE GRE w/IP data encapsulation 20 includes UE innermost IP w/application data 19 and GRE header 12. UE Inner IP w/GRE data encapsulation 21 includes UE GRE w/IP data encapsulation 20 and Inner IP header 13. UE IPsec w/Inner IP data encapsulation 22 includes UE Inner IP w/GRE data encapsulation 21 and IPsec header 14. UE Outer IP w/IPsec data encapsulation 23 includes UE IPsec w/Inner IP data encapsulation 22 and IP header (Outer) 24. Drawing 1632 further illustrates UE 102 setting (see step 1618 of FIG. 16B) the ECN field 17 of the innermost IP header 11 to ECT(1), e.g., indicating L4S traffic flow, as indicated in information block 1633.

Drawing 1634 illustrates data, header fields and data encapsulation corresponding to AP 114 for an example in which UE application data 10 is communicated from UE 102 toward DN 130. Drawing 1634 illustrates information 35, which includes AP (WLAN AP or TNAP) encapsulation of UE IPsec payload 34 and IP header (Outer) 30 including ECN field 33. AP (WLAN AP or TNAP) encapsulation of UE IPsec payload 34 includes UE application (app) data 25, IP header (Inner) 26 including an ECN field 31, GRE header 27, Inner IP header 28 including an ECN field 32, and IPsec header 29. Drawing 1634 further illustrates AP 114 setting (see step 1624 of FIG. 16B) the ECN field 33 of the outer IP header 30 to CE (e.g., bit pattern=11) due to congestion detected (see step 1622 of FIG. 16B) at the AP 114, as indicated by information block 1635.

Drawing 1636 illustrates information corresponding to core network interfacing device (N3IWF or TNGF) 120 for an example in which UE application data 10 is communicated from UE 102 toward DN 130. Drawing 1636 illustrates N3IWF or TNGF received UE IPsec payload 45 and IP header (Outer) 41 including ECN field 44. The N3IWF or TNGF received UE IPsec payload 45 includes UE application (app) data 36, IP header (Inner) 37 including an ECN field 42, GRE header 38, Inner IP header 39 including an ECN field 43, and IPsec header 40.

Drawing 1636 further illustrates the outer IP header ECN field 44 is set to CE due to congestion detected (see step 1622 of FIG. 16B) prior to the N3IWF or TNGF, as indicated in information block 1637.

Drawing 1636 further illustrates that the core network interfacing device 120 copies this ECN field 44 of the outer IP header 41 to the ECN field 42 of inner most IP header 37 (see step 1626 of FIG. 16B).

Drawing 1638 illustrates information corresponding to core network interfacing device (N3IWF or TNGF) 120 for an example in which UE application data 10 is communicated from UE 102 toward DN 130. Drawing 1638 illustrates N3IWF or TNGF encapsulation of UE payload 53 and IP header (Outer) 50 including ECN field 52. The N3IWF or TNGF encapsulation of UE payload 53 includes application data 46, IP header (Inner) 47 including ECN field 51, GTPU header 48, and UDP header 49.

Drawing 1638 further illustrates the core network interfacing device (N3IWF or TNGF) 120 sets (see step 1630 of FIG. 16C) the inner most IP header 51 to CE (in the N3IWF or TNGF encapsulation of UE payload 53) due to congestion detected (see step 1628 of FIG. 16B) at the core network interfacing device (N3IWF or TNGF) 120 or due to a received IP header marking (see step 1626), indicating CE, as indicated in information block 1639. Thus, ECN field 51 of innermost IP header 47 is set to CE if congestion is detected at either: i) the AP 114 or ii) the core network interfacing device (N3IWF or TNGF) 120 for an scenario in which both the AP 114 and the core network interfacing device 120 are enabled to perform ECN markings for the L4S traffic flow.

FIG. 17, comprising the combination of FIG. 17A, FIG. 17B, and FIG. 17C, is a drawing 1700, comprising Part A 1701, Part B 1703 and Part C 1706, which illustrates PDU session establishment via untrusted or trusted non-3GPP access for an LAS traffic flow and UE application DL traffic congestion detection at AP (WLAN AP or TNAP) and/or network interfacing device (N3IWF or TNGF) and ECN marking for an exemplary communications system, e.g., system 100 of FIG. 1, in accordance with an exemplary embodiment. Exemplary system 100 includes UE 102, non-3GPP access point (WLAN AP or TNAP) 114, core network interface device (N3IWF or TNGF) 120, a 5GC 122 including AMF 124 and other control plane (CP) and user plane (UP) functions 125, which includes UPF 126, SMF 129, and PCF 129), and DN 132.

Block 1702 of FIG. 17A illustrates a modified TS23.502 FIG. 4.12.5-1 PDU session establishment via untrusted or trusted non-3GPP access, in accordance with an exemplary embodiment. In block 1704, step 1 and 2a of TS23.502 clause 4.12.5-1 are performed, which includes, in the case of non-3GPP access, where the 5G-AN corresponds to a N3IWF or TNFG, for each QoS flow, the SMF, e.g., SMF 128, may request ECN marking for L4S at N3IWF or TNGF as described in TS.23.501 clause 5.37.3. In step 1706, AMF 124 generates and sends a (step 2b) N2 PDU session request 1708 to the core network interfacing device (N3IWF or TNGF) 120. The AMF 124, from SMF's N2 Session Management (SM) information, if applicable, provides an ECN marking request per QoS flow level to the core network interfacing device (N3IWF or TNGF) 120, as part of PDU session management procedures. In block 1712, steps 3 through 7 of TS23.502 clause 4.12.5-1 are performed, which includes, in the case of non-3GPP access, where the 5G-AN corresponds to a N3IWF or TNGF, N2 PDU session response including establish QoS flows (active/not active) (for ECN marking for L4S at N3IWF or TGNF). Bidirectional arrow 1714 illustrates step 8 of TS23.502 clause 4.12.5-1 in which PDUs belonging to L4S-enabled QoS flow(s) may be transferred over dedicated IPsec Child Security Association(s) (SA(s)).

Block 1716 of FIG. 17B illustrates exemplary DL application DL traffic and congestion detected at an AP (WLAN AP or TNAP) 114 and/or at a core network interfacing device (N3IWF or TNGF) 120, and exemplary operations performed in response to the detected congestion. In step 1718 an application in an end device in data network 132 sets an application request for L4S handling via setting ECN field to ECT(1) in IP header for DL traffic. Block 1720 indicates that DL traffic from DN application to core network interfacing device (N3IWF or TNGF) to UE receiving application includes ECN field set to ECT(1) in inner most IP header, so end-to-end (E2E) application is aware L4S handling is enabled. Note, each IP header within the encapsulation copies the ECN field from the inner most IP header.

Set of steps 1722, 1724, and 1726, indicated in dotted boxes, corresponds to a scenario in which AP 114 monitors to detect congestion and performs ECN marking. Set of steps 1728 and 1730, indicated in dot/dash boxes, corresponds to a scenario in which core network interfacing device (N3IWF or TNGF) 120 monitors to detect congestion and performs ECN marking. It should be appreciated that if both the AP 114 and core networking interfacing device (N3IWF or TNGF) 120 are enabled to monitor for congestion and perform ECN marking, then both sets of steps may be, and sometimes are performed, e.g., when congestion is detected at both the core network interfacing device 120 and the AP 114.

In step 1728 the core network interfacing device (N3IWF or TNGF) 120 detects congestion at the core network interfacing device, e.g., the core network interfacing device 120 detects congestion, with regard to the status of its downlink traffic buffers used for L4S downlink traffic. In response to the downlink congestion detection of step 1728, in step 1730, the core network interfacing device (N3IWF or TNGF) 120 sets the ECN field in the inner most IP header to CE (e.g., a bit pattern of 11) so the receiving application is aware that congestion was experienced.

In step 1722 the access point (WLAN or TNAP) 114 detects congestion at the AP, e.g., the AP 114 detects congestion, with regard to the status of its downlink traffic buffers used for L4S downlink traffic. In response to the downlink congestion detection of step 1722, in step 1724, the AP 114 sets the outer most IP header ECN field to CE (e.g., a bit pattern of 11). In step 1726, the UE 102 copies the ECN field of the outer most IP header, which was received from the AP 114, to the inner most IP header so the receiving application in UE 102 is aware that congestion was experienced.

FIG. 17C illustrates downlink application data, headers, encapsulation, and ECN field setting(s) for an example of a downlink L4S traffic flow in which downlink congestion is detected at a core network interfacing device 120 and/or an AP 114, as a L4S downlink data packet, corresponding to an application is communicated from a source end node of DN 132 to UE 102.

Drawing 1736 illustrates information corresponding to core network interfacing device (N3IWF or TNGF) 120 for an example in which application (originally sourced from a source end node in DN 132) is to be communicated toward UE 102. Drawing 1736 illustrates N3IWF or TNGF encapsulation of DL payload for UE 86 and IP header (Outer) 83 including ECN field 85. The N3IWF or TNGF encapsulation of DL payload for UE 86 includes application (app) data 79, IP header (Inner) 80 including an ECN field 84, GTPU header 81, and UDP header 82. Drawing 1736 further illustrates the application in the source end node in DN 132 has previously set (see step 1718 in FIG. 17B) the ECN field in the inner most IP header to ECT1, indicating L4S traffic, and ECN field 84 in IP header (Inner) 80 is still set to ECT(1) for a scenario in which the congestion was not detected at the core network interfacing device 120 or the core network interfacing device 120 was not enable to perform ECN marking.

Drawing 1738 illustrates information corresponding to core network interfacing device (N3IWF or TNGF) 120 for an example in which application data (originally sourced from a source end node in DN 132) is to be communicated toward UE 102. Drawing 1738 illustrates N3IWF or TNGF transmitted DL UE IPsec payload 96 and IP header (Outer) 92 including ECN field 95. The N3IWF or TNGF transmitted DL UE IPsec payload 96 includes application data 87, IP header (Inner) 88 including ECN field 93, GRE header 89, Inner IP header 90 including ECN field 94 and IPsec header 91. Drawing 1738 further illustrates the core network interfacing device (N3IWF or TNGF) 120 sets (see step 1730 of FIG. 17C) the inner most IP header 93 to CE (in the N3IWF or TNGF transmitted DL UE IPsec payload 96) due to congestion detected (see step 1728 of FIG. 17B) at the core network interfacing device (N3IWF or TNGF) 120, as indicated in information block 1742.

Drawing 1734 illustrates data, header fields and data encapsulation corresponding to AP 114 for an example in which application data (sourced from an end node in DN 132) is communicated toward UE 102. Drawing 1734 illustrates information 78, which includes AP (WLAN AP or TNAP) encapsulation of DL UE IPsec payload 78 and IP header (Outer) 73 including ECN field 76. AP (WLAN AP or TNAP) encapsulation of DL UE IPsec payload 77 includes application (app) data 68, IP header (Inner) 69 including an ECN field 74, GRE header 70, Inner IP header 71 including an ECN field 75, and IPsec header 72. Drawing 1734 further illustrates AP 114 setting (see step 1724 of FIG. 17B) the ECN field 76 of the outer IP header 70 to CE (e.g., bit pattern=11) due to congestion detected (see step 1722 of FIG. 17B) at the AP 114, as indicated by information block 1744.

Drawing 1732 illustrates data, header fields and data encapsulation corresponding to UE 102 for an example in which application data is communicated from a source end node of DN 130 to UE 102. Drawing 1732 illustrates UE DL application (app) data 53, IP header (Inner) 54 including an ECN field 59, GRE header 55, Inner IP header 56 including an ECN field 60, IPsec header 57 and IP header (Outer) 58 including an ECN field 61. UE innermost IP w/application data 62 includes UE DL application data 53 and IP header (Inner) 54. UE GRE w/IP data encapsulation 63 includes UE innermost IP w/application data 62 and GRE header 55. UE Inner IP w/GRE data encapsulation 64 includes UE GRE w/IP data encapsulation 63 and Inner IP header 56. UE IPsec w/Inner IP data encapsulation 65 includes UE Inner IP w/GRE data encapsulation 64 and IPsec header 57. UE Outer IP w/IPsec data encapsulation 66 includes UE IPsec w/Inner IP data encapsulation 65 and IP header (Outer) 61. Drawing 1732 further illustrates that if the outer IP header ECN field 61 is set to CE due to congestion detected (see step 1722 and 1724 of FIG. 17B) by AP (WLAN AP or TNAP), as indicated by information block 1740, then step 1726 is performed in which UE 102 copies the CE indication (e.g., bit pattern=11) of the ECN field 61 of the outer IP header 58 to the ECN field 59 of the innermost IP header field 54, so the receiving application in UE 102 is aware that congestion was experienced.

The dot-dash boxes (1728, 1730) and the dotted boxes (1722, 1724, 1726)_in FIG. 17B illustrate different options of where the congestion was detected and how the inner IP header ECN field is impacted. If congestion is detected at the core network interface device (N3IWF or TNGF) 120, the inner IP header ECN field is modified directly, but if congestion is detected at the AP (WLAN AP or TNGF) 114, then the outer IP header ECN field is modified and the UE 102 would then determine if to copy to the inner IP header ECN field.

For the optional box 1722 “Congestion detected at AP (WLAN or TNAP) 114”
If no congestion at core network interface device (N3IWF or TNGF) 120, the inner IP header would have the ECN field set to ECT(1) because no congestion was detected at core network interface device (N3IWF/TNGF) 120.
If congestion is detected (in step 1722) at AP 114, then the AP (WLAN or TNAP) 114 would set (in step 1724) the outer IP header ECN field to CE (Note that the AP 114 has no visibility to inner IP header).
If the AP 114 set (in step 1724) the outer IP header ECN field to CE, then the UE 102 would copy (in step 1726) the outer IP header ECN field to the inner IP header ECN field, so the receiving application is aware that congestion was detected somewhere in the receive chain.

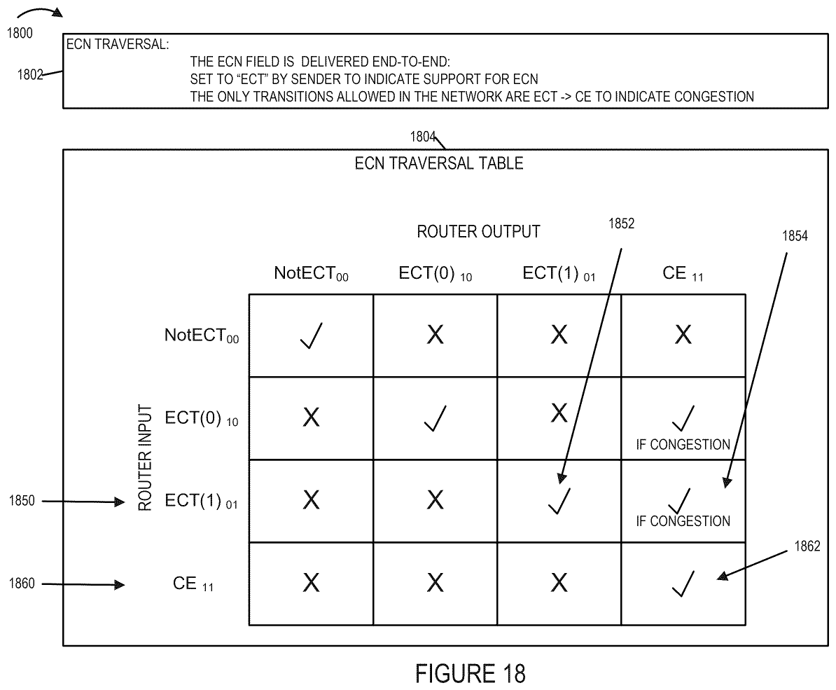

For the optional box 1728 “Congestion detected at core network interface device (N3IWF or TNGF) 120”
If congestion is detected (in step 1728) at core network interface device (N3IWF or TNGF) 120, then the N3IWF/TNGF 120 would set (in step 1730) the inner IP header ECN field to CE.
If congestion was not detected at the AP 114, the outer IP header ECN field is unchanged and remains set to ECT(1).
If congestion was also detected (in step 1722) at the AP 114, the AP 114 would set (in step 1724) the outer IP header ECN field to CE.
The UE 102 would copy (in step 1726) the outer IP header ECN field to the inner IP header ECN field ONLY if the inner IP header ECN field is not set to CE (that is, IETF states that the ECN field can transition from ECT(1) to ECT(1) or ECT(1) to CE, but cannot go from CE to ECT(1). See drawing 1800 of FIG. 18.

Drawing 1800 of FIG. 18 illustrates how ECN traversal is handled throughout a network. Note that the input IP Header ECN field only allows a transition from ECT to CE for proper processing throughout the network. FIG. 18 is a drawing 1800 including information 1802 explaining ECN traversal and an ECN traversal table 1804. ECN traversal information 1802 indicates that the ECN field will be delivered end-to-end. The value of ECN in the ECN field is set to “ECT” by the sender to indicate support for ECN. The only transitions allowed in the network are ECT→CE to indicate congestion. ECN traversal table 1804 plots router input vs router output.

The ECN field is set to ECT, e.g., ECT(1), by the sender, e.g., a UE for uplink direction, or an application server of a data network for downlink direction. If a device along the data communications path, which is enabled for ECN marking, receives an input ECT(1) 1850, then there are two possible outputs. If the device is not congested, then the device outputs ECT(1) 1852; however, if the device is congested then the device outputs CE 1854.

If a device along the data communications path, which is enabled for ECN marking, receives an input CE 1860, then there is only one possible output, which is CE 1862.

In one embodiment, NotECT maps to bit pattern 00, ECT(0) maps to bit pattern 10, ECT(1) maps to bit pattern 01, and CE maps to bit pattern 11.

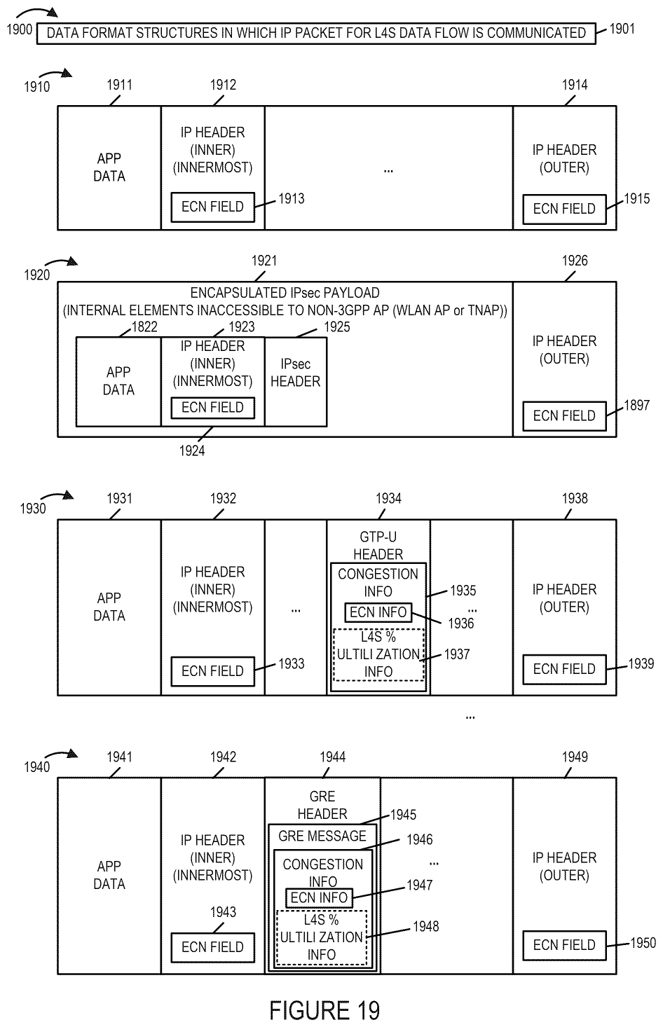

FIG. 19 is a drawing 1900 illustrated exemplary data format structures in which an IP packet for an L4S data flow is communicated in accordance with an exemplary embodiment.

Exemplary data format structure 1910 includes: application (APP) data 1911, an IP header (inner) 1912, sometimes referred to as innermost IP header, and IP header (outer) 1914. IP header (inner) 1912 includes ECN field 1913. IP header (outer) 1914 includes ECN field 1915.

Exemplary data format structure 1920 includes an encapsulated IPsec payload 1920, and an IP header (outer) 1926. The encapsulated IPsec payload 1921 includes internal elements, which are inaccessible to the non-3GPP AP (WLAN AP or TNAP); the internal elements include application (APP) data 1922, IP header (inner) 1923, sometimes referred to as innermost IP header, and an IPsec header 1925. IP header (inner) 1923 includes ECN field 1924. The IP header (outer) 1926 includes ECN field 1927.

Exemplary data format structure 1330 includes: application (APP) data 1931, an IP header (inner) 1932, sometimes referred to as innermost IP header, a GTP-U header 1934, and IP header (outer) 1938. IP header (inner) 1932 includes ECN field 1933. GTP-U header 1934 includes congestion information 1935, which includes ECN information 1936, e.g., an ECN field, and, in some embodiments, L4S percentage (%) utilization information 1937. IP header (outer) 1938 includes ECN field 1939.

Exemplary data format structure 1940 includes: application (APP) data 1941, an IP header (inner) 1942, sometimes referred to as innermost IP header, a GRE header 1944, and IP header (outer) 1949. IP header (inner) 1942 includes ECN field 1943. GRE header 1944 includes a GRE message 1945 which includes congestion information 1946, which includes ECN information 1947, e.g., an ECN field, and, in some embodiments, L4S percentage (%) utilization information 1948. IP header (outer) 1949 includes ECN field 1950.

ECN information, installed in an outer ECN field or a GRE field or a GTP-U field, in response to detected congestion at a particular device along the traffic flow path, e.g., a UE, a non-3GPP AP (WLAN AP or TNAP), or a core network interface device (N3IWF or TNGF), is routed, e.g., in accordance with the implemented embodiment, to an innermost IP header of a device (e.g., a core network interface device (N3IWF or TNGF) or UPF), for ECN marking operations in the ECN field of the innermost header of the device. L4S percentage (%) utilization information, e.g. a determined or estimated percentage utilization of buffers used for L4S traffic at a particular device, is routed toward a PSA UPF to be used by the PSA UPF, e.g., in resource allocation decisions.

Various proposed solutions, in accordance with the present invention have, or follow, one or more of the following principles or features:
Dedicated User Plane (UP) resources are used for carrying L4S-enabled Internet Protocol (IP) traffic.
N3IWF and/or TNGF maps the L4S-enabled QoS flows to UP resources.
N3IWF and/or TNGF relays ECN marking up the stack to the Inner most IP headers so end-to-end applications are aware of the ECN marking.
Option for the user equipment (UE) to perform ECN marking when uplink (UL) congestion is experienced at the UE. Protocol stack diagrams see (FIGS. 3-9) indicated how L4S is supported within the UE, N3IWF, and TNGF via ECN marking in the IP header as well as providing congestion information to the user plane function (UPF) for Quality of Service (QOS) monitoring.

Various embodiments, in accordance with the present invention support L4S congestion marking in non-3GPP access.

References which are hereby expressly incorporated by reference in their entirety include the references listed below which, through reference and express incorporation in this text, constitute provisions of the present document.
1) 3GPP TR 21.905: “Vocabulary for 3GPP Specifications” v17.1.0 (12-2021)
2) 3GPP TS 23.501: “System Architecture for the 5G System (5GS); Stage 2” v18.4.0 (12-2023)
3) 3GPP TS 23.502: “Procedures for the 5G System; Stage 2” v18.4.0 (12-2023)
4) 3GPP TS 23.503: “Policies and Charging control framework for the 5G System; Stage 2” v18.4.0 (12-2023)
5) IETF RFC 3711: “The Secure Real-time Transport Protocol (SRTP)”, March 2004.
6) IETF RFC 6904: “Encryption of Header Extensions in the Secure Real-time Transport Protocol (SRTP)”, April 2013
7) IETF RFC 9335: “Completely Encrypting RTP Header Extensions and Contributing Sources”, January 2023
8) IETF draft-ietf-avtcore-rtp-over-quic: “RTP over QUIC (RoQ)”, Oct. 23, 2023.
9) IETF draft-ietf-moq-transport: “Media over QUIC Transport”, Oct. 23, 2023
10) IETF experimental draft-ietf-avtext-framemarking: “Video Frame Marking RTP Header Extension”, Jul. 26, 2023.
11) IETF RFC 9000: “QUIC: A UDP-Based Multiplexed and Secure Transport”, May 2021.
12) IETF RFC 9330: “Low Latency, Low Loss, and Scalable Throughput (L4S) Internet Service: Architecture, January 2023
13) IETF RFC 9331: “The Explicit Congestion Notification (ECN) Protocol for Low Latency, Low Loss, and Scalable Throughput (L4S)”, January 2023.
14) IETF draft-ietf-tsvwg-ecn-encap-guidelines-22: “Guidelines for Adding Congestion Notification to Protocols that Encapsulate IP”, Dec. 5, 2023.

Untrusted and trusted non-3GPP accesses are able to connect 3GPP UEs to the 5G core (5GC) via a N3IWF (in the case of un-trusted access) or a TNGF (in the case of trusted access) which interfaces directly to the 5GC's control plane (CP) and user plane (UP) functions via N2 and N3 reference points, respectively. The N3IWF and TNGF support similar functionality and reference points as an NG-RAN towards the 5GC, specifically communicating to 5GC CP and UP functions over N2 and N3 interfaces.

Various lists of exemplary numbered embodiments follow. In each list, references to a preceding numbered embodiment refers to a preceding numbered embodiment in the same list.

### First Numbered List of Exemplary Method Embodiments

Method Embodiment 1. A method of supporting L4S in non-3GPP accesses, the method comprising: operating a non-3GPP access point (AP) (e.g., a WLAN AP (304) or a TNAP (604)) to monitor (3790 or 6790) for congestion on the uplink; detecting (379 or 679) at the non-3GPP AP uplink congestion; operating the non-3GPP AP to indicate (381 or 681) via bits of an outer IP header ECN field of a packet being communicated that congestion was experienced (assuming that the ECN field was set to ECT(1); and operating a core network interface device (e.g., a N3IWF (306) or a TNGF (606)) to detect (382 or 682) that the bits of the outer IP header ECN field of the packet being communicated are set indicating congestion.

Method Embodiment 1AA. The method of Method Embodiment 1, wherein operating a non-3GPP access point (AP) (e.g., a WLAN AP (304) or a TNAP (604)) to monitor (3790 or 6790) for congestion on the uplink includes monitoring an uplink data buffer (3041 or 6041) in the non-3GPP AP (304 or 604) used for storing received L4S traffic.

Method Embodiment 1AB. The method of Method Embodiment 1AA, wherein detecting (379 or 679) at the non-3GPP AP uplink congestion includes detecting an amount of traffic in the uplink data buffer (3041 or 6041) in the non-3GPP AP (304 or 604) used for storing L4S traffic that exceeds a congestion level threshold.

Method Embodiment 1A. The method of Method Embodiment 1, wherein said packet being communicated is an IP packet directed to a data network (310 or 610) to which is the packet being communicated, said packet being communicated originating at a UE (302 or 602) which sends the packet to be communicated to the data network via the non-3GPP access point (AP).

Method Embodiment 1B. The method of Method Embodiment 1A, wherein said packet being communicated, includes an inner IP header (which may and sometimes does include an ECN field or to which an ECN field can be added, e.g., by inserting or including ECN information in the inner packet header, as the packet is communicated to the destination node).

Method Embodiment 1C. The method of Method Embodiment 1, wherein the non-3GPP AP indicates (381 or 681) via an IP header ECN field of the packet being communicated that congestion was experienced includes setting bits of the outer IP header ECN field of the packet being communicated to a value (e.g., (1, 1) indicating that congestion has been experienced.

Method Embodiment 1D. The method of Method Embodiment 1, wherein the outer IP header ECN field of the packet being communicated includes two bits and wherein setting both of the bits to the value of 1 indicates that congestion has been encountered.

Method Embodiment 2. The method of Method Embodiment 1, further comprising: operating the core network interface device (e.g., a N3IWF (306) or a TNGF (606)) to relay (e.g. copy the bits communicating the congestion information) (383 or 683) congestion information from the outer IP header ECN field of the packet being communicated to an inner-most IP header of the packet being communicated.

Method Embodiment 2A. The method of Method Embodiment 2, further comprising: operating the core network interface device (e.g., a N3IWF (306) or a TNGF (606)) to send ((3831 or 6831) the IP packet to be communicated, with the inner-most IP header including ECN bits (3601 or 6601) communicating congestion information, to a UPF (308); and operating the UPF (308 or 608) to send (3832 or 6832) the IP packet to be communicated with the congestion information (e.g., indicated in the inner-most IP header bits 3701 or 6701) to a data network (310 or 610) (e.g., to an application (375 or 675) of the data network (310 or 610) to which the IP packet being communicated is sent).

Method Embodiment 2B. The method of Method Embodiment 2A, wherein operating the UPF (308 or 608) to send the IP packet to be communicated with the congestion information includes sending the IP packet with the innermost IP header ECN bits (3701 or 6701) communicating congestion information without additional congestion indication information (e.g., without an additional outer IP header including ECN bits).

Method Embodiment 3. The method of Method Embodiment 1, further comprising: operating the core network interface device (e.g., a N3IWF (306) or a TNGF (606) to relay (e.g., via outer IP header via step 384a or via GTP-U header via steps 384b and 385a) congestion information (e.g., the value of the ECN bits) included in the outer IP header of the packet being communicated to a UPF (308 or 608) (e.g. GTP-U layer level communication without the need to communicated ECN information using an inner header of the IP packet being communicated or via outer IP layer level communication).

Method Embodiment 4. The method of Method Embodiment 3, wherein operating the core network interface device (e.g., a N3IWF (306) or a TNGF (606)) to relay congestion information includes: operating the core network interface device (e.g., a N3IWF (306) or a TNGF (606)) to provide (e.g., generate and/or associate) (384b or 684b) a GTP-U header (e.g., corresponding to the packet being communicated) with congestion information (e.g., with the value of the ECN bits that were in the outer IP header of the packet being communicated).

Method Embodiment 4A. The method of Method Embodiment 4, wherein operating the core network interface device (e.g., a N3IWF (306) or a TNGF (606) to relay congestion information includes: operating the core network interface device (e.g., a N3IWF (306) or a TNGF (606) to communicate (385a) the GTP-U header with the congestion information to a UPF (308 or 608), said congestion information corresponding to the packet being communicated.

Method Embodiment 4B The method of Method Embodiment 4, further comprising: operating the UPF (308 or 608) to mark (385b or 685b) an ECN field (3701 or 6701) of the packet being communicated (e.g., the ECN bits in an inner IP header) indicating congestion was experienced in response to receiving the congestion information in said GTP-U header, said congestion information indicating that congestion was encountered.

Method Embodiment 4C. The method of Method Embodiment 4B, wherein operating the UPF (308 or 608) to mark the ECN field (3701 or 6701) of the packet being communicated includes changing the bits of ECN field to a value (e.g., 1,1) indicating congestion was encountered when the bits of the ECN field are not already set to indicate that congestion was encountered.

Method Embodiment 4D. The method of Method Embodiment 4C, further comprising: operating the UPF (308 or 608) to send (3832 or 6832) the IP packet to be communicated with the congestion information (e.g., indicated in the inner-most IP header bits 3701 or 6701) to a data network (310 or 610) (e.g., with the packet ultimately being directed to and delivered to an application (375 or 675) of a destination node (e.g., destination device 311 or 611) of the data network (310 or 610) to which the IP packet being communicated is sent).

Method Embodiment 5. The method of Method Embodiment 3, wherein operating the core network interface device (e.g., a N3IWF (306) or a TNGF (606)) to relay congestion information includes: operating the core network interface device (e.g., a N3IWF (306) or a TNGF (606) to transfer (384a or 684a) the packet to be communicated from the core network interface device to the UPF (308 or 608), with the congestion information to be communicated being located in the outer IP header of the packet to be communicated.

Method Embodiment 5A1. The method of Method Embodiment 5, further comprising: operating the UPF (398 or 608) to relay (386a or 386b) congestion information from the outer IP header to the inner IP header.

Method Embodiment 5A. The method of Method Embodiment 5, further comprising: operating the UPF (398 or 608) to mark (386b or 686b) an ECN field (3701 or 6701) of the packet being communicated (e.g., the ECN bits in an inner IP header) indicating congestion was experienced in response to receiving the congestion information in the outer IP header of the packet being communicated indicating that congestion was encountered.

Method Embodiment 5B. The method of Method Embodiment 5A, wherein operating the UPF (308 or 608) to mark the ECN field (3701 or 6701) of the packet being communicated includes changing the bits of ECN field to a value (e.g., bit pattern (1,1) indicating congestion was encountered when the bits of the ECN field are not already set to indicate that congestion was encountered.

Method Embodiment 5C. The method of Method Embodiment 5B, further comprising: operating the UPF (308 or 608) to send (3832 or 6832) the IP packet to be communicated with the congestion information (e.g., indicated in the inner-most IP header bits 3701 or 6701) to a data network (310 or 610) (e.g., with the packet ultimately being directed to, and delivered (3762 or 6732) to, an application (375 or 675) of a destination node (e.g., destination device 311 or 611, e.g., a server or UE) of the data network (310 or 610) to which the IP packet being communicated is sent).

Method Embodiment 6A. The method of any of the preceding Method Embodiments wherein the non-3GPP AP is a WLAN AP (304), e.g., a WiFi AP.

Method Embodiment 6B. The method of any of the preceding Method Embodiments wherein the non-3GPP AP is a TNAP (604).

Method Embodiment 6C. The method of any of the preceding Method Embodiments wherein the core network interface device is a N3IWF (306).

Method Embodiment 6D. The method of any of the preceding Method Embodiments wherein the core network interface device is a TNGF (606).

### First Numbered List of Exemplary System Embodiments

System Embodiment 1. A communications system (100 or 301 or 601) supporting L4S in non-3GPP accesses, the communications system comprising:

a non-3GPP access point (AP) (e.g., a WLAN AP (304) or a TNAP (604)) including a first processor (1102 or 1202) configured to: operate the non-3GPP access point (AP) (e.g., a WLAN AP (304) or a TNAP (604) to monitor (3790 or 6790) for congestion on the uplink; detect (379 or 679) at the non-3GPP AP uplink congestion; operate the non-3GPP AP to indicate (381 or 681) via bits of an outer IP header ECN field of a packet being communicated that congestion was experienced (assuming that the ECN field was set to ECT(1)); and a core network interface device (e.g., a N3IWF (306) or a TNGF (606)) including a second processor (1302 or 1402) configured to: operate the core network interface device (e.g., a N3IWF (306) or a TNGF (606)) to detect (382 or 682) that the bits of the outer IP header ECN field of the packet being communicated are set indicating congestion.

System Embodiment 1AA. The communications system of System Embodiment 1, wherein said first processor (1102 or 1202) is configured to: operate the non-3GPP AP (e.g., a WLAN AP (304) or a TNAP (604) to monitor an uplink data buffer (3041 or 6041) in the non-3GPP AP (304 or 604) used for storing received L4S traffic, as part of being configured to operate the non-3GPP access point (AP) (e.g., a WLAN AP (304) or a TNAP (604) to monitor (3790 or 6790) for congestion on the uplink.

System Embodiment 1AB. The communications system of System Embodiment 1AA, wherein said first processor (1102 or 1202) is configured to: detect an amount of traffic in the uplink data buffer (3041 or 6041) in the non-3GPP AP (304 or 604) used for storing L4S traffic that exceeds a congestion level threshold, as part of being configured to detect (379 or 679) at the non-3GPP AP uplink congestion.

System Embodiment 1A. The communications system of System Embodiment 1, wherein said packet being communicated is an IP packet directed to a data network (310 or 610) to which is the packet being communicated, said packet being communicated originating at a UE (302 or 602) which sends the packet to be communicated to the data network via the non-3GPP access point (AP).

System Embodiment 1B. The communications system of System Embodiment 1A, wherein said packet being communicated, includes an inner IP header (which may and sometimes does include an ECN field or to which an ECN field can be added, e.g., by inserting or including ECN information in the inner packet header, as the packet is communicated to the destination node).

System Embodiment 1C. The communications system of System Embodiment 1, wherein said first processor (1102 or 1202) is configured to:

operate the non-3GPP AP to set bits of the outer IP header ECN field of the packet being communicated to a value (e.g., (1, 1) indicating that congestion has been experienced, as part of being configured to operate the non-3GPP AP to indicate (381 or 681) via an IP header ECN field of the packet being communicated that congestion was experienced.

System Embodiment 1D. The communications system of System Embodiment 1, wherein the outer IP header ECN field of the packet being communicated includes two bits and wherein setting both of the bits to the value of 1 indicates that congestion has been encountered.

System Embodiment 2. The communications system of System Embodiment 1, wherein said second processor (1302 or 1402) is further configured to: operate the core network interface device (e.g., a N3IWF (306) or a TNGF (606) to relay (e.g. copy the bits communicating the congestion information) (383 or 683) congestion information from the outer IP header ECN field of the packet being communicated to an inner-most IP header of the packet being communicated.

System Embodiment 2A. The communications system of System Embodiment 2, wherein said second processor (1302 or 1402) is further configured to: operate the core network interface device (e.g., a N3IWF (306) or a TNGF (606) to send ((3831 or 6831) the IP packet to be communicated, with the inner-most IP header including ECN bits (3601 or 6601) communicating congestion information, to a UPF (308); and wherein said communications system further comprises a UPF (308 or 608) including a third processor (1502) configured to: operate the UPF (308 or 608) to send (3832 or 6832) the IP packet to be communicated with the congestion information (e.g., indicated in the inner-most IP header bits 3701 or 6701) to a data network (310 or 610) (e.g., to an application (375 or 675 of the data network (310 or 610) to which the IP packet being communicated is sent).

System Embodiment 2B. The communications system of System Embodiment 2A, wherein said third processor (1508) is further configured to:
operate the UPF (308 or 608) to send the IP packet to be communicated with the congestion information includes sending the IP packet with the innermost IP header ECN bits (3701 or 6701) communicating congestion information without additional congestion indication information (e.g., without an additional outer IP header including ECN bits).

System Embodiment 3. The communications system of System Embodiment 1, wherein said second processor (1302 or 1402) is further configured to:
operate the core network interface device (e.g., a N3IWF (306) or a TNGF (606) to relay (e.g., via outer IP header via steps 384a or via GTP-U header via steps 384b and 385a) congestion information (e.g., the value of the ECN bits) included in the outer IP header of the packet being communicated to a UPF (308 or 608) (e.g. GTP-U layer level communication without the need to communicated ECN information using an inner header of the IP packet being communicated or via outer IP layer level communication).

System Embodiment 4. The communications system of System Embodiment 3, wherein said second processor (1302 or 1402) is further configured to: operate the core network interface device (e.g., a N3IWF (306) or a TNGF (606) to provide (e.g., generate and/or associate) (384b or 684b) a GTP-U header (e.g., corresponding to the packet being communicated) with congestion information (e.g., with the value of the ECN bits that were in the outer IP header of the packet being communicated), as part of being configured to operate the core network interface device (e.g., a N3IWF (306) or a TNGF (606)) to relay congestion information.

System Embodiment 4A. The communications system of System Embodiment 4, wherein the second processor (1302 or 1402) is configured to:
operate the core network interface device (e.g., a N3IWF (306) or a TNGF (606)) to communicate (385a) the GTP-U header with the congestion information to a UPF (308 or 608), said congestion information corresponding to the packet being communicated, as part of being configured to operate the core network interface device (e.g., a N3IWF (306) or a TNGF (606) to relay congestion information.

System Embodiment 4B. The communications system of System Embodiment 4, further comprising: said UPF (308 or 608) including a third processor (1502) configured to: operate the UPF (308 or 608) to mark (385b or 685b) an ECN field (3701 or 6701) of the packet being communicated (e.g., the ECN bits in an inner IP header) indicating congestion was experienced in response to receiving the congestion information in said GTP-U header, said congestion information indicating that congestion was encountered.

System Embodiment 4C. The communications system of System Embodiment 4B, wherein said third processor (1502) is configured to:
operate the UPF (308 or 608) to change the bits of ECN field to a value (e.g., 1,1) indicating congestion was encountered when the bits of the ECN field are not already set to indicate that congestion was encountered, as part of being configured to operate the UPF (308 or 608) to mark the ECN field (3701 or 6701) of the packet being communicated.

System Embodiment 4D. The communications system of System Embodiment 4C, wherein said third processor (1502) is configured to: operate the UPF (308 or 608) to send (3832 or 6832) the IP packet to be communicated with the congestion information (e.g., indicated in the inner-most IP header bits 3701 or 6701) to a data network (310 or 610) (e.g., with the packet ultimately being directed to and delivered to an application (375 or 675) of a destination node (e.g., destination device 311 or 611) of the data network (310 or 610) to which the IP packet being communicated is sent).

System Embodiment 5. The communications system of System Embodiment 3, wherein said second processor (1302 or 1402) is configured to: operate the core network interface device (e.g., a N3IWF (306) or a TNGF (606) to transfer (384a or 684a) the packet to be communicated from the core network interface device to the UPF (308 or 608), with the congestion information to be communicated being located in the outer IP header of the packet to be communicated, as part of being configured to operate the core network interface device (e.g., a N3IWF (306) or a TNGF (606) to relay congestion information.

System Embodiment 5A1. The communications system of System Embodiment 5, further comprising: said UPF (308 or 608) including a third processor (1502) configured to: operate the UPF (308 or 608) to relay (386a or 386b) congestion information from the outer IP header to the inner IP header.

System Embodiment 5A The communications system of System Embodiment 5, wherein said third processor (1502) is further configured to: operate the UPF (308 or 608) to mark (386b or 686b) an ECN field (3701 or 6701) of the packet being communicated (e.g., the ECN bits in an inner IP header) indicating congestion was experienced in response to receiving the congestion information in the outer IP header of the packet being communicated indicating that congestion was encountered.

System Embodiment 5B. The communications system of System Embodiment 5A, wherein said third processor (1502) is configured to:
operate the UPF (308 or 608) to change the bits of ECN field to a value (e.g., bit pattern (1,1)) indicating congestion was encountered when the bits of the ECN field are not already set to indicate that congestion was encountered, as part of being configured to operate the UPF (308 or 608) to mark the ECN field (3701 or 6701) of the packet being communicated.

System Embodiment 5C. The communications system of System Embodiment 5B, wherein said third processor (1502) is further configured to: operate the UPF (308 or 608) to send (3832 or 6832) the IP packet to be communicated with the congestion information (e.g., indicated in the inner-most IP header bits 3701 or 6701) to a data network (310 or 610) (e.g., with the packet ultimately being directed to, and delivered (3762 or 6732) to, an application (375 or 675) of a destination node (e.g., destination device 311 or 611, e.g., a server or UE) of the data network (310 or 610) to which the IP packet being communicated is sent).

System Embodiment 6A. The communications system of any of the preceding System Embodiments wherein the non-3GPP AP is a WLAN AP (304), e.g., a WiFi AP.

System Embodiment 6B. The communications system of any of the preceding System Embodiments wherein the non-3GPP AP is a TNAP (604).

System Embodiment 6C. The communications system of any of the preceding System Embodiments wherein the core network interface device is a N3IWF (306).

System Embodiment 6D. The communications system of any of the preceding System Embodiments wherein the core network interface device is a TNGF (606).

### Second Numbered List of Exemplary Method Embodiments

Method Embodiment 1. A method of supporting L4S in non-3GPP accesses, the method comprising: operating a non-3GPP access point (AP) (e.g., a WLAN AP (404) or a TNAP (704) to monitor (4790 or 7790) for congestion on a downlink; detecting (479 or 779) at the non-3GPP AP downlink congestion; and operating the non-3GPP AP to indicate (481 or 781) via an IP header ECN field (4571 or 7571) that congestion was experienced (e.g., set the two bits of the ECN field of a downlink packet to the value (1,1) to indicate that congestion was experienced, if a downlink packet is used to communicate the congestion information to a downstream device, e.g., UE (402 or 702), the ECN field is set in a downlink packet, (optionally in some embodiments in the outer IP header) but in other embodiments the field is set in an uplink packet so that the AP downlink congestion information can be communicated to an upstream device, e.g. core network interfacing device (e.g., a N3IWF (406) or TNGF (706)) with in some cases the congestion information ultimately being inserted into a downlink packet that is then communicated to the UE (402 or 702)).

Method Embodiment 1AA. The method of Method Embodiment 1, wherein operating a non-3GPP access point (AP) (e.g., a WLAN AP (404) or a TNAP (704) to monitor (4790 or 7790) for congestion on the downlink includes monitoring a downlink data buffer (4041 or 7041) in the non-3GPP AP (404 or 704) used for storing L4S traffic to be communicated.

Method Embodiment 1AB. The method of Method Embodiment 1AA, wherein detecting (479 or 779) at the non-3GPP AP (404 or 704) downlink congestion includes detecting an amount of traffic in the downlink data buffer (4041 or 7041) in the non-3GPP AP (404 or 704) used for storing L4S traffic that exceeds a congestion level threshold.

Method Embodiment 1B. The method of Method Embodiment 1, further comprising: operating the non-3GPP access point (e.g., a WLAN AP (404) or a TNAP (704) to transmit (405) the IP header ECN field as part of a downlink IP packet to User Equipment (UE) (402 or 702).

Method Embodiment 1C. The method of Method Embodiment 1B, wherein the IP header ECN field used to communicate that downlink congestion was encountered is communicated in an outer IP header ECN field of a downlink packet.

Numbered method embodiments 2-2B relate to using a downlink packet from an AP to UE to communicate downlink congestion information without the need to use an uplink packet to communicate the information to another device.

Method Embodiment 2. The method of Method Embodiment 1, further comprising: operating user equipment (UE) (402 or 702) to receive (407) a downlink packet including the IP header ECN field communicating congestion information, said IP header ECN field being an outer IP header field; operating the user equipment (UE) (402 or 702) to detect (482a or 782a) that the outer IP header ECN field of the received downlink packet is set to a value indicating that congestion was experienced; and operating the UE (402 or 702) to relay (482b or 782b) information (e.g. copy congestion indication information indicating that congestion was experienced) to an inner IP header field (e.g., ECN field 4511) of the received downlink packet.

Method Embodiment 2A. The method of Method Embodiment 2, further comprising: providing (4512 or 7512) the received downlink packet including the inner IP header field with congestion information indicating that congestion was encountered to an application (450 or 750) in the UE (402 or 702).

Method Embodiment 2B. The method of Method Embodiment 2A wherein the congestion information indicating that congestion was encountered is a 2 bit ECN field value represented by a bit pattern of 1,1.

Numbered method embodiment 3 relates to an upstream device (e.g., N3IWF, TNGF or UPF) detecting an indicator of downlink congestion having been encountered which was communicated to the upstream device in an upstream packet after the non-3GPP AP inserted the indication of downlink congestion encountered into an upstream packet which would be received and processed by the upstream device.

Method Embodiment 3. The method of Method Embodiment 1, further comprising: operating a core network interface device (e.g., a N3IWF (406) or TNGF (706) to detect (483 or 783) (e.g., based on an indication of downlink congestion received from the non-3GPP AP, e.g., a WLAN AP (404) or a TNAP (704) that downlink congestion was encountered.

Method Embodiment 3A. The method of Method Embodiment 3, wherein detecting (483 or 783), at the core network interface device (406 or 706) that downlink congestion was encountered, is based on the detection of a downlink congestion detected indictor in an outer IP header of an upstream packet received from the non-3GPP access point (AP) (404 or 704).

Numbered method embodiment 3B relates to insertion of the congestion information into a downlink packet passing through the core network interface device (406 or 706).

Method Embodiment 3B. The method of Method Embodiment 3 further comprising: operating the core network interfacing device (e.g., a N3IWF (406) or TNGF (706)) to relay (484 or 784) congestion information, indicating that congestion was encountered, into a downlink packet (e.g., a packet intended to be delivered via a downlink transmission) passing through the core network interface device (406 or 706) (e.g., into a packet which is being sent to the non-3GPP access node (404 or 704) where the downlink congestion was detected) (In some but not necessarily all embodiments this involves copying or inserting into an ECN field (4601 or 7601) of a downlink IP packet, e.g. a packet being communicated subsequent to the detection of downlink congestion at the non-3GPP AP (404 or 704) information, e.g., a congestion information indicator value (e.g., ECN bit pattern=(1,1)), indicating that congestion was encountered thereby informing devices receiving the downlink packet of downlink congestion).

Method Embodiment 3A. The method of Method Embodiment 3B, wherein operating the core network interfacing device (406 or 706) to relay (484 or 784) congestion information includes operating the core network interface device to set bits in an ECN field (4601 or 7601) of inner-most IP header of a downlink packet (i.e., a packet to be delivered in a downlink transmission) to a value (e.g., represented by bit pattern=1,1) indicating congestion has been encountered.

Numbered method embodiment 4 relates to implementations where downlink congestion information is communicated to UPF via outer IP header or via GTP-U layer.

Method Embodiment 4. The method of Method Embodiment 3, further comprising: operating the core network interface device to relay (485a with 487a) or (785a with 787a) or (485b with 486a) or (785b with 786a) congestion information (e.g., indicating that downlink congestion was encountered) to a UPF (408 or 708).

Method Embodiment 4A1. The method of Method Embodiment 4, wherein operating the core network interface device (e.g., a N3IWF (406) or a TNGF (706) to relay congestion information includes: operating the core network interface device (e.g., a N3IWF (406) or a TNGF (706) to provide (e.g., generate and/or associate) (485b or 785b) a GTP-U header with congestion information indicating that congestion was encountered in the downlink.

Method Embodiment 4A. The method of Method Embodiment 4, wherein operating the core network interface device (e.g., a N3IWF (406) or a TNGF (706) to relay congestion information further includes: operating the core network interface device (e.g., a N3IWF (406) or a TNGF (706) to communicate (486a or 786a) the GTP-U header with the congestion information to a UPF (408 or 708), said congestion information indicating that downlink congestion was encountered.

Method Embodiment 4A1. The method of Method Embodiment 4A, wherein operating the core network interface device (e.g., a N3IWF (406) or a TNGF (706) to communicate (486a or 786a) the GTP-U header with the congestion information to a UPF (408 or 708) includes sending (4603 or 7603) a GTP-U uplink (UL) packet to the UPF 408.

Method Embodiment 4A2. The method of Method Embodiment 4A1, wherein the GTP-U UL packet is a dummy packet.

Method Embodiment 4B. The method of Method Embodiment 4A, further comprising: operating the UPF (408 or 708) to mark (486b or 786b) an ECN field (4701 or 7701) of a downlink packet being communicated through the UPF (e.g., set the ECN bits in an inner IP header 4701 or 7701) to indicate that downlink congestion was experienced in response to receiving the congestion information in said GTP-U header, said congestion information indicating that congestion was encountered in the downlink.

Method Embodiment 4C. The method of Method Embodiment 4B, wherein operating the UPF (408 or 708) to mark the ECN field (4701 or 7701) of the downlink packet being communicated includes changing the bits of ECN field to a value (e.g., represented by bit pattern=(1,1)) indicating congestion was encountered when the bits of the ECN field are not already set to indicate that congestion was encountered.

Method Embodiment 4D. The method of Method Embodiment 4C, further comprising: operating the UPF (408 or 708) to send (4602 or 7602) the downlink IP packet including the downlink congestion information (e.g., IP header bits 4701 or 7701) to the core network interface device (e.g., a N3IWF (406) or a TNGF (706) (e.g., with the packet ultimately being directed to and delivered to an application (450 or 750) of a UE (402 or 702) via downlink communication).

Numbered method embodiment 5 relates to communicating congestion information in an IP header sent between the network interworking function device (406 or 706) and UPF (408 or 708).

Method Embodiment 5. The method of Method Embodiment 4, wherein operating the core network interface device (e.g., a N3IWF (406) or a TNGF (706)) to relay congestion information includes: operating the core network interface device (e.g., a N3IWF (406) or a TNGF (706) to transfer (485a or 785a) a packet including downlink congestion information to the UPF (408 or 708).

Method Embodiment 5A1. The method of Method Embodiment 5, further comprising: operating the UPF (408 or 708) to relay (487a or 487b) congestion information from the outer IP header to the inner IP header.

Method Embodiment 5A The method of Method Embodiment 5, further comprising: operating the UPF (408 or 708) to mark (487b or 787b) an ECN field (4701 or 7701) of a downlink packet (e.g., set the ECN bits in an inner IP header 4701 or 7701) to indicate that congestion was experienced in the downlink direction in response to receiving the downlink congestion information.

Method Embodiment 5B. The method of Method Embodiment 5A, wherein operating the UPF (408 or 708) to mark the ECN field (4701 or 7701) of the downlink packet includes changing the bits of ECN field to a value (e.g., 1,1) indicating congestion was encountered when the bits of the ECN field are not already set to indicate that congestion was encountered.

Method Embodiment 5C. The method of Method Embodiment 5B, further comprising: operating the UPF (408 or 708) to send (4602 or 7602) the downlink IP packet including the downlink congestion information (e.g., ECN field IP header bits 4701 or 7701) to the core network interface device (e.g., a N3IWF (406) or a TNGF (706) (e.g., with the packet ultimately being directed to and delivered to an application (450 or 770) of a UE (402 or 702 via downlink communication).

Method Embodiment 6A. The method of any of the preceding Method Embodiments wherein the non-3GPP AP is a WLAN AP (404), e.g., a WiFi AP.

Method Embodiment 6B. The method of any of the preceding Method Embodiments wherein the non-3GPP AP is a TNAP (704).

Method Embodiment 6C. The method of any of the preceding Method Embodiments wherein the core network interface device is a N3IWF (406).

Method Embodiment 6D. The method of any of the preceding Method Embodiments wherein the core network interface device is a TNGF (706)).

### Second Numbered List of Exemplary System Embodiments

System Embodiment 1. A communications system (401 or 701 or 100) supporting L4S in non-3GPP accesses, the communications system comprising: a non-3GPP access point (AP) (e.g., a WLAN AP (404) or a TNAP (704)) including a first processor (1102 or 1202) configured to: operate the non-3GPP access point (AP) (e.g., a WLAN AP (404) or a TNAP (704) to monitor (4790 or 7790) for congestion on a downlink; detect (479 or 779) at the non-3GPP AP downlink congestion; and operate the non-3GPP AP to indicate (481 or 781) via an IP header ECN field (4571 or 7571) that congestion was experienced (e.g., set the two bits of the ECN field of a downlink packet to the value (1,1) to indicate that congestion was experienced, if a downlink packet is used to communicate the congestion information to a downstream device, e.g., UE (402 or 702), the ECN field is set in a downlink packet, (optionally in some embodiments in the outer IP header) but in other embodiments the field is set in an uplink packet so that the AP downlink congestion information can be communicated to an upstream device, e.g. core network interfacing device (e.g., a N3IWF (406) or TNGF (706)) with in some cases the congestion information ultimately being inserted into a downlink packet that is then communicated to the UE (402 or 702)).

System Embodiment 1AA. The communications system of System Embodiment 1, wherein said first processor (1102 or 1202) is configured to:
operate the non-3GPP AP (404 or 704) to monitor a downlink data buffer (4041 or 7041) in the non-3GPP AP (404 or 704) used for storing LAS traffic to be communicated, as part of being configured to operate the non-3GPP access point (AP) (e.g., a WLAN AP (404) or a TNAP (704)) to monitor (4790 or 7790) for congestion on the downlink.

System Embodiment 1AB. The communications system of System Embodiment 1AA, wherein said first processor (1102 or 1202) is configured to:
detect an amount of traffic in the downlink data buffer (4041 or 7041) in the non-3GPP AP (404 or 704) used for storing L4S traffic that exceeds a congestion level threshold, as part of being configured to detect (479 or 779) at the non-3GPP AP (404 or 704) downlink congestion.

System Embodiment 1B. The communications system of System Embodiment 1, wherein said first processor (1102 or 1202) is further configured to: operate the non-3GPP access point (e.g., a WLAN AP (404) or a TNAP (704) to transmit (405) the IP header ECN field as part of a downlink IP packet to User Equipment (UE) (402 or 702).

System Embodiment 1C. The communications system of System Embodiment 1B, wherein the IP header ECN field used to communicate that downlink congestion was encountered is communicated in an outer IP header ECN field of a downlink packet.

System Embodiment 2. The communications system of System Embodiment 1, further comprising: a user equipment (UE) (402 or 702) including a second processor (1002) configured to: operate the user equipment (UE) (402 or 702) to receive (407) a downlink packet including the IP header ECN field communicating congestion information, said IP header ECN field being an outer IP header field; operate the user equipment (UE) (402 or 702) to detect (482a or 782a) that the outer IP header ECN field of the received downlink packet is set to a value indicating that congestion was experienced; and operate the UE (402 or 702) to relay (482b or 782b) information (e.g. copy congestion indication information indicating that congestion was experienced) to an inner IP header field (e.g., ECN field 4511) of the received downlink packet.

System Embodiment 2A. The communications system of System Embodiment 2, wherein said second processor (1002) is further configured: to operate the UE (402 or 702) to provide (4512 or 7512) the received downlink packet including the inner IP header field with congestion information indicating that congestion was encountered to an application (450 or 750) in the UE (402 or 702).

System Embodiment 2B. The communications system of System Embodiment 2A wherein the congestion information indicating that congestion was encountered is a 2 bit ECN field value represented by a bit pattern of 1,1.

System Embodiment 3. The communications system of System Embodiment 1, further comprising: a core network interface device (e.g., a N3IWF (406) or TNGF (706)) including a second processor (1302 or 1402) configured to: operate the core network interface device (e.g., a N3IWF (406) or TNGF (706) to detect (483 or 783) (e.g., based on an indication of downlink congestion received from the non-3GPP AP, e.g., a WLAN AP (404) or a TNAP (704) that downlink congestion was encountered.

System Embodiment 3A. The communications system of System Embodiment 3, wherein detecting (483 or 783), at the core network interface device (406 or 706) that downlink congestion was encountered, is based on the detection of a downlink congestion detected indictor in an outer IP header of an upstream packet received from the non-3GPP access point (AP) (404 or 704).

System Embodiment 3B. The communications system of System Embodiment 3, wherein said second processor (1202 or 1402) is configured to: operate the core network interfacing device (e.g., a N3IWF (406) or TNGF (706)) to relay (484 or 784) congestion information, indicating that congestion was encountered, into a downlink packet (e.g., a packet intended to be delivered via a downlink transmission) passing through the core network interface device (406 or 706) (e.g., into a packet which is being sent to the non-3GPP access node (404 or 704) where the downlink congestion was detected) (In some but not necessarily all embodiments this involves copying or inserting into an ECN field (4601 or 7601) of a downlink IP packet, e.g. a packet being communicated subsequent to the detection of downlink congestion at the non-3GPP AP (404 or 704) information, e.g., a congestion information indicator value (e.g., ECN bit pattern=(1,1)), indicating that congestion was encountered thereby informing devices receiving the downlink packet of downlink congestion).

System Embodiment 3A. The communications system of System Embodiment 3B, wherein said second processor (1302 or 1402) is configured to:
operate the core network interface device to set bits in an ECN field (4601 or 7601) of inner-most IP header of a downlink packet (i.e., a packet to be delivered in a downlink transmission) to a value (e.g., represented by bit pattern=1,1) indicating congestion has been encountered, as part of being configured to operate the core network interfacing device (406 or 706) to relay (484 or 784) congestion information.

System Embodiment 4. The communications system of System Embodiment 3, wherein said second processor (1302 or 1402) is configured to: operate the core network interface device to relay ((485a with 487a) or (785a with 787a) or (485b with 486a) or (785b with 786a) congestion information (e.g., indicating that downlink congestion was encountered) to a UPF (408 or 708).

System Embodiment 4A1. The communications system of System Embodiment 4, wherein said second processor (1302 or 1402) is configured to: operate the core network interface device (e.g., a N3IWF (406) or a TNGF (706) to provide (e.g., generate and/or associate) (485b or 785b) a GTP-U header with congestion information indicating that congestion was encountered in the downlink, as part of being configured to operate the core network interface device (e.g., a N3IWF (406) or a TNGF (706)) to relay congestion information.

System Embodiment 4A. The communications system of System Embodiment 4, wherein said second processor (1302 or 1402) is configured to:
operate the core network interface device (e.g., a N3IWF (406) or a TNGF (706)) to communicate (486a or 786a) the GTP-U header with the congestion information to a UPF (408 or 708), said congestion information indicating that downlink congestion was encountered, as part of being configured to operate the core network interface device (e.g., a N3IWF (406) or a TNGF (706) to relay congestion information.

System Embodiment 4A1. The communications system of System Embodiment 4A, wherein said second processor (1302 or 1402) is configured to: operate the core network interface device (406 or 706) to send (4603 or 7603) a GTP-U uplink (UL) packet to the UPF 408, as part of being configured to operate the core network interface device (e.g., a N3IWF (406) or a TNGF (706) to communicate (486a or 786a) the GTP-U header with the congestion information to a UPF (408 or 708).

System Embodiment 4A2. The communications system of System Embodiment 4A1, wherein the GTP-U UL packet is a dummy packet.

System Embodiment 4B. The communications system of System Embodiment 4A, further comprising: a user plane function (408 or 708) including a third processor (1502) configured to: operate the UPF (408 or 708) to mark (486b or 786b) an ECN field (4701 or 7701) of a downlink packet being communicated through the UPF (e.g., set the ECN bits in an inner IP header 4701 or 7701) to indicate that downlink congestion was experienced in response to receiving the congestion information in said GTP-U header, said congestion information indicating that congestion was encountered in the downlink.

System Embodiment 4C. The communications system of System Embodiment 4B, wherein said third processor (1502) is configured to:
change the bits of ECN field to a value (e.g., represented by bit pattern=(1,1) indicating congestion was encountered when the bits of the ECN field are not already set to indicate that congestion was encountered, as part of being configured to operate the UPF (408 or 708) to mark the ECN field (4701 or 7701) of the downlink packet being communicated.

System Embodiment 4D. The communications system of System Embodiment 4C, wherein said third processor (1502) is further configured to: operate the UPF (408 or 708) to send (4602 or 7602) the downlink IP packet including the downlink congestion information (e.g., IP header bits 4701 or 7701) to the core network interface device (e.g., a N3IWF (406) or a TNGF (706) (e.g., with the packet ultimately being directed to and delivered to an application (450 or 750) of a UE (402 or 702) via downlink communication).

System Embodiment 5. The communications system of System Embodiment 4, wherein said second processor (1302 or 1402) is configured to: operate the core network interface device (e.g., a N3IWF (406) or a TNGF (706)) to transfer (485a or 785a) a packet including downlink congestion information to the UPF (408 or 708), as part of being configured to operate the core network interface device (e.g., a N3IWF (406) or a TNGF (706) to relay congestion information.

System Embodiment 5A1. The communications system of System Embodiment 5, further comprising: a user plane function (408 or 708) including a third processor (1502) configured to: operate the UPF (408 or 708) to relay (487a or 487b) congestion information from the outer IP header to the inner IP header.

System Embodiment 5A The communications system of System Embodiment 5, wherein said third processor (1502) is further configured to: operate the UPF (408 or 708) to mark (487b or 787b) an ECN field (4701 or 7701) of a downlink packet (e.g., set the ECN bits in an inner IP header 4701 or 7701) to indicate that congestion was experienced in the downlink direction in response to receiving the downlink congestion information.

System Embodiment 5B. The communications system of System Embodiment 5A, wherein said third processor (1502) is configured to: change the bits of ECN field to a value (e.g., represented by a bit pattern=1,1) indicating congestion was encountered when the bits of the ECN field are not already set to indicate that congestion was encountered, as part of being configured to operate the UPF (408 or 708) to mark the ECN field (4701 or 7701) of the downlink packet.

System Embodiment 5C. The communications system of System Embodiment 5B, wherein said third processor (1502) is further configured to: operate the UPF (408 or 708) to send (4602 or 7602) the downlink IP packet including the downlink congestion information (e.g., ECN field IP header bits 4701 or 7701) to the core network interface device (e.g., a N3IWF (406) or a TNGF (706) (e.g., with the packet ultimately being directed to and delivered to an application (450 or 770) of a UE (402 or 702 via downlink communication).

System Embodiment 6A. The communications system of any of the preceding System Embodiments wherein the non-3GPP AP is a WLAN AP (404), e.g., a WiFi AP.

System Embodiment 6B. The communications system of any of the preceding System Embodiments wherein the non-3GPP AP is a TNAP (704).

System Embodiment 6C. The communications system of any of the preceding System Embodiments wherein the core network interface device is a N3IWF (406).

System Embodiment 6D. The communications system of any of the preceding System Embodiments wherein the core network interface device is a TNGF (706).

### Third Numbered List of Exemplary Method Embodiments

Method Embodiment 1. A method of supporting L4S in non-3GPP accesses, the method comprising: operating a core network interface device (e.g., a N3IWF (506) or TNGF (806) to monitor (5790 or 8790) for congestion on the downlink; and detecting (579 or 879) at the core network interface device downlink congestion.

Method Embodiment 1AA. The method of Method Embodiment 1, wherein operating a core network interface device (e.g., a N3IWF (506) or TNGF (806)) to monitor (5790 or 8790) for congestion on the downlink includes monitoring a downlink data buffer (5061 or 8061) in the core network interface device (e.g., a N3IWF (506) or TNGF (806)) used for storing L4S traffic to be communicated (e.g., with the traffic being traffic from a data network (510 or 810) which is to be communicated over a downlink to a UE (502 or 802).

Method Embodiment 1AB. The method of Method Embodiment 1AA, wherein detecting (579 or 879) at the core network interface device (506 or 806) downlink congestion includes detecting an amount of traffic in the downlink data buffer (5061 or 8061) in the core network interface device (506 or 806) used for storing L4S traffic that exceeds a congestion level threshold.

Method Embodiment 2. The method of Method Embodiment 1, further comprising: operating the core network interface device (506 or 806) to indicate (581 or 881) via an IP header ECN field that congestion was experienced (e.g., assuming that the ECN field was set to ECT(1)).

Method Embodiment 2A. The method of Method Embodiment 2, wherein operating the core network interface device (506 or 806) to indicate (581 or 881) via an IP header ECN field that congestion was experienced
includes: operating the core network interface device (506 or 806) to mark (581 or 881) an ECN field (5601 or 8601) of a downlink packet being communicated through the core network interface device (506 or 806) (e.g., set the ECN bits (5601 or 8601) in an innermost IP header 560 or 860) to indicate that downlink congestion was experienced.

Method Embodiment 2B. The method of Method Embodiment 2A, wherein operating the core network interface device (506 or 806) to mark (581 or 881) the ECN field of the downlink packet to indicate that congestion was experienced includes changing the bits of ECN field to a value (e.g., represented by bit pattern=(1,1)) indicating congestion was encountered when the bits of the ECN field are not already set to indicate that congestion was encountered.

Method Embodiment 2C. The method of Method Embodiment 2B, further comprising: operating the operating the core network interface device (506 or 806) to communicate (5791 or 8791) the downlink packet with the ECN field set to the value indicating that congestion was encountered to a non-3GPP access point (e.g., WLAN AP 504 or TNAP 804)

Method Embodiment 3. The method of Method Embodiment 1, further comprising: operating the core network interface device (506 or 806) to provide (582 or 882) (e.g., relay) congestion information related to congestion (e.g., downlink congestion) experienced by the core network interface device via a GTP-U header.

Method Embodiment 3A. The method of Method Embodiment 3, wherein operating the core network interface device (e.g., a N3IWF (506) or a TNGF (806) to provide congestion information further includes: operating the core network interface device (506 or 806) to generate (582a or 882a) a GTP-U header including information indicating that downlink congestion was encountered; and operating the core network interface device (e.g., a N3IWF (506) or a TNGF (806) to communicate (582b or 882b) the GTP-U header with the congestion information to a UPF (508 or 808), said congestion information indicating that downlink congestion was encountered.

Method Embodiment 3A1. The method of Method Embodiment 3A, wherein operating the core network interface device (e.g., a N3IWF (506) or a TNGF (806) to communicate (582b or 882b) the GTP-U header with the congestion information to a UPF (508 or 808) includes sending (5603 or 8603) a GTP-U uplink (UL) packet to the UPF (508 or 808).

Method Embodiment 3A2. The method of Method Embodiment 3A1, wherein the GTP-U UL packet is a dummy packet.

Method Embodiment 3AA. The method of Method Embodiment 3A, further comprising: operating a UPF (508 or 808) to receive (583a or 883a) congestion information the GTP-U header including congestion information.

Method Embodiment 3B The method of Method Embodiment 3AA, further comprising: operating the UPF (508 or 808) to mark (583b or 883b) (e.g., set) an ECN field (5701 or 8701) of a downlink packet being communicated through the UPF (e.g., set the ECN bits in an inner IP header 5701 or 8701), based on the received congestion information included in the received GTP-U header, to indicate that downlink congestion was experienced in response to receiving the congestion information in said GTP-U header, said congestion information indicating that congestion was encountered in the downlink.

Method Embodiment 3C. The method of Method Embodiment 3B, wherein operating the UPF (508 or 808) to mark the ECN field (5701 or 8701) of the downlink packet being communicated includes changing the bits of ECN field to a value (e.g., represented by bit pattern=(1,1)) indicating congestion was encountered when the bits of the ECN field are not already set to indicate that congestion was encountered.

Method Embodiment 3D. The method of Method Embodiment 3C, further comprising: operating the UPF (508 or 808) to send (5672 or 8792) the downlink IP packet including the downlink congestion information (e.g., IP header bits 5701 or 8701) to the core network interface device (e.g., a N3IWF (506) or a TNGF (806) (e.g., with the packet ultimately being directed to and delivered to an application (550 or 850) of a UE (502 or 802) via downlink communication).

Method Embodiment 4. The method of Method Embodiment 1 wherein the core network interface device is a N3IWF (506).

Method Embodiment 5. The method of Method Embodiment 1, wherein the core network interface device is a TNGF (806)

Method Embodiment 6. The method of Method Embodiment 2C, wherein the non-3GPP access point (504) is a WLAN AP, e.g., a WiFi AP.

Method Embodiment 7. The method of Method Embodiment 2C, wherein the non-3GPP access point (804) is a TNAP (804).

### Third Numbered List of Exemplary System Embodiments

System Embodiment 1. A communications system (501 or 801 or 100) supporting L4S in non-3GPP accesses, the communications system comprising: a core network interface device (e.g., a N3IWF (506) or TNGF (806)) including a first processor (1302 or 1402) configured to: operate the core network interface device (e.g., a N3IWF (506) or TNGF (806)) to monitor (5790 or 8790) for congestion on the downlink; and detect (579 or 879) at the core network interface device downlink congestion.

System Embodiment 1AA. The communications system of System Embodiment 1, wherein said first processor (1302 or 1402) is configured to:
operate the core network interface device (506 or 806) to monitor a downlink data buffer (5061 or 8061) in the core network interface device (e.g., a N3IWF (506) or TNGF (806)) used for storing L4S traffic to be communicated (e.g., with the traffic being traffic from a data network (510 or 810) which is to be communicated over a downlink to a UE (502 or 802), as part of being configured to operate the core network interface device (e.g., a N3IWF (506) or TNGF (806) to monitor (5790 or 8790) for congestion on the downlink.

System Embodiment 1AB. The communications system of System Embodiment 1AA, wherein said first processor (1302 or 1402) is configured to: detect an amount of traffic in the downlink data buffer (5061 or 8061) in the core network interface device (506 or 806) used for storing L4S traffic that exceeds a congestion level threshold, as part of being configured to detect (579 or 879) at the core network interface device (506 or 806) downlink congestion.

System Embodiment 2. The communications system of System Embodiment 1, wherein said first processor (1302 or 1402) is further configured to: operate the core network interface device (506 or 806) to indicate (581 or 881) via an IP header ECN field that congestion was experienced (e.g., assuming that the ECN field was set to ECT(1).

System Embodiment 2A. The communications system of System Embodiment 2, wherein said first processor (1302 or 1402) is configured to: operate the core network interface device (506 or 806) to mark (581 or 881) an ECN field (5601 or 8601) of a downlink packet being communicated through the core network interface device (506 or 806) (e.g., set the ECN bits (5601 or 8601) in an innermost IP header 560 or 860) to indicate that downlink congestion was experienced, as part of being configured to operate the core network interface device (506 or 806) to indicate (581 or 881) via an IP header ECN field that congestion was experienced.

System Embodiment 2B. The communications system of System Embodiment 2A, wherein said first processor (1302 or 1402) is configured to operate the core network interface device (506 or 806) to: change the bits of ECN field to a value (e.g., represented by bit pattern=(1,1)) indicating congestion was encountered when the bits of the ECN field are not already set to indicate that congestion was encountered, as part of being configured to operate the core network interface device (506 or 806) to mark (581 or 881) the ECN field of the downlink packet to indicate that congestion was experienced.

System Embodiment 2C. The communications system of System Embodiment 2B, wherein said first processor (1302 or 1402) is further configured to: operate the operating the core network interface device (506 or 806) to communicate (5791 or 8791) the downlink packet with the ECN field set to the value indicating that congestion was encountered to a non-3GPP access point (e.g., WLAN AP 504 or TNAP 804).

System Embodiment 3. The communications system of System Embodiment 1, wherein said first processor (1302 or 1402) is further configured to: operate the core network interface device (506 or 806) to provide (582 or 882) (e.g., relay) congestion information related to congestion (e.g., downlink congestion) experienced by the core network interface device via a GTP-U header.

System Embodiment 3A. The communications system of System Embodiment 3, wherein said first processor (1302 or 1402) is configured to: operate the core network interface device (506 or 806) to generate (582a or 882a) a GTP-U header including information indicating that downlink congestion was encountered; and
operate the core network interface device (e.g., a N3IWF (506) or a TNGF (806)) to communicate (582b or 882b) the GTP-U header with the congestion information to a UPF (508 or 808), said congestion information indicating that downlink congestion was encountered, as part of being configured to operate the core network interface device (e.g., a N3IWF (506) or a TNGF (806)) to provide congestion information.

System Embodiment 3A1. The communications system of System Embodiment 3A, wherein said first processor (1302 or 1402) is configured to operate the core network interface device (506 or 806) to send (5603 or 8603) a GTP-U uplink (UL) packet to the UPF (508 or 808), as part of being configured to operating the core network interface device (e.g., a N3IWF (506) or a TNGF (806) to communicate (582b or 882b) the GTP-U header with the congestion information to a UPF (508 or 808).

System Embodiment 3A2. The communications system of System Embodiment 3A1, wherein the GTP-U UL packet is a dummy packet.

System Embodiment 3AA. The communications system of System Embodiment 3A, further comprising: said UPF (508 or 808) including a second processor (1502) configured to: operate the UPF (508 or 808) to receive (583a or 883a) congestion information the GTP-U header including congestion information.

System Embodiment 3B The communications system of System Embodiment 3AA, wherein said second processor (1502) is further configured to: operate the UPF (508 or 808) to mark (583b or 883b) (e.g., set) an ECN field (5701 or 8701) of a downlink packet being communicated through the UPF (e.g., set the ECN bits in an inner IP header 5701 or 8701), based on the received congestion information included in the received GTP-U header, to indicate that downlink congestion was experienced in response to receiving the congestion information in said GTP-U header, said congestion information indicating that congestion was encountered in the downlink.

System Embodiment 3C. The communications system of System Embodiment 3B, wherein said second processor (1502) is configured to:
change the bits of ECN field to a value (e.g., represented by bit pattern=(1,1) indicating congestion was encountered when the bits of the ECN field are not already set to indicate that congestion was encountered, as part of being configured to operate the UPF (508 or 808) to mark the ECN field (5701 or 8701) of the downlink packet being communicated.

System Embodiment 3D. The communications system of System Embodiment 3C, wherein said second processor (1502) is further configured to: operate the UPF (508 or 808) to send (5672 or 8792) the downlink IP packet including the downlink congestion information (e.g., IP header bits 5701 or 8701) to the core network interface device (e.g., a N3IWF (506) or a TNGF (806) (e.g., with the packet ultimately being directed to and delivered to an application (550 or 850) of a UE (502 or 802) via downlink communication).

System Embodiment 4. The communications system of System Embodiment 1 wherein the core network interface device is a N3IWF (506).

System Embodiment 5. The communications system of System Embodiment 1, wherein the core network interface device is a TNGF (806).

System Embodiment 6. The communications system of System Embodiment 2C, wherein the non-3GPP access point (504) is a WLAN AP, e.g., a WiFi AP.

System Embodiment 7. The communications system of System Embodiment 2C, wherein the non-3GPP access point (804) is a TNAP (804).

### Fourth Numbered List of Exemplary Method Embodiments

Method Embodiment 1. A method of supporting L4S in non-3GPP accesses, the method comprising: operating a core network interface device (e.g., a N3IWF (306) or TNGF (606) to monitor (3890 or 6890) for congestion in an uplink direction; and detecting (389 or 689) at the core network interface device congestion in the uplink direction.

Method Embodiment 1AA. The method of Method Embodiment 1, wherein operating a core network interface device (e.g., a N3IWF (306) or TNGF (606)) to monitor (3890 or 6890) for congestion in the uplink direction includes monitoring an uplink data buffer (3061 or 6061) in the core network interface device (e.g., a N3IWF (306) or TNGF (606) used for storing L4S traffic to be communicated in the uplink direction (e.g., with the traffic being communicated from the network interface device towards a data network (310 or 610)).

Method Embodiment 1AB. The method of Method Embodiment 1AA, wherein detecting (389 or 689) at the core network interface device (306 or 606) congestion in the uplink direction includes detecting an amount of traffic in the uplink data buffer (3061 or 6061) in the core network interface device (306 or 606) used for storing L4S traffic that exceeds a congestion level threshold.

Method embodiments 2-2C relate to IP setting of ECN bits (3601 or 6601) at core network interface device (N3IWF 306 or TNGF 606).

Method Embodiment 2. The method of Method Embodiment 1, further comprising: operating the core network interface device (306 or 606) to indicate (390 or 690) via an IP header ECN field (3601 or 6601) that congestion was experienced (e.g., assuming that the ECN field was set to ECT(1)).

Method Embodiment 2A. The method of Method Embodiment 2, wherein operating the core network interface device (306 or 606) to indicate (390 or 690) via an IP header ECN field (3601 or 6601) that congestion was experienced includes: operating the core network interface device (306 or 606) to mark (390 or 690) an ECN field (3601 or 6601) of an uplink packet being communicated through the core network interface device (306 or 606) (e.g., set the ECN bits (3601 or 6601) in an innermost IP header 360 or 660) to indicate that uplink congestion was experienced.

Method Embodiment 2B. The method of Method Embodiment 2A, wherein operating the core network interface device (306 or 606) to mark (390 or 690) the ECN field (3601 or 6601) of the uplink packet to indicate that congestion was experienced includes changing (e.g., setting) the bits of ECN field to a value (e.g., represented by bit pattern=(1,1)) indicating congestion was encountered when the bits of the ECN field are not already set to indicate that congestion was encountered.

Method Embodiment 2C. The method of Method Embodiment 2B, further comprising: operating the core network interface device (306 or 606) to communicate (3831 or 6831) the uplink packet with the ECN field set to the value indicating that congestion was encountered to a UPF (308 or 608).

Method Embodiment 3. The method of Method Embodiment 1, wherein the core network interface device is a N3IWF (306).

Method Embodiment 4. The method of Method Embodiment 1, wherein the core network interface device is a TNGF (606).

### Fourth Numbered List of Exemplary System Embodiments

System Embodiment 1. A communications system supporting L4S in non-3GPP accesses, the communications system (301 or 601 or 100) comprising: a core network interface device including a first processor (1302 or 1402) configured to: operate the core network interface device (e.g., a N3IWF (306) or TNGF (606)) to monitor (3890 or 6890) for congestion in an uplink direction; and detect (389 or 689) at the core network interface device congestion in the uplink direction.

System Embodiment 1AA. The communications system of System Embodiment 1, wherein said first processor (1302 or 1402) is configured to: operate the core network interface device (306 or 606) to monitor an uplink data buffer (3061 or 6061) in the core network interface device (e.g., a N3IWF (306) or TNGF (606)) used for storing L4S traffic to be communicated in the uplink direction (e.g., with the traffic being communicated from the network interface device towards a data network (310 or 610)), as part of being configured to operate the core network interface device (e.g., a N3IWF (306) or TNGF (606) to monitor (3890 or 6890) for congestion in the uplink direction.

System Embodiment 1AB. The communications system of System Embodiment 1AA, said first processor (1302 or 1402) is configured to:
detect an amount of traffic in the uplink data buffer (3061 or 6061) in the core network interface device (306 or 606) used for storing L4S traffic that exceeds a congestion level threshold, as part of being configured to detect (389 or 689) at the core network interface device (306 or 606) congestion in the uplink direction.

System Embodiment 2. The communications system of System Embodiment 1, wherein said first processor (1302 or 1402) is further configured to: operate the core network interface device (306 or 606) to indicate (390 or 690) via an IP header ECN field (3601 or 6601) that congestion was experienced (e.g., assuming that the ECN field was set to ECT(1).

System Embodiment 2A. The communications system of System Embodiment 2, wherein said first processor (1302 or 1402) is configured to: operate the core network interface device (306 or 606) to mark (390 or 690) an ECN field (3601 or 6601) of an uplink packet being communicated through the core network interface device (306 or 606) (e.g., set the ECN bits (3601 or 6601) in an innermost IP header 360 or 660) to indicate that uplink congestion was experienced, as part of being configured to operate the core network interface device (306 or 606) to indicate (390 or 690) via an IP header ECN field (3601 or 6601) that congestion was experienced.

System Embodiment 2B. The communications system of System Embodiment 2A, wherein said first processor (1302 or 1402) is configured to:
change (e.g., set) the bits of ECN field to a value (e.g., represented by bit pattern=(1,1)) indicating congestion was encountered when the bits of the ECN field are not already set to indicate that congestion was encountered, as part of being configured to operate the core network interface device (306 or 606) to mark (390 or 690) the ECN field (3601 or 6601) of the uplink packet to indicate that congestion was experienced.

System Embodiment 2C. The communications system of System Embodiment 2B, wherein said first processor (1302 or 1402) is further configured to: operate the core network interface device (306 or 606) to communicate (3831 or 6831) the uplink packet with the ECN field set to the value indicating that congestion was encountered to a UPF (308 or 608).

System Embodiment 3. The communications system of System Embodiment 1, wherein the core network interface device is a N3IWF (306).

System Embodiment 4. The communications system of System Embodiment 1, wherein the core network interface device is a TNGF (606).

### Fifth Numbered List of Exemplary Method Embodiments

Method Embodiment 1. A method of supporting L4S in non-3GPP accesses, the method comprising: operating a user equipment (UE) (902) to monitor for (9790) congestion on the uplink; and detecting (979), at the UE, congestion.

Method Embodiment 1AA. The method of Method Embodiment 1, wherein operating a UE (902) to monitor (9790) for congestion on the uplink includes monitoring an uplink data buffer (9021) in the UE (902) used for storing L4S traffic to be communicated (e.g., with the traffic to be communicated, via over a wireless uplink to a non-3GPP AP (WLAN AP or TNAP 904), said traffic being sent a endpoint device in data network (910).

Method Embodiment 1AB. The method of Method Embodiment 1AA, wherein detecting (979) at the UE congestion includes detecting an amount of traffic in the uplink data buffer (9021) in the UE (902) used for storing L4S traffic that exceeds a congestion level threshold.

Method Embodiment 2. The method of Method Embodiment 1 further comprising: operating the UE to indicate (981) via IP header ECN field that congestion was experienced (e.g., assuming that the ECN field was set to ECT(1).

Method Embodiment 2A. The method of Method Embodiment 1 wherein operating the UE to indicate (981) via IP header ECN that congestion was experienced includes setting an innermost IP header ECN field (951) of an uplink IP packet to a value (e.g. represented by bit pattern=(1,1) indicating that congestion was experienced.

Method Embodiment 3. The method of Method Embodiment 1, further comprising: operating the UE to generate (982a) a GRE message indicating that uplink congestion was experienced at the UE (902).

Method Embodiment 3A. The method of Method Embodiment 3, further comprising: operating the UE to provide (982b) congestion information related to congestion experienced by the UE via the GRE message to a core network interface device (e.g., N3IWF or TNGF (906)).

Method Embodiment 3A1. The method of Method Embodiment 3A, wherein said GRE message is communicated via an IPsec tunnel traversing a non-GPP access point (WLAN AP or a TNAP 904).

Method Embodiment 3B. The method of Method Embodiment 3A, further comprising: operating the core network interface device (906) to detect (983a) the GRE message; and operating the core network interface device (906) to generate (983b) a GTP-U header including the UE provided congestion information to be sent to a UPF (908).

Method Embodiment 4. The method of Method Embodiment 3B, further comprising: operating the core network interface device (906) to send (984) the GTP-U header including congestion information to UPF (908).

Method Embodiment 5. The method of Method Embodiment 4, further comprising: operating the UPF (908) to receive (985a) the GTP-U header including the congestion information; and operating the UPF, in response to receiving the GTP-U header including the congestion information indicating that congestion was experienced, to set (985b) the ECN field (9701) in an inner-most IP header of an IP packet to indicate that congestion was experienced.

Method Embodiment 6. The method of Method Embodiment 5, wherein operating the UPF to set (985b) the ECN field (9701) in an inner-most IP header of an IP packet to indicate that congestion was experienced includes setting an inner most ECN field of an uplink IP packet to the value represented by a bit pattern of (1,1) to indicate that congestion was experienced in the uplink.

Method Embodiment 7. The method of Method Embodiment 3A1, wherein the non-3GPP AP is a WLAN AP (1100).

Method Embodiment 8. The method of Method Embodiment 3A1, wherein the non-3GPP AP is a TNAP (904).

Method Embodiment 9. The method of Method Embodiment 3A, wherein said core network interface device is a TNGF (906).

Method Embodiment 10. The method of Method Embodiment 3A, wherein said core network interface device is a N3IWF (1300).

### Fifth Numbered List of Exemplary System Embodiments

System Embodiment 1. A communications system (901 or 100) supporting L4S in non-3GPP accesses, the communications system comprising: a user equipment (UE) (902) including a first processor (1002) configured to: operate the UE (902) to monitor for (9790) congestion on the uplink; and detect (979), at the UE, congestion.

System Embodiment 1AA. The communications system of System Embodiment 1, wherein said first processor (1002) is configured to:
operate the UE (902) to monitor an uplink data buffer (9021) in the UE (902) used for storing L4S traffic to be communicated (e.g., with the traffic to be communicated, via over a wireless uplink to a non-3GPP AP (WLAN AP or TNAP 904), said traffic being sent an endpoint device in data network (910)), as part of being configured to operate the UE (902) to monitor (9790) for congestion on the uplink.

System Embodiment 1AB. The communications system of System Embodiment 1AA, said first processor (1002) is configured to: detect an amount of traffic in the uplink data buffer (9021) in the UE (902) used for storing L4S traffic that exceeds a congestion level threshold, as part of being configured to detect (979) at the UE congestion.

System Embodiment 2. The communications system of System Embodiment 1, wherein said first processor (1002) is further configured to: operate the UE (902) to indicate (981) via IP header ECN field that congestion was experienced (e.g., assuming that the ECN field was set to ECT(1)).

System Embodiment 2A. The communications system of System Embodiment 1 wherein said first processor (1002) is configured to:
set an innermost IP header ECN field (951) of an uplink IP packet to a value (e.g. represented by bit pattern=(1,1)) indicating that congestion was experienced, as part of being configured to operate the UE to indicate (981) via IP header ECN that congestion was experienced.

System Embodiment 3. The communications system of System Embodiment 1, wherein said first processor (1002) is further configured to: operate the UE to generate (982a) a GRE message indicating that uplink congestion was experienced at the UE (902).

System Embodiment 3A. The communications system of System Embodiment 3, wherein said first processor (1002) is further configured to: operate the UE to provide (982b) congestion information related to congestion experienced by the UE via the GRE message to a core network interface device (e.g., N3IWF 1300 or TNGF (906)).

System Embodiment 3A1. The communications system of System Embodiment 3A, wherein said GRE message is communicated via an IPsec tunnel traversing a non-GPP access point (WLAN AP 1100 or a TNAP 904).

System Embodiment 3B. The communications system of System Embodiment 3A, further comprising: a core network interface device (TNGF 906 or a N3IWF 1300) including a second processor (1402 or 1302) configured to: operate the core network interface device (906 or 1300) to detect (983a) the GRE message; and operate the core network interface device (906 or 1300) to generate (983b) a GTP-U header including the UE provided congestion information to be sent to a UPF (908).

System Embodiment 4. The communications system of System Embodiment 3B, wherein said second processor (1402 or 1302) is further configured to: operate the core network interface device (906) to send (984) the GTP-U header including congestion information to UPF (908).

System Embodiment 5. The communications system of System Embodiment 4, further comprising: said UPF (908) including a third processor (1502) configured to: operate the UPF (908) to receive (985a) the GTP-U header including the congestion information; and operate the UPF, in response to receiving the GTP-U header including the congestion information indicating that congestion was experienced, to set (985b) the ECN field (9701) in an inner-most IP header of an IP packet to indicate that congestion was experienced.

System Embodiment 6. The communications system of System Embodiment 5, wherein said third processor (1502) is configured to: operate the UPF to set an inner most ECN field of an uplink IP packet to the value represented by a bit pattern of (1,1) to indicate that congestion was experienced in the uplink, as part of being configured to set (985b) the ECN field (9701) in an inner-most IP header of an IP packet to indicate that congestion was experienced.

System Embodiment 7. The communications system of System Embodiment 3A1, wherein the non-3GPP AP is a WLAN AP (1100).

System Embodiment 8. The communications system of System Embodiment 3A1, wherein the non-3GPP AP is a TNAP (904).

System Embodiment 9. The communications system of System Embodiment 3A, wherein said core network interface device is a TNGF (906).

System Embodiment 10. The communications system of System Embodiment 3A, wherein said core network interface device is a N3IWF (1300).

The techniques of various embodiments may be implemented using software, hardware and/or a combination of software and hardware. Various embodiments are directed to apparatus, e.g., user equipment (UE) devices, core network devices (e.g., PCF devices, AMF devices, SMF devices, UPF devices, etc.), access network devices (e.g., WLAN APs, TNAPs, base stations, WiFi access nodes, cable network access devices), core network interfacing devices, e.g. N3IWFs and TNGFs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating user equipment (UE) devices, core network devices (e.g., PCF devices, AMF devices, SMF devices, UPF devices, etc.), access network devices (e.g., WLAN APs, TNAPs, base stations, WiFi access nodes, cable network access devices), core network interfacing devices, e.g. N3IWFs and TNGFs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., user equipment (UE) devices, core network devices (e.g., PCF devices, AMF devices, SMF devices, UPF devices, etc.), access network devices (e.g., base stations, WLAN APs, TNAPs, WiFi access nodes, cable network access devices), core network interfacing devices, e.g. N3IWFs and TNGFs, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., user (UE) devices, core network devices (e.g., PCF devices, AMF devices, SMF devices, UPF devices, etc.), access network devices (e.g., base stations, WLAN APs, TNAPs, WiFi access nodes, cable network access devices), core network interfacing devices (e.g., N3IWFs and TNGWs), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a user equipment (UE) device, core network device (e.g., PCF device, AMF device, SMF device, UPF device, etc.), access network device (e.g., base station, WLAN AP, TNAP, WiFi access node, cable network access device), core network interfacing device (e.g., N3IWF, TNGW), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, node and/or element, with a processor which includes a component corresponding to each of the steps of the various described methods performed by the device in which the processor is included. In some but not all embodiments a device, e.g., user equipment (UE) devices, core network devices (e.g., PCF devices, AMF devices, SMF devices, UPF devices, etc.), access network devices (e.g., base stations, WLAN APs, TNAPs, WiFi access nodes, cable network access devices), core network interfacing devices (e.g., N3IWFs and TNGWs), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., user (UE) device, core network device (e.g., PCF device, AMF device, SMF device, UPF device, etc.), access network device (e.g., base station, WLAN AP, TNAP, WiFi access node, cable network access device), core network interfacing device (e.g., N3IWF, TNGW), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, nodes and/or element. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a user equipment (UE) device, core network device (e.g., PCF device, AMF device, SMF device, UPF device, etc.), access network device (e.g., base station, WLAN AP, TNAP, WiFi access node, cable network access device), core network interfacing device (e.g., N3IWFs or TNGWs), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of supporting Low Latency, Low Loss, Scalable Throughput (L4S) in non-3GPP accesses, the method comprising:
operating a user equipment (UE) to monitor for congestion on the uplink; and
detecting, at the UE, congestion.

2. The method of claim 1, wherein operating a UE to monitor for congestion on the uplink includes monitoring an uplink data buffer in the UE used for storing L4S traffic to be communicated.

3. The method of claim 2,
wherein detecting at the UE congestion includes detecting an amount of traffic in the uplink data buffer in the UE used for storing L4S traffic that exceeds a congestion level threshold.

4. The method of claim 1, further comprising:
operating the UE to indicate via Internet Protocol (IP) header Explicit Congestion Notification (ECN) field that congestion was experienced.

5. The method of claim 1, wherein operating the UE to indicate via IP header ECN that congestion was experienced includes setting an innermost IP header ECN field of an uplink IP packet to a value indicating that congestion was experienced.

6. The method of claim 1, further comprising:
operating the UE to generate a Generic Routing Encapsulation (GRE) message indicating that uplink congestion was experienced at the UE.

7. The method of claim 6, further comprising:
operating the UE to provide congestion information related to congestion experienced by the UE via the GRE message to a core network interface device.

8. The method of claim 7, wherein said GRE message is communicated via an IPsec tunnel traversing a non-GPP access point.

9. The method of claim 7, further comprising:
operating the core network interface device to detect the GRE message; and
operating the core network interface device to generate a General Packet Radio Service (GPRS) Tunnelling Protocol for the user plane (GTP-U) header including the UE provided congestion information to be sent to a user plane function (UPF).

10. The method of claim 9, further comprising:
operating the core network interface device to send the GTP-U header including congestion information to UPF.

11. The method of claim 10, further comprising:
operating the UPF to receive the GTP-U header including the congestion information; and
operating the UPF, in response to receiving the GTP-U header including the congestion information indicating that congestion was experienced, to set the ECN field in an inner-most IP header of an IP packet to indicate that congestion was experienced.

12. The method of claim 11, wherein operating the UPF to set the ECN field in an inner-most IP header of an IP packet to indicate that congestion was experienced includes setting an inner most ECN field of an uplink IP packet to the value represented by a bit pattern of (1,1) to indicate that congestion was experienced in the uplink.

13. The method of claim 8, wherein the non-3GPP AP is a WLAN AP.

14. The method of claim 8, wherein the non-3GPP AP is a TNAP.

15. A communications system supporting Low Latency, Low Loss, Scalable Throughput (L4S) in non-3GPP accesses, the communications system comprising:
a user equipment (UE) including a first processor configured to:
operate the UE to monitor for congestion on the uplink; and
detect, at the UE, congestion.

16. The communications system of claim 15, wherein said first processor is further configured to:
operate the UE to indicate via IP header ECN field that congestion was experienced.

17. The communications system of claim 15, wherein said first processor is further configured to:
operate the UE to generate a Generic Routing Encapsulation (GRE) message indicating that uplink congestion was experienced at the UE.

18. The communications system of claim 17, wherein said first processor is further configured to:
operate the UE to provide congestion information related to congestion experienced by the UE via the GRE message to a core network interface device.

19. The communications system of claim 18, further comprising:
a core network interface device including a second processor configured to:
operate the core network interface device to detect the GRE message; and
operate the core network interface device to generate a General Packet Radio Service (GPRS) Tunnelling Protocol for the user plane (GTP-U) header including the UE provided congestion information to be sent to a UPF.

20. The communications system of claim 19, wherein said second processor is further configured to:
operate the core network interface device to send the GTP-U header including congestion information to a user plane function (UPF).
